(19) United States
(12) Patent Application Publication
(10) Pub. No.: US 2017/0080409 A1
(43) Pub. Date: Mar. 23, 2017

(54) CATALYSTS FOR EPOXIDE CARBONYLATION

(71) Applicant: Novomer, Inc., Ithaca, NY (US)

(72) Inventors: Jay J. FARMER, Ithaca, NY (US); Scott D. ALLEN, Ithaca, NY (US)

(73) Assignee: Novomer, Inc., Ithaca, NY (US)

(21) Appl. No.: 15/126,266

(22) PCT Filed: Mar. 13, 2015
(86) PCT No.: PCT/US2015/020562

§ 371 Date: Sep. 14, 2016

Related U.S. Application Data
(60) Provisional application No. 61/953,243, filed on Mar. 14, 2014.

(51) Int. Cl. B01J 31/22; B01J 31/18

(52) U.S. Cl. CPC B01J 31/2217; B01J 31/1815; B01J 2231/34; B01J 2531/025; B01J 2531/0252; B01J 2531/31

(57) ABSTRACT

The present invention encompasses catalysts for the carbonylation of heterocycles such as ethylene oxide, as well as methods for their use. The catalysts feature Lewis acidic metal complexes having one or more tethered metal-coordinating groups in combination with at least one metal carbonyl species. In preferred embodiments, the inventive catalysts have improved stability when subjected to product separation conditions in continuous ethylene oxide carbonylation processes.

### CROSS REFERENCE TO RELATED APPLICATIONS

The present application claims priority to U.S. provisional patent application No. 61/953,243, filed Mar. 14, 2014, the entire contents of which are hereby incorporated by reference.

### FIELD OF THE INVENTION

The invention pertains to the field of chemical synthesis. More particularly, the invention pertains to catalysts for the carbonylation of epoxides.

### SUMMARY OF THE INVENTION

Catalytic carbonylation of epoxides has been shown to be useful for the synthesis of commodity chemicals. Several product classes have been targeted by such carbonylation reactions. In particular processes have recently been developed for the carbonylation of ethylene oxide to provide propiolactone, polypropriolactone and/or succinic anhydride which may be converted to useful C₃ and C₄ chemicals such as acrylic acid, tetrahydrofuran, 1,4 butanediol and succinic acid. Inventions related to these methods are described in co-owned patent applications published as WO/2012523421, WO/2012030619, WO/2013063191, WO/2013122905 WO/2013165670, WO/2014004858, and WO/2014008232, the entirety of each of which is incorporated herein by reference.

A key challenge in practicing these methods on an industrially-useful scale is the effective separation of the carbonylation catalyst from the desired products. This has been achieved by distillation, nanofiltration, and utilization of heterogenous catalysts, however each of these approaches has certain drawbacks. A key challenge lies in obtaining catalysts with high reaction rates and good selectivity which can also be readily separated from the reaction stream. The most active catalysts discovered to date are two-component systems containing a Lewis acid (such as a Lewis acidic cationic metal complex) in combination with a nucleophilic metal carbonyl compound (such as a carbonyl cobaltate anion). These catalysts can be complicated to recycle since the two components making up the catalyst tend to have different properties in terms of their stability and their behavior in certain separation processes. In short, it can be challenging to establish a catalyst recycle regime in which each component of such catalysts remains intact and where the molar ratio of the two components is not changed. As such, there remains a need for epoxide carbonylation catalysts having increased recoverability and/or recyclability.

### DEFINITIONS

Definitions of specific functional groups and chemical terms are described in more detail below. For purposes of this invention, the chemical elements are identified in accordance with the Periodic Table of the Elements, CAS version, Handbook of 75^{th} Chemistry and Physics, 75^{th} Ed inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

Certain compounds, as described herein may have one or more double bonds that can exist as either a Z or E isomer, unless otherwise indicated. The invention additionally encompasses the compounds as individual isomers substantially free of other isomers and alternatively, as mixtures of various isomers, e.g., racemic mixtures of enantiomers. In addition to the above-mentioned compounds per se, this invention also encompasses compositions including one or more compounds.

As used herein, the term “isomers” includes any and all geometric isomers and stereoisomers. For example, “isomers” include cis- and trans-isomers, E- and Z-isomers, R- and S-enantiomers, diastereomers, (D)-isomers, (L)-isomers, racemic mixtures thereof, and other mixtures thereof, as falling within the scope of the invention. For instance, a compound may, in some embodiments, be provided substantially free of one or more corresponding stereoisomers, and may also be referred to as “stereochemically enriched.”

The terms “halo” and “halogen” as used herein refer to an atom selected from fluorine (fluoro, —F), chlorine (chloro, —Cl), bromine (bromo, —Br), and iodine (iodo, —I).

The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but is not aromatic. Unless otherwise specified, aliphatic groups contain 1-30 carbon atoms. In certain embodiments, aliphatic groups contain 1-12 carbon atoms. In certain embodiments, aliphatic groups contain 1-8 carbon atoms. In certain embodiments, aliphatic groups contain 1-6 carbon atoms. In some embodiments, aliphatic groups contain 1-5 carbon atoms; in some embodiments, aliphatic groups contain 1-4 carbon atoms; in yet other embodiments aliphatic groups contain 1-3 carbon atoms; and in yet other embodiments aliphatic groups contain 1-2 carbon atoms. Suitable aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “heteroaliphatic”, as used herein, refers to aliphatic groups where one or more carbon atoms are independently replaced by one or more atoms selected from the group consisting of oxygen, sulfur, nitrogen, phosphorus, and boron. In certain embodiments, one or two carbon atoms are independently replaced by one or more of oxygen, sulfur, nitrogen, or phosphorus. Heteroaliphatic groups may be substituted or unsubstituted, branched or unbranched, cyclic or acyclic, and include “heterocycle”, “hetercyclyl”, “heterocycloaliphatic”, or “heterocyclic” groups.

The term “epoxide”, as used herein, refers to a substituted or unsubstituted oxirane. Substituted oxiranes include monosubstituted oxiranes, disubstituted oxiranes, trisubstituted oxiranes, and tetrasubstituted oxiranes. Such epoxides may be further optionally substituted as defined herein. In certain embodiments, epoxides include a single oxirane moiety. In certain embodiments, epoxides include two or more oxirane moieties.

The term “acyl” as used herein refers to groups formed by removing one or more hydroxy groups from an oxoacid (i.e., an acid having oxygen in the acidic group), and replacement analogs of such intermediates. By way of nonlimiting example, acyl groups include carboxylic acids, esters, amides, carbamates, carbonates, ketones, and the like.

The term “acrylate” or “acrylates” as used herein refers to any acyl group having a vinyl group adjacent to the acyl carbonyl. The terms encompass mono-, di-, and trisubstituted vinyl groups. Examples of acrylates include, but are not limited to: acrylate, methacrylate, ethacrylate, cinnamate (3-phenylacrylate), crotonate, tiglate, and senecioate. Because it is known that cylcopropane groups can in certain instances behave very much like double bonds, cyclopropane esters are specifically included within the definition of acrylate herein.

The term “polymer”, as used herein, refers to a molecule of high relative molecular mass, the structure of which includes the multiple repetition of units derived, actually or conceptually, from molecules of low relative molecular mass. In certain embodiments, a polymer includes only one monomer species (e.g., polyethylene oxide). In certain embodiments, a polymer of the present invention is a copolymer, terpolymer, heteropolymer, block copolymer, or tapered heteropolymer of one or more epoxides.

The term “unsaturated”, as used herein, means that a moiety has one or more double or triple bonds.

The term “alkyl”, as used herein, refers to saturated, straight- or branched-chain hydrocarbon radicals derived from an aliphatic moiety containing between one and six carbon atoms by removal of a single hydrogen atom. Unless otherwise specified, alkyl groups contain 1-12 carbon atoms. In certain embodiments, alkyl groups contain 1-8 carbon atoms. In certain embodiments, alkyl groups contain 1-6 carbon atoms. In some embodiments, alkyl groups contain 1-5 carbon atoms, in some embodiments, alkyl groups contain 1-4 carbon atoms, in yet other embodiments alkyl groups contain 1-3 carbon atoms, and in yet other embodiments alkyl groups contain 1-2 carbon atoms. Examples of alkyl radicals include, but are not limited to, methyl, ethyl, n-propyl, isopropyl, n-butyl, iso-butyl, sec-butyl, sec-pentyl, iso-pentyl, tert-butyl, n-pentyl, neopentyl, n-hexyl, sec-hexyl, n-heptyl, n-octyl, n-decyl, n-undecyl, dodecyl, and the like.

The term “alkenyl”, as used herein, denotes a monovalent group derived from a straight- or branched-chain aliphatic moiety having at least one carbon-carbon double bond by the removal of a single hydrogen atom. Unless otherwise specified, alkenyl groups contain 2-12 carbon atoms. In certain embodiments, alkenyl groups contain 2-8 carbon atoms. In certain embodiments, alkenyl groups contain 2-6 carbon atoms. In some embodiments, alkenyl groups contain 2-5 carbon atoms, in some embodiments, alkenyl groups contain 2-4 carbon atoms, in yet other embodiments alkenyl groups contain 2-3 carbon atoms, and in yet other embodiments alkenyl groups contain 2 carbon atoms. Alkenyl groups include, for example, ethenyl, propenyl, butenyl, 1-methyl-2-buten-1-yl, and the like.

The term “alkynyl”, as used herein, refers to a monovalent group derived from a straight- or branched-chain aliphatic moiety having at least one carbon-carbon triple bond by the removal of a single hydrogen atom. Unless otherwise specified, alkynyl groups contain 2-12 carbon atoms. In certain embodiments, alkynyl groups contain 2-8 carbon atoms. In certain embodiments, alkynyl groups contain 2-6 carbon atoms. In some embodiments, alkynyl groups contain 2-5 carbon atoms, in some embodiments, alkynyl groups contain 2-4 carbon atoms, in yet other embodiments alkynyl groups contain 2-3 carbon atoms, and in yet other embodiments alkynyl groups contain 2 carbon atoms. Representative alkynyl groups include, but are not limited to, ethynyl, 2-propynyl (propargyl), 1-propynyl, and the like.

The term “carbocycle” and “carbocyclic ring” as used herein, refers to monocyclic and polycyclic moieties where the rings contain only carbon atoms. Unless otherwise specified, carbocycles may be saturated or partially unsaturated, but not aromatic, and contain 3 to 20 carbon atoms. The terms “carbocycle” or “carbocyclic” also include aliphatic rings that are fused to one or more aromatic or nonaromatic rings, such as decahydronaphthyl or tetrahydronaphthyl, where the radical or point of attachment is on the aliphatic ring. In some embodiments, a carbocyclic group is bicyclic. In some embodiments, a carbocyclic group is tricyclic. In some embodiments, a carbocyclic group is polycyclic. Representative carbocycles include cyclopropane, cyclobutane, cyclopentane, cyclohexane, bicyclo[2,2,1]heptane, norbornene, phenyl, cyclohexene, naphthalene, and spiro[4.5]decane.

The term “aryl” used alone or as part of a larger moiety as in “aralkyl”, “aralkoxy”, or “aryloxyalkyl”, refers to monocyclic and polycyclic ring systems having a total of five to 20 ring members, where at least one ring in the system is aromatic and where each ring in the system contains three to twelve ring members. The term “aryl” may be used interchangeably with the term “aryl ring”. In certain embodiments of the present invention, “aryl” refers to an aromatic ring system which includes, but is not limited to, phenyl, biphenyl, naphthyl, anthracyl and the like, which may bear one or more substituents. Also included within the scope of the term “aryl”, as it is used herein, is a group in which an aromatic ring is fused to one or more additional rings, such as benzofuranyl, indanyl, phthalimidyl, naphthimidyl, phenantriidinyl, tetrahydronaphthyl, and the like.

The terms “heteroaryl” and “heteroar-”, used alone or as part of a larger moiety, e.g., “heteroaralkyl”, or “heteroaralkoxy”, refer to groups having 5 to 14 ring atoms, preferably 5, 6, or 9 ring atoms, having 6, 10, or 14 electrons shared in a cyclic array, and having, in addition to carbon atoms, from one to five heteroatoms. Heteroaryl groups include, but are not limited to, thienyl, furanyl, pyrrolyl, imidazolyl, pyrazolyl, triazolyl, tetrazolyl, oxazolyl, isoxazolyl, oxadiazolyl, thiazolyl, isothiazolyl, thiadiazolyl, pyridyl, pyridazinyl, pyrimidinyl, pyrazinyl, indolizinyl, purinyl, naphthyridinyl, benzofuranyl, and pteridinyl. The terms “heteroaryl” and “heteroar-”, as used herein, also include groups in which a heteroaromatic ring is fused to one or more aryl, cycloaliphatic, or heterocyclyl rings, where the radical or point of attachment is on the heteroaromatic ring. Nonlimiting examples include indolyl, isoindolyl, benzothienyl, benzofuranyl, dibenzofuranyl, indazolyl, benzimidazolyl, benzthiazolyl, quinolyl, isoquinolyl, cinnolinyl, phthalazinyl, quinazolinyl, quinoxalinyl, 4H-quinolizinyl, carbazolyl, acridinyl, phenazinyl, phenothiazinyl, phenoxazinyl, tetrahydroquinolinyl, tetrahydroisoquinolinyl, and pyrido[2,3-b]-1,4-oxazin-3(4H)-one. A heteroaryl group may be mono- or bicyclic. The term “heteroaryl” may be used interchangeably with the terms “heteroaryl ring”, “heteroaryl group”, or “heteroaromatic”, any of which terms include rings that are optionally substituted. The term “heteroaralkyl” refers to an alkyl group substituted by a heteroaryl, where the alkyl and heteroaryl portions independently are optionally substituted.

As used herein, the terms “heterocycle”, “heterocyclyl”, “heterocyclic radical”, “heterocyclyl ring”, “heterocyclic group”, “heterocyclic moiety”, and “heterocyclic ring” are used interchangeably and refer to a stable 5- to 7-membered monocyclic or a 7-14-membered bicyclic heterocyclic moiety that is either saturated or partially unsaturated, but not aromatic and has, in addition to carbon atoms, one or more, preferably one to four, heteroatoms, as defined above. When used in reference to a ring atom of a heterocycle, the term “nitrogen” includes a substituted nitrogen. As an example, in a saturated or partially unsaturated ring having 0-3 heteroatoms selected from oxygen, sulfur, and nitrogen, the nitrogen may be N (as in 3,4-dihydro-2H-pyrrolyl), NH (as in pyrrolidinyl), or ⁺NR (as in N-substituted pyrrolidinyl).

The term “heteroatom” refers to nitrogen, oxygen, or sulfur, and includes any oxidized form of nitrogen or sulfur, and any quaternized form of a basic nitrogen.

A heterocyclic ring can be attached to its pendant group at any heteroatom or carbon atom that results in a stable structure and any of the ring atoms can be optionally substituted. Examples of such saturated or partially unsaturated heterocyclic radicals include, without limitation, tetrahydrofuranyl, tetrahydrothienyl, pyrrolidinyl, pyrrolidonyl, piperidinyl, pyrrolinyl, tetrahydroquinolinyl, tetrahydroisoquinolinyl, decahydroquinolinyl, oxazolidinyl, piperazinyl, dioxanyl, dioxolanyl, diazepinyl, oxazepinyl, thiazepinyl, morpholinyl, and quinuclidinyl. The term heterocycle also include groups in which a heterocyclyl ring is fused to one or more aryl, heteroaryl, or cycloaliphatic rings, such as indolinyl, 3H-indolyl, chromanyl, phenanthridinyl, or tetrahydroquinolinyl, where the radical or point of attachment is on the heterocyclyl ring. A heterocyclyl group may be mono- or bicyclic. The term “heterocyclylalkyl” refers to an alkyl group substituted by a heterocyclyl, where the alkyl and heterocyclyl portions independently are optionally substituted.

As used herein, the term “partially unsaturated” refers to a ring moiety that includes at least one double or triple bond. The term “partially unsaturated” is intended to encompass rings having multiple sites of unsaturation, but is not intended to include aryl or heteroaryl moieties, as herein defined.

As described herein, compounds of the invention may contain “optionally substituted” moieties. In general, the term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable or chemically feasible compounds. The term “stable”, as used herein, refers to compounds that are not substantially altered when subjected to conditions to allow for their production, detection, and, in certain embodiments, their recovery, purification, and use for one or more of the purposes disclosed herein.

Suitable monovalent substituents on a substitutable carbon atom of an “optionally substituted” group are independently a halogen; —(CH₂)₀₋₄R^{◯}; —(CH₂)₀₋₄OR^{◯}; —O—(CH₂)₀₋₄C(O)OR^{◯}; —(CH₂)₀₋₄CH(OR^{◯})₂; —(CH₂)₀₋₄SR^{◯}; —(CH₂)₀₋₄Ph, which may be substituted with R^{◯}; —(CH₂)₀₋₄O(CH₂)₀₋₁Ph which may be substituted with R^{◯}; —CH═CHPh, which may be substituted with R^{◯}; —NO₂; —CN; —N₃; —(CH₂)₀₋₄N(R^{◯})₂; —(CH₂)₀₋₄N(R^{◯})C(O)R^{◯}; —N(R^{◯})C(S)R^{◯}; —(CH₂)₀₋₄N(R^{◯})C(O)NR^{◯}₂; —N(R^{◯})C(S)NR₂; —(CH₂)₀₋₄N(R^{◯})C(O)OR^{◯}; —N(R^{◯})N(R^{◯})C(O)R^{◯}; —N(R^{◯})N(R^{◯})C(O)NR₂; —N(R^{◯})N(R^{◯})C(O)OR^{◯}; —(CH₂)₀₋₄C(O)R^{◯}; —C(S)R^{◯}; —(CH₂)₀₋₄C(O)OR^{◯}; —(CH₂)₀₋₄C(O)N(R^{◯})₂; —(CH₂)₀₋₄C(O)SR^{◯}; —(CH₂)₀₋₄C(O)OSiR^{◯}₃; —(CH₂)₀₋₄OC(O)R; —OC(O)(CH₂)₀₋₄SR^{◯}; —SC(S)SR^{◯}; —(CH₂)₀₋₄SC(O)R^{◯}; —(CH₂)₀₋₄C(O)NR^{◯}₂; —C(S)NR^{◯}₂; —C(S)SR^{◯}; —SC(S)SR^{◯}; —(CH₂)₀₋₄OC(O)NR^{◯}₂; —C(O)N(OR^{◯})R^{◯}; —C(O)C(O)R^{◯}; —C(O)CH₂C(O)R^{◯}; —C(NOR^{◯})R^{◯}; —(CH₂)₀₋₄SSR^{◯}; —(CH₂)₀₋₄S(O)₂R^{◯}; —(CH₂)₀₋₄S(O)₂OR^{◯}; —(CH₂)₀₋₄OS(O)₂R^{◯}; —S(O)₂NR^{◯}₂; —(CH₂)₀₋₄S(O)R^{◯}; —N(R^{◯})S(O)₂NR^{◯}₂; —N(R^{◯})S(O)₂R^{◯}; —N(OR^{◯})R^{◯}; —C(NH)NR^{◯}₂; —P(O)₂R^{◯}; —P(O)R^{◯}₂; —OP(O)R^{◯}₂; —OP(O)(OR^{◯})₂; SiR^{◯}₃; —(C₁₋₄ straight or branched alkylene)O—N(R^{◯})₂; or —(C₁₋₄ straight or branched alkylene)C(O)O—N(R^{◯})₂, where each R^{◯} may be substituted as defined below and is independently a hydrogen, C₁₋₈ aliphatic, —CH₂Ph, —O(CH₂)₀₋₁Ph, or a 5-6-membered saturated, partially unsaturated, or aryl ring having 0-4 heteroatoms independently selected from nitrogen, oxygen, and sulfur, or, notwithstanding the definition above, two independent occurrences of R^{◯}, taken together with their intervening atom(s), form a 3-12-membered saturated, partially unsaturated, or aryl mono- or polycyclic ring having 0-4 heteroatoms independently selected from nitrogen, oxygen, and sulfur, which may be substituted as defined below.

Suitable monovalent substituents on R^{◯} (or the ring formed by taking two independent occurrences of R^{◯} together with their intervening atoms), are independently a halogen, —(CH₂)₀₋₂R^{•}, -(haloR^{•}), —(CH₂)₀₋₂OH, —(CH₂)₀₋₂OR, —(CH₂)₀₋₂CH(OR^{•})₂; —O(haloR^{•}), —CN, —N₃, —(CH₂)₀₋₂C(O)R^{•}, —(CH₂)₀₋₂C(O)OH, —(CH₂)₀₋₂C(O)OR^{•}, —(CH₂)₀₋₄C(O)N(R^{◯})₂; —(CH₂)₀₋₂SR^{•}, —(CH₂)₀₋₂SH, —(CH₂)₀₋₂NH₂, —(CH₂)₀₋₂NHR^{•}, —(CH₂)₀₋₂NR^{•}₂, —NO₂, —SiR^{•}₃, —OSiR^{•}₃, —C(O)SR^{•}, —(C₁₋₄ straight or branched alkylene)C(O)OR^{•}, or —SSR^{•} where each R^{•} is unsubstituted or, where preceded by “halo”, is substituted only with one or more halogens, and is independently selected from C₁₋₄ aliphatic, —CH₂Ph, —O(CH₂)₀₋₁Ph, and a 5-6-membered saturated, partially unsaturated, or aryl ring having 0-4 heteroatoms independently selected from nitrogen, oxygen, or sulfur. Suitable divalent substituents on a saturated carbon atom of R^{◯} include ═O and ═S.

Suitable divalent substituents on a saturated carbon atom of an “optionally substituted” group include the following: ═O, ═S, ═NNR*₂, ═NNHC(O)R*, ═NNHC(O)OR*, ═NNHS(O)₂R*, ═NR*, ═NOR*, —O(C(R*₂))₂₋₃O—, or —S(C(R*₂))₂₋₃S—, where each independent occurrence of R* is selected from a hydrogen, C₁₋₆ aliphatic which may be substituted as defined below, and an unsubstituted 5-6-membered saturated, partially unsaturated, or aryl ring having 0-4 heteroatoms independently selected from nitrogen, oxygen, or sulfur. Suitable divalent substituents that are bound to vicinal substitutable carbons of an “optionally substituted” group include: —O(CR*₂)₂₋₃O—, where each independent occurrence of R* is selected from hydrogen, C₁ aliphatic which may be substituted as defined below, and an unsubstituted 5-6-membered saturated, partially unsaturated, or aryl ring having 0-4 heteroatoms independently selected from nitrogen, oxygen, and sulfur.

Suitable substituents on the aliphatic group of R* include halogen, —R^{•}, -(haloR^{•}), —OH, —OR^{•}, —O(haloR^{•}), —CN, —C(O)OH, —C(O)OR^{•}, —NH₂, —NHR^{•}, —NR^{•}₂, or —NO₂, where each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Suitable substituents on a substitutable nitrogen of an “optionally substituted” group include —R^{†}, —NR^{†}₂, —C(O)R^{†}, —C(O)OR^{†}, —C(O)C(O)R^{†}, —C(O)CH₂C(O)R^{†}, —S(O)₂R^{†}, —S(O)₂NR^{†}₂, —C(S)NR^{†}₂, —C(NH)NR^{†}₂, or —N(R^{†})S(O)₂R^{†}; where each R^{†} is independently a hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, or sulfur, or, notwithstanding the definition above, two independent occurrences of R^{†}, taken together with their intervening atom(s) form an unsubstituted 3-12-membered saturated, partially unsaturated, or aryl mono- or bicyclic ring having 0-4 heteroatoms independently selected from nitrogen, oxygen, or sulfur.

Suitable substituents on the aliphatic group of R^{†} are independently a halogen, —R^{•}, -(haloR^{•}), —OH, —OR^{•}, —O(haloR^{•}), —CN, —C(O)OH, —C(O)OR^{•}, —NH₂, —NHR^{•}, —NR^{•}₂, or —NO₂, where each R^{•} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, and sulfur.

As used herein, the term “catalyst” refers to a substance, the presence of which increases the rate of a chemical reaction, while not being consumed or undergoing a permanent chemical change itself.

### DETAILED DESCRIPTION OF THE INVENTION

The present disclosure encompasses improved catalysts for the carbonylation of epoxides and processes of making and using such catalysts.

Numerous catalysts competent for the carbonylation of epoxides and other heterocycles are known in the art. Metal carbonyl-Lewis acid catalyst such as those described in U.S. Pat. No. 6,852,865 are among the most active and selective catalysts for epoxide carbonylation, but as noted above, such catalysts can be challenging to adapt to continuous processes where the catalyst must be recovered from the product stream and re-used. Without being bound by theory or thereby limiting the scope of the present invention, it is believed that this may be due to one or more factors including: decomposition of the metal carbonyl during catalyst recovery steps conducted in environments deficient in CO (such as distillation), or due to physical separation of the metal carbonyl component of the catalyst from the Lewis acid component (as may occur during processes such as extraction, nanofiltration, adsorption or precipitation). The current invention improves existing catalyst systems by engineering the ligand on the Lewis acid such that the metal carbonyl and the Lewis acid have improved stability and/or are less likely to disassociate from each other during catalyst recovery. In certain embodiments, such catalysts have further advantages in that they have increased catalytic rates and/or selectivity.

According to one aspect, the present invention provides carbonylation catalysts comprising the combination of a Lewis-acidic metal complex and a metal carbonyl compound. The Lewis-acidic metal complex in such catalysts contains one or more metal atoms associated with one or more ligands and are characterized in that at least one of the ligands has an additional metal-coordinating moiety covalently bound to it. The purpose of the tethered metal-coordinating moiety is to interact with the metal carbonyl compound. Again, without being bound by theory, it is believed that by providing such a coordinating moiety as part of the Lewis acid, the resulting catalyst may: a) exhibit enhanced stability in low CO environments: b) exhibit better separation characteristics in processes such as adsorption, extraction, or filtration where there may be a tendency for the two components of the catalyst to be separated from each other; c) exhibit increased catalytic activity or selectivity; or any combination of (a) through (c).

Preferably, the metal-coordinating moiety present in catalysts of the present invention has a carefully selected affinity for the metal carbonyl compound, which together with the Lewis acidic metal complex to which the metal-coordinating moiety is tethered makes up the catalyst. In certain embodiments, the affinity of the coordinating moiety is selected such that under carbonylation reaction conditions where there is a high CO concentration, the metal carbonyl compound dissociates at least partially from the metal-coordinating moiety so that it may act as a nucleophile in the typical fashion. Under conditions of low CO concentration (for example such as might be encountered in a product recovery step such as distillation), the metal carbonyl compound can re-associate with the metal-coordinating moiety thereby preventing further decomposition or loss of the metal carbonyl component of the catalyst.

It is to be appreciated that the terms “catalyst” and “metal complex” are used herein interchangeably, and the term “catalyst” is not meant to limit the use or preferred stoichiometry of provided metal complexes.

In other embodiments of provided catalysts, the metal-coordinating moieties may act as a reservoir for additional metal carbonyl equivalents. This can be the case for example where there are a plurality of metal-coordinating groups present on one ligand. If each metal-coordinating group is coordinated to one metal carbonyl complex, then the activity and/or stability of the catalyst can be improved. Such catalysts can be advantageously used in continuous epoxide carbonylation reaction systems where additional metal carbonyl is fed over time to replenish lost or decomposed metal carbonyl.

In certain embodiments, provided carbonylation catalysts of the present invention include a cationic Lewis-acidic metal complex and at least one anionic metal carbonyl compound balancing the charge of the metal complex.

In certain embodiments, the Lewis-acidic metal complex has the formula [(L^{c})_{a′}M_{b′}(Lⁿ)_{c}]^{z}, where:
L^{c} is a ligand that includes at least one metal-coordinating moiety where, when two or more L^{c} are present, each may be the same or different;
M is a metal atom where, when two M are present, each may be the same or different;
Lⁿ is optionally present, and if present, is a ligand that does not include a metal-coordinating moiety where, when two or more Lⁿ are present, each may be the same or different;
a′ is an integer from 1 to 4 inclusive;
b′ is an integer from 1 to 2 inclusive;
c is an integer from 0 to 6 inclusive; and
z is 0 where the metal complex is neutral or an integer greater than 0 representing the magnitude of cationic charge on the metal complex.

In certain embodiments, provided metal complexes conform to structure I:

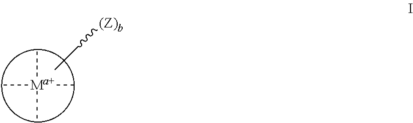

wherein:

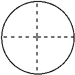

is a multidentate ligand;
M is a metal atom coordinated to the multidentate ligand;
a is the charge of the metal atom and ranges from 0 to 2; and [symbol] (Z)_{b} represents a metal-coordinating moiety, where one or more [symbol] (Z)_{b} may be present on the multidentate ligand;
where [symbol] is a in er moiety covalently coupled to the multidentate ligand;
   Z is a metal-coordinating group covalently coupled to the linker moiety; and
   b is the number of metal-coordinating groups coupled to the linker moiety and is an integer between 1 and 4 inclusive;

In certain embodiments, provided metal complexes conform to structure II:

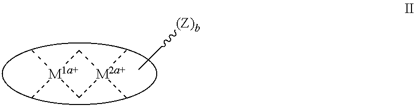

where each of [symbol] (Z)_{b} and a is as defined above, and each a may be the same or different; and
M¹ is a first metal atom; M² is a second metal atom:

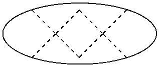

comprises a multidentate ligand system capable of coordinating both metal atoms.

For sake of clarity, and to avoid confusion between the net and total charge of the metal atoms in complexes I and II and other structures herein, the charge (a⁺) shown on the metal atom in complexes I and II above represents the net charge on the metal atom after it has satisfied any anionic sites of the multidentate ligand. For example, if a metal atom in a complex of formula I were Cr(III), and the ligand were porphyrin (a tetradentate ligand with a charge of −2), then the chromium atom would have a net charge of +1, and a would be 1.

Before more fully describing the provided catalysts, the following section provides a more detailed understanding of what the tethered metal-coordinating moieties are.

### I. Metal-Coordinating Moieties

As described above, inventive catalysts of the present invention include Lewis-acidic metal complexes featuring one or more tethered metal-coordinating moieties. Each metal-coordinating moiety denoted generically herein as “ [symbol] (Z)_{b}” comprises a linker “ [symbol] ” coupled to at least one metal-coordinating group Z, where b denotes the number of metal-coordinating groups present on a single linker moiety. Thus, a single metal-coordinating moiety may contain two or more metal-coordinating groups.

In some embodiments, there may be one or more metal-coordinating moieties [symbol] (Z)_{b} tethered to a given metal complex; each metal-coordinating moiety may itself contain more than one metal-coordinating group Z. In certain embodiments, each metal-coordinating moiety contains only one metal-coordinating group (i.e. b=1). In some embodiments, each metal-coordinating moiety contains more than one metal-coordinating groups (i.e. b>1). In certain embodiments, a metal-coordinating moiety contains two metal-coordinating groups (i.e. b=2). In certain embodiments, a metal-coordinating moiety contains three metal-coordinating groups (i.e. b=3). In certain embodiments, a metal-coordinating moiety contains four metal-coordinating groups (i.e. b=4). In certain embodiments where more than one metal-coordinating group is present on a metal-coordinating moiety, the metal-coordinating groups are the same. In some embodiments where more than one metal-coordinating group is present on a metal-coordinating moiety, two or more of the metal-coordinating groups are different.

Ia. Linkers

In certain embodiments, a linker [symbol] may comprise a bond. In this case, the metal-coordinating group Z is bonded directly to the ligand. To avoid the need to arbitrarily define where a ligand ends and a tether begins, it is to be understood that if a Z group is bonded directly to an atom that is typically regarded as part of the parent structure of the ligand, then the linker [symbol] is to be regarded as comprising a bond. In certain embodiments, when [symbol] comprises a bond, b is 1.

In certain embodiments, each linker [symbol] contains 1-30 atoms including at least one carbon atom, and optionally one or more atoms selected from the group consisting of N, O, S, Si, B, and P.

In certain embodiments, a linker is an optionally substituted C₂₋₃₀ aliphatic group wherein one or more methylene units are optionally and independently replaced by -Cy-, —NR^{y}—, —N(R^{y})C(O)—, —C(O)N(R^{y})—, —O—, —C(O)—, —OC(O)—, —C(O)O—, —S—, —SO—, —SO₂—, —C(═S)—, —C(═NR^{y})—, or —N═N—, wherein:
each -Cy- is independently an optionally substituted 5-8 membered bivalent, saturated, partially unsaturated, or aryl ring having 0-4 heteroatoms independently selected from nitrogen, oxygen, or sulfur, or an optionally substituted 8-10 membered bivalent saturated, partially unsaturated, or aryl bicyclic ring having 0-5 heteroatoms independently selected from nitrogen, oxygen, or sulfur; and
each R^{y} is independently —H, or an optionally substituted radical selected from the group consisting of C₁₋₆ aliphatic, phenyl, a 3-7 membered saturated or partially unsaturated carbocyclic ring, a 3-7 membered saturated or partially unsaturated monocyclic heterocyclic ring having 1-2 heteroatoms independently selected from nitrogen, oxygen, or sulfur, a 5-6 membered heteroaryl ring having 1-3 heteroatoms independently selected from nitrogen, oxygen, or sulfur, and an 8- to 10-membered aryl ring.

In certain embodiments, a linker [symbol] is a C₃-C₁₂ aliphatic group substituted with one or more moieties selected from the group consisting of halogen, —NO₂, —CN, —SR^{y}, —S(O)R^{y}, —S(O)₂R^{y}, —NR^{y}C(O)R^{y}, —OC(O)R^{y}, —CO₂R, —NCO, —N₃, —OR⁴, —OC(O)N(R^{y})₂, —N(R^{y})₂, —NR^{y}C(O)R^{y}, and —NR^{y}C(O)OR^{y}, where each R^{y} and R⁴ is independently as defined herein and described in classes and subclasses herein.

In certain embodiments, a linker [symbol] is an optionally substituted C₃-C₃₀ aliphatic group. In certain embodiments, a linker is an optionally substituted C₄₋₂₄ aliphatic group. In certain embodiments, a linker moiety is an optionally substituted C₄-C₂₀ aliphatic group. In certain embodiments, a linker moiety is an optionally substituted C₄-C₁₂ aliphatic group. In certain embodiments, a linker is an optionally substituted C₄₋₁₀ aliphatic group. In certain embodiments, a linker is an optionally substituted C₄₋₈ aliphatic group. In certain embodiments, a linker moiety is an optionally substituted C₄-C₆ aliphatic group. In certain embodiments, a linker moiety is an optionally substituted C₆-C₁₂ aliphatic group. In certain embodiments, a linker moiety is an optionally substituted C₈ aliphatic group. In certain embodiments, a linker moiety is an optionally substituted C₇ aliphatic group. In certain embodiments, a linker moiety is an optionally substituted C₆ aliphatic group. In certain embodiments, a linker moiety is an optionally substituted C₅ aliphatic group. In certain embodiments, a linker moiety is an optionally substituted C₄ aliphatic group. In certain embodiments, a linker moiety is an optionally substituted C₃ aliphatic group. In certain embodiments, an aliphatic group in the linker moiety is an optionally substituted straight alkyl chain. In certain embodiments, the aliphatic group is an optionally substituted branched alkyl chain. In some embodiments, a linker moiety is a C₄ to C₂₀ alkyl group having one or more methylene groups replaced by —C(R^{◯})₂— wherein R^{◯} is as defined above. In certain embodiments, a linker [symbol] consists of a bivalent aliphatic group having 4 to 30 carbons including one or more C₁₋₄ alkyl substituted carbon atoms. In certain embodiments, a linker moiety consists of a bivalent aliphatic group having 4 to 30 carbons including one or more gem-dimethyl substituted carbon atoms.

In certain embodiments, a linker [symbol] includes one or more optionally substituted cyclic elements selected from the group consisting of saturated or partially unsaturated carbocyclic, aryl, heterocyclic, or heteroaryl. In certain embodiments, a linker moiety consists of the substituted cyclic element. In some embodiments, the cyclic element is part of a linker with one or more non-ring heteroatoms or optionally substituted aliphatic groups comprising other parts of the linker moiety.

In certain embodiments, structural constraints are built into a linker moiety to control the disposition and orientation of one or more metal-coordinating groups near a metal center of a metal complex. In certain embodiments, such structural constraints are selected from the group consisting of cyclic moieties, bicyclic moieties, bridged cyclic moieties and tricyclic moieties. In some embodiments, such structural constraints are the result of acyclic steric interactions. In certain embodiments, steric interactions due to syn-pentane, gauche-butane, and/or allylic strain in a linker moiety, bring about structural constraints that affect the orientation of a linker and one or more metal-coordinating groups. In certain embodiments, structural constraints are selected from the group consisting of cis double bonds, trans double bonds, cis allenes, trans allenes, and triple bonds. In some embodiments, structural constraints are selected from the group consisting of substituted carbons including geminally disubstituted groups such as sprirocyclic rings, gem dimethyl groups, gem diethyl groups, and gem diphenyl groups. In certain embodiments, structural constraints are selected from the group consisting of heteratom-containing functional groups such as sulfoxides, amides, and oximes.

In certain embodiments, linker moieties are selected from the group consisting of:

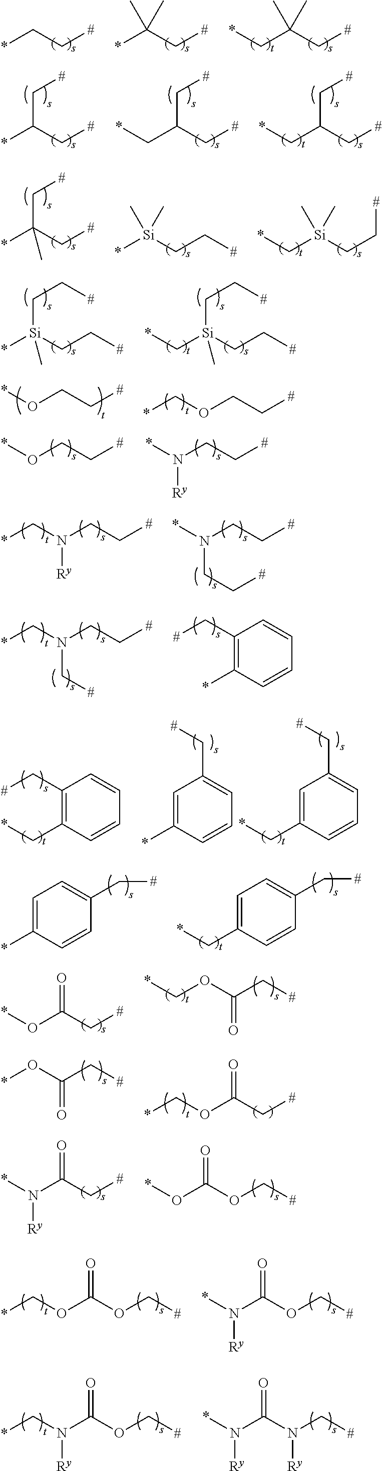

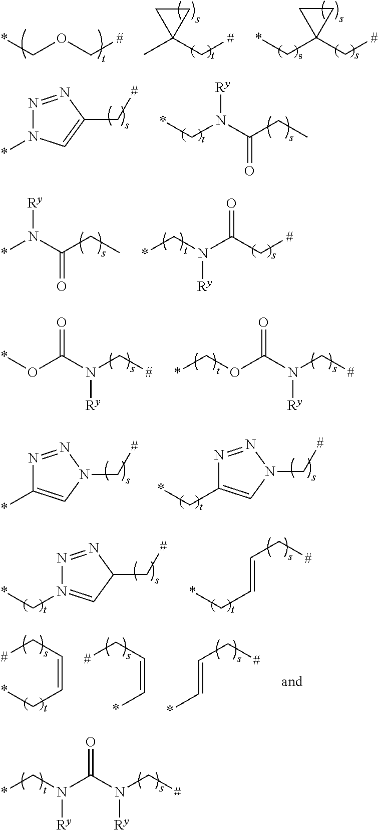

wherein each s is independently 0-6, t is 0-4, R^{y} is defined above and described in classes and subclasses herein, * represents the site of attachment to a ligand, and each # represents a site of attachment of a metal-coordinating group.

In some embodiments, s is 0. In some embodiments, s is 1. In some embodiments, s is 2. In some embodiments, s is 3. In some embodiments, s is 4. In some embodiments, s is 5. In some embodiments, s is 6.

In some embodiments, t is 1. In some embodiments, t is 2. In some embodiments, t is 3. In some embodiments, t is 4.

In certain embodiments, there is at least one metal-coordinating moiety tethered to the multidentate ligand. In certain embodiments, there are 1 to 8 such metal-coordinating moieties tethered to the multidentate ligand. In certain embodiments, there are 1 to 4 such metal-coordinating moieties tethered to the multidentate ligand. In certain embodiments, there is 1 such metal-coordinating moiety tethered to the multidentate ligand. In certain embodiments, there are 2 such metal-coordinating moieties tethered to the multidentate ligand. In certain embodiments, there are 3 such metal-coordinating moieties tethered to the multidentate ligand. In certain embodiments, there are 4 such metal-coordinating moieties tethered to the multidentate ligand.

Ib. Metal-Coordinating Groups

The purpose of metal-coordinating groups in provided catalysts is to coordinate with the metal atom in a metal carbonyl compound. As described above, metal-coordinating group is tethered to a ligand, said ligand being coordinated to another metal atom (e.g. not the metal in the metal carbonyl). A large number of neutral coordinating ligands are known in the art. In certain embodiments, a metal-coordinating group in catalysts of the present invention is simply a tethered analog of a group known to coordinate to a metal carbonyl compound.

In certain embodiments, one or more tethered metal-coordinating groups (Z) comprise neutral functional groups containing one or more atoms selected from phosphorous, nitrogen, and boron.

### Neutral Nitrogen-Containing Metal-Coordinating Groups

In certain embodiments, a tethered metal-coordinating group is a neutral nitrogen containing functional group. In certain embodiments, a tethered metal-coordinating group is selected from the group consisting of: amine, hydroxyl amine, N-oxide, urea, carbamate, imine, oxime, amidine, guanidine, bis-guanidine, amidoxime, enamine, azide, cyanate, azo, hydrazine, and nitroso functional groups. In certain embodiments, a tethered metal-coordinating group is a nitrogen-containing heterocycle or heteroaryl.

In certain embodiments, one or more tethered metal-coordinating groups (Z) on the Lewis-acidic metal complexes (i.e. complexes of formulae I or II or any of the embodiments, classes or subclasses thereof described herein) are neutral nitrogen-containing moieties. In some embodiments, such moieties include one or more of the structures in Table Z-1:

TABLE Z-1

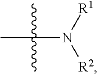

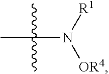

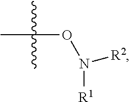

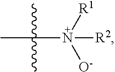

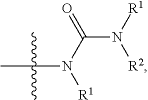

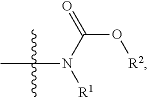

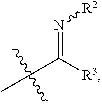

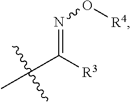

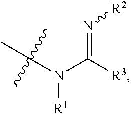

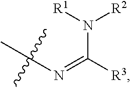

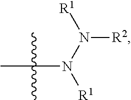

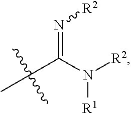

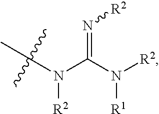

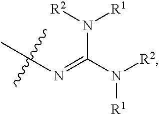

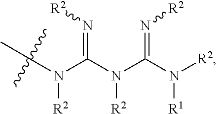

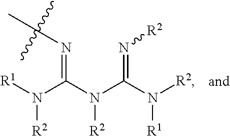

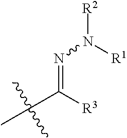

or a combination of two or more of these,
   wherein:
each R¹ and R² is independently hydrogen or an optionally substituted radical selected from the group consisting of C₁₋₂₀ aliphatic; C₁₋₂₀ heteroaliphatic; a 3- to 8-membered saturated or partially unsaturated monocyclic carbocycle; a 7- to 14-membered saturated or partially unsaturated polycyclic carbocycle; a 5- to 6-membered monocyclic heteroaryl ring having 1-4 heteroatoms independently selected from nitrogen, oxygen, or sulfur; an 8- to 14-membered polycyclic heteroaryl ring having 1-5 heteroatoms independently selected from nitrogen, oxygen, or sulfur; a 3- to 8-membered saturated or partially unsaturated monocyclic heterocyclic ring having 1-3 heteroatoms independently selected from nitrogen, oxygen, or sulfur; a 6- to 14-membered saturated or partially unsaturated polycyclic heterocycle having 1-5 heteroatoms independently selected from nitrogen, oxygen, or sulfur; phenyl; or an 8- to 14-membered polycyclic aryl ring; wherein R¹ and R² can be taken together with intervening atoms to form one or more optionally substituted rings optionally containing one or more additional heteroatoms;
each R³ is independently hydrogen or an optionally substituted radical selected from the group consisting of C₁₋₂₀ aliphatic; C₁₋₂₀ heteroaliphatic; a 3- to 8-membered saturated or partially unsaturated monocyclic carbocycle; a 7- to 14-membered saturated or partially unsaturated polycyclic carbocycle; a 5- to 6-membered monocyclic heteroaryl ring having 1-4 heteroatoms independently selected from nitrogen, oxygen, or sulfur; an 8- to 14-membered polycyclic heteroaryl ring having 1-5 heteroatoms independently selected from nitrogen, oxygen, or sulfur; a 3- to 8-membered saturated or partially unsaturated monocyclic heterocyclic ring having 1-3 heteroatoms independently selected from nitrogen, oxygen, or sulfur; a 6- to 14-membered saturated or partially unsaturated polycyclic heterocycle having 1-5 heteroatoms independently selected from nitrogen, oxygen, or sulfur; phenyl; or an 8- to 14-membered polycyclic aryl ring; wherein an R³ group can be taken with an R¹ or R² group to form one or more optionally substituted rings; and
each R⁴ is independently hydrogen, a hydroxyl protecting group, or an optionally substituted radical selected from the group consisting of C₁₋₂₀ acyl; C₁₋₂₀ aliphatic; C₁₋₂₀ heteroaliphatic; a 3- to 8-membered saturated or partially unsaturated monocyclic carbocycle; a 7- to 14-membered saturated or partially unsaturated polycyclic carbocycle; a 5- to 6-membered monocyclic heteroaryl ring having 1-4 heteroatoms independently selected from nitrogen, oxygen, or sulfur; an 8- to 14-membered polycyclic heteroaryl ring having 1-5 heteroatoms independently selected from nitrogen, oxygen, or sulfur; a 3- to 8-membered saturated or partially unsaturated monocyclic heterocyclic ring having 1-3 heteroatoms independently selected from nitrogen, oxygen, or sulfur; a 6- to 14-membered saturated or partially unsaturated polycyclic heterocycle having 1-5 heteroatoms independently selected from nitrogen, oxygen, or sulfur; phenyl; or an 8- to 14-membered polycyclic aryl ring.

In certain embodiments, each R¹ group is the same. In other embodiments, R¹ groups are different. In certain embodiments, R¹ is hydrogen. In some embodiments, R¹ is an optionally substituted radical selected from the group consisting of C₁₋₂₀ aliphatic; C₁₋₂₀ heteroaliphatic, 5- to 14-membered heteroaryl, phenyl, 8- to 10-membered aryl and 3- to 7-membered heterocyclic. In some embodiments, R¹ is an optionally substituted radical selected from the group consisting of a 3- to 8-membered saturated or partially unsaturated monocyclic carbocycle; a 7- to 14-membered saturated or partially unsaturated polycyclic carbocycle; a 5- to 6-membered monocyclic heteroaryl ring having 1-4 heteroatoms independently selected from nitrogen, oxygen, or sulfur; an 8- to 14-membered polycyclic heteroaryl ring having 1-5 heteroatoms independently selected from nitrogen, oxygen, or sulfur; a 3- to 8-membered saturated or partially unsaturated monocyclic heterocyclic ring having 1-3 heteroatoms independently selected from nitrogen, oxygen, or sulfur; a 6- to 14-membered saturated or partially unsaturated polycyclic heterocycle having 1-5 heteroatoms independently selected from nitrogen, oxygen, or sulfur; phenyl; or an 8- to 14-membered polycyclic aryl ring.

In certain embodiments, R¹ is an optionally substituted radical selected from the group consisting of C₁₋₁₂ aliphatic and C₁₋₁₂ heteroaliphatic. In some embodiments, R¹ is optionally substituted C₁₋₂₀ aliphatic. In some embodiments, R¹ is optionally substituted C₁₋₁₂ aliphatic. In some embodiments, R¹ is optionally substituted C₁₋₆ aliphatic. In some embodiments, R¹ is optionally substituted C₁₋₂₀ heteroaliphatic. In some embodiments, R¹ is optionally substituted C₁₋₁₂ heteroaliphatic. In some embodiments, R¹ is optionally substituted phenyl. In some embodiments, R¹ is optionally substituted 8- to 10-membered aryl. In some embodiments, R¹ is an optionally substituted 5- to 6-membered heteroaryl group. In some embodiments, R¹ is an optionally substituted 8- to 14-membered polycyclic heteroaryl group. In some embodiments, R¹ is optionally substituted 3- to 8-membered heterocyclic.

In certain embodiments, each R¹ is independently hydrogen, methyl, ethyl, propyl, butyl, pentyl, hexyl, heptyl, octyl, optionally substituted phenyl, or optionally substituted benzyl. In certain embodiments, R¹ is methyl, ethyl, propyl, butyl, pentyl, hexyl, heptyl, octyl, phenyl, or benzyl. In some embodiments, R¹ is butyl. In some embodiments, R¹ is isopropyl. In some embodiments, R¹ is neopentyl. In some embodiments, R¹ is perfluoro. In some embodiments, R¹ is —CF₂CF₃. In some embodiments, R¹ is phenyl. In some embodiments, R¹ is benzyl.

In certain embodiments, each R² group is the same. In other embodiments, R² groups are different. In certain embodiments, R² is hydrogen. In some embodiments, R² is an optionally substituted radical selected from the group consisting of C₁₋₂₀ aliphatic; C₁₋₂₀ heteroaliphatic, 5- to 14-membered heteroaryl, phenyl, 8- to 10-membered aryl and 3- to 7-membered heterocyclic. In some embodiments, R² is an optionally substituted radical selected from the group consisting of a 3- to 8-membered saturated or partially unsaturated monocyclic carbocycle; a 7- to 14-membered saturated or partially unsaturated polycyclic carbocycle; a 5- to 6-membered monocyclic heteroaryl ring having 1-4 heteroatoms independently selected from nitrogen, oxygen, or sulfur; an 8- to 14-membered polycyclic heteroaryl ring having 1-5 heteroatoms independently selected from nitrogen, oxygen, or sulfur; a 3- to 8-membered saturated or partially unsaturated monocyclic heterocyclic ring having 1-3 heteroatoms independently selected from nitrogen, oxygen, or sulfur; a 6- to 14-membered saturated or partially unsaturated polycyclic heterocycle having 1-5 heteroatoms independently selected from nitrogen, oxygen, or sulfur; phenyl; or an 8- to 14-membered polycyclic aryl ring.

In certain embodiments, R² is an optionally substituted radical selected from the group consisting of C₁₂ aliphatic and C₁₋₁₂ heteroaliphatic. In some embodiments, R² is optionally substituted C₁₋₂₀ aliphatic. In some embodiments, R² is optionally substituted C₁₋₁₂ aliphatic. In some embodiments, R² is optionally substituted C₁₋₆ aliphatic. In some embodiments, R² is optionally substituted C₁₋₂₀ heteroaliphatic. In some embodiments, R² is optionally substituted C₁₋₁₂ heteroaliphatic. In some embodiments, R² is optionally substituted phenyl. In some embodiments, R² is optionally substituted 8- to 10-membered aryl. In some embodiments, R² is an optionally substituted 5- to 6-membered heteroaryl group. In some embodiments, R² is an optionally substituted 8- to 14-membered polycyclic heteroaryl group. In some embodiments, R² is optionally substituted 3- to 8-membered heterocyclic.

In certain embodiments, each R² is independently hydrogen, methyl, ethyl, propyl, butyl, pentyl, hexyl, heptyl, octyl, optionally substituted phenyl, or optionally substituted benzyl. In certain embodiments, R² is methyl, ethyl, propyl, butyl, pentyl, hexyl, heptyl, octyl, phenyl, or benzyl. In some embodiments, R² is butyl. In some embodiments, R² is isopropyl. In some embodiments, R² is neopentyl. In some embodiments, R² is perfluoro. In some embodiments, R² is —CF₂CF₃. In some embodiments, R² is phenyl. In some embodiments, R² is benzyl.

In certain embodiments, each R¹ and R² are hydrogen. In some embodiments, each R¹ is hydrogen each and each R² is other than hydrogen. In some embodiments, each R² is hydrogen each and each R¹ is other than hydrogen.

In certain embodiments, R¹ and R² are both methyl, ethyl, propyl, butyl, pentyl, hexyl, heptyl, octyl, phenyl, or benzyl. In some embodiments, R¹ and R² are each butyl. In some embodiments, R¹ and R² are each isopropyl. In some embodiments, R¹ and R² are each perfluoro. In some embodiments, R¹ and R² are —CF₂CF₃. In some embodiments, R¹ and R² are each phenyl. In some embodiments, R¹ and R² are each benzyl.

In some embodiments, R¹ and R² are taken together with intervening atoms to form one or more optionally substituted carbocyclic, heterocyclic, aryl, or heteroaryl rings. In certain embodiments, R¹ and R² are taken together to form a ring fragment selected from the group consisting of: —C(R^{y})₂—, —C(R^{y})₂C(R^{y})₂—, —C(R^{y})₂C(R^{y})₂C(R^{y})₂—, —C(R^{y})₂OC(R^{y})₂—, and —C(R^{y})₂NR^{y}C(R^{y})₂—, wherein R^{y} is as defined above. In certain embodiments, R¹ and R² are taken together to form a ring fragment selected from the group consisting of: —CH₂—, —CH₂CH₂—, —CH₂CH₂CH₂—, —CH₂OCH₂—, and —CH₂NR^{y}CH₂—. In some embodiments, R¹ and R² are taken together to form an unsaturated linker moiety optionally containing one or more additional heteroatoms. In some embodiments, the resulting nitrogen-containing ring is partially unsaturated. In certain embodiments, the resulting nitrogen-containing ring comprises a fused polycyclic heterocycle.

In certain embodiments, R³ is H. In certain embodiments, R³ is an optionally substituted radical selected from C₁₋₂₀ aliphatic, C₁₋₂₀ heteroaliphatic, 5- to 14-membered heteroaryl, phenyl, 8- to 10-membered aryl, or 3- to 7-membered heterocyclic. In some embodiments, R³ is an optionally substituted radical selected from the group consisting of a 3- to 8-membered saturated or partially unsaturated monocyclic carbocycle; a 7- to 14-membered saturated or partially unsaturated polycyclic carbocycle; a 5- to 6-membered monocyclic heteroaryl ring having 1-4 heteroatoms independently selected from nitrogen, oxygen, or sulfur; an 8- to 14-membered polycyclic heteroaryl ring having 1-5 heteroatoms independently selected from nitrogen, oxygen, or sulfur; a 3- to 8-membered saturated or partially unsaturated monocyclic heterocyclic ring having 1-3 heteroatoms independently selected from nitrogen, oxygen, or sulfur; a 6- to 14-membered saturated or partially unsaturated polycyclic heterocycle having 1-5 heteroatoms independently selected from nitrogen, oxygen, or sulfur; phenyl; or an 8- to 14-membered polycyclic aryl ring. In certain embodiments, R³ is optionally substituted C₁₋₁₂ aliphatic. In some embodiments, R³ is optionally substituted C₁₋₆ aliphatic. In certain embodiments, R³ is optionally substituted phenyl.

In certain embodiments, R³ is methyl, ethyl, propyl, butyl, pentyl, hexyl, heptyl, octyl, phenyl or benzyl. In some embodiments, R³ is butyl. In some embodiments, R³ is isopropyl. In some embodiments, R³ is perfluoro. In some embodiments, R³ is —CF₂CF₃.

In some embodiments, one or more R¹ or R² groups are taken together with R³ and intervening atoms to form an optionally substituted heterocyclic or heteroaryl ring. In certain embodiments, R¹ and R³ are taken together to form an optionally substituted 5- or 6-membered ring. In some embodiments, R² and R³ are taken together to form an optionally substituted 5- or 6-membered ring optionally containing one or more heteroatoms in addition to any heteroatoms already present in the group to which R² and R³ are attached. In some embodiments, R¹, R², and R³ are taken together to form an optionally substituted fused ring system. In some embodiments, such rings formed by combinations of any of R¹, R², and R³ are partially unsaturated or aromatic.

In certain embodiments, R⁴ is hydrogen. In some embodiments, R⁴ is an optionally substituted radical selected from the group consisting of C₁₋₁₂ aliphatic, phenyl, 8- to 10-membered aryl, and 3- to 8-membered heterocyclic or heteroaryl. In certain embodiments, R⁴ is a C₁₋₁₂ aliphatic. In certain embodiments, R⁴ is a C₁₋₆ aliphatic. In some embodiments, R⁴ is an optionally substituted 8- to 10-membered aryl group. In certain embodiments, R⁴ is optionally substituted C₁₋₁₂ acyl or in some embodiments, optionally substituted C₁₋₆ acyl. In certain embodiments, R⁴ is optionally substituted phenyl. In some embodiments, R⁴ is a hydroxyl protecting group. In some embodiments, R⁴ is a silyl-containing hydroxyl protecting group. In some embodiments, R⁴ is methyl, ethyl, propyl, butyl, pentyl, hexyl, heptyl, octyl, allyl, phenyl, or benzyl.

In certain embodiments, R¹ and R⁴ are taken together with intervening atoms to form one or more optionally substituted heterocyclic or heteroaryl rings optionally containing one or more heteroatoms in addition to any heteroatoms already present in the group to which R¹ and R⁴ are attached.

In some embodiments, a metal-coordinating functional group is an N-linked amino group:

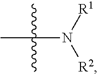

R², wherein R¹ and R² are as defined above and described in classes and subclasses herein.

In some embodiments, a metal-coordinating N-linked amino group is selected from the group consisting of:

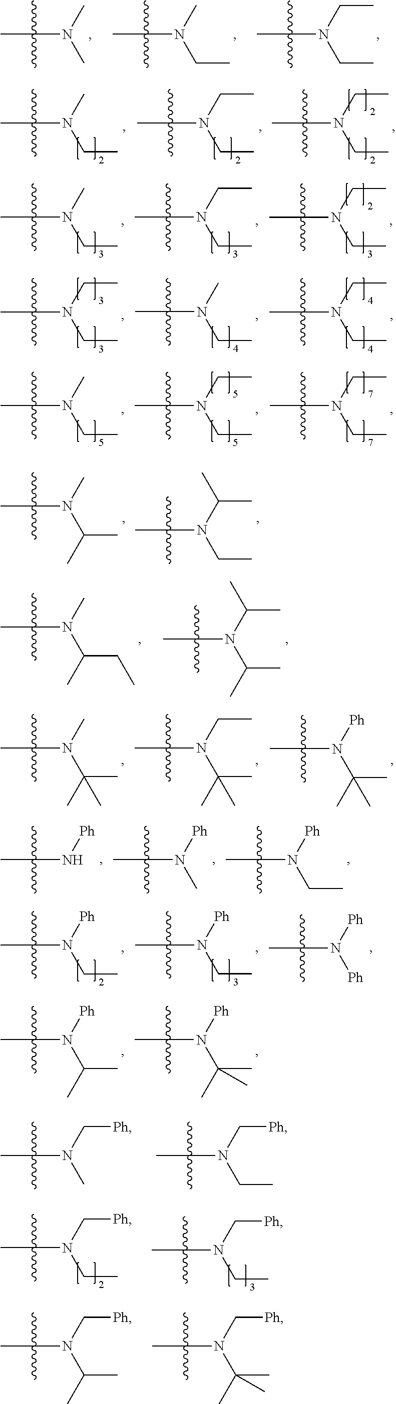

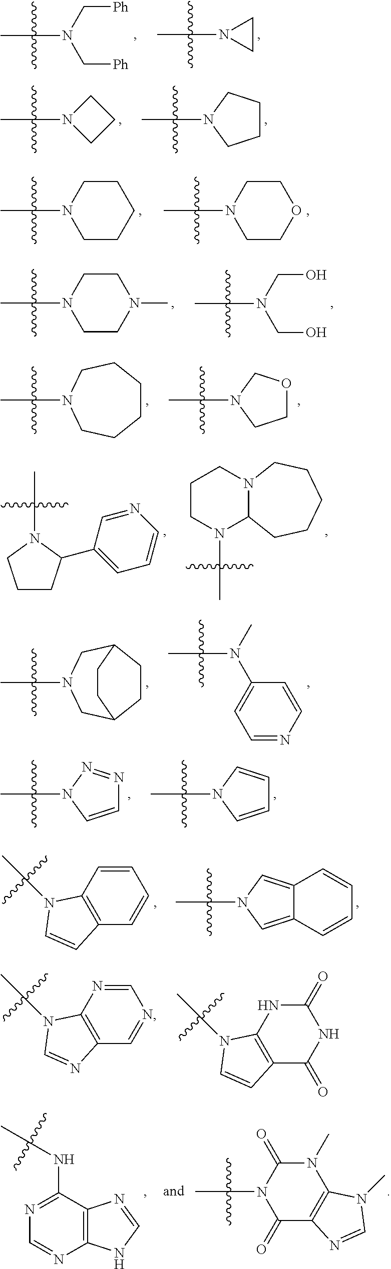

In some embodiments, one or more metal-coordinating functional groups is an N-linked hydroxyl amine derivative:

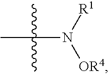

wherein R¹ and R⁴ are as defined above and described in classes and subclasses herein.

In certain embodiments, one or more metal-coordinating N-linked hydroxyl amine functional groups are selected from the group consisting of:

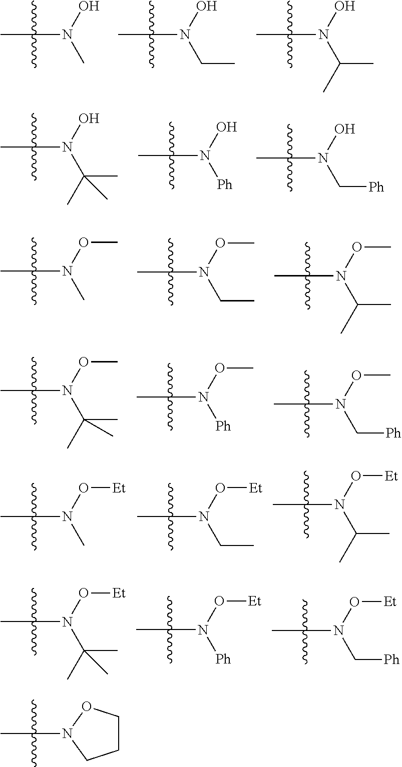

In some embodiments, a metal-coordinating functional group in a provided metal complex is an amidine. In certain embodiments, such metal-coordinating amidine functional groups are selected from:

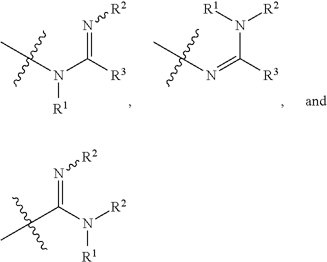

wherein each of R¹, R², and R³ is as defined above and described in classes and subclasses herein.

In certain embodiments, a metal-coordinating functional group is an N-linked amidine:

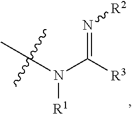

wherein each of R¹, R², and R³ is as defined above and described in classes and subclasses herein. In certain embodiments, such N-linked amidine groups are selected from the group consisting of:

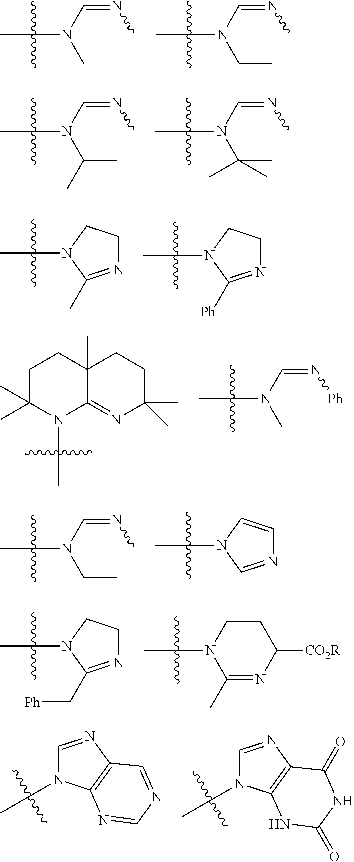

In certain embodiments, metal-coordinating functional groups are amidine moieties linked through the imine nitrogen:

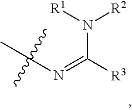

wherein each of R¹, R², and R³ is as defined above and described in classes and subclasses herein. In certain embodiments, such imine-linked amidine metal-coordinating functional groups are selected from the group consisting of:

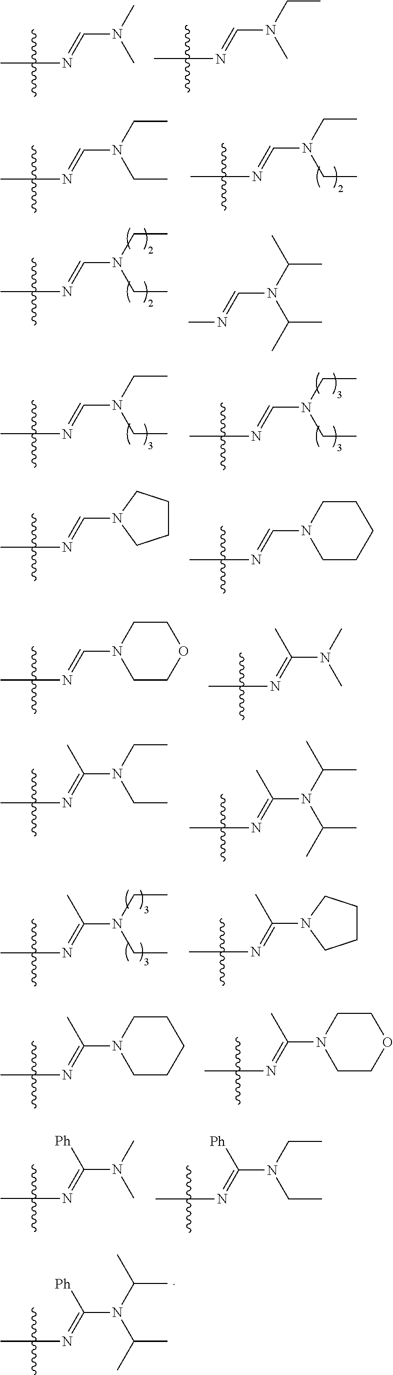

In certain embodiments, metal-coordinating functional groups are amidine moieties linked through a carbon atom:

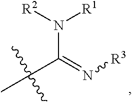

wherein each of R¹, R², and R³ is as defined above and described in classes and subclasses herein. In certain embodiments, such carbon-linked amidine groups are selected from the group consisting of:

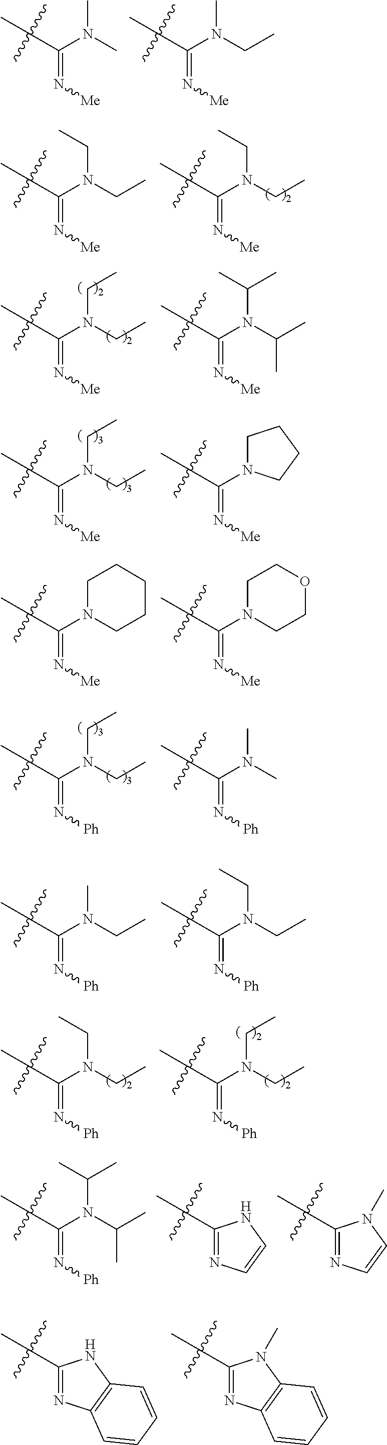

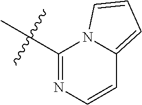 [SMILES: *c1nccc2cccn12]

In some embodiments, one or more metal-coordinating functional groups is a carbamate. In certain embodiments, a carbamate is N-linked:

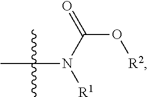

wherein each of R¹ and R² is as defined above and described in classes and subclasses herein. In some embodiments, a carbamate is O-linked:

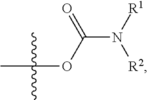

wherein each of R¹ and R² is as defined above and described in classes and subclasses herein.

In some embodiments, R² is selected from the group consisting of: methyl, t-butyl, t-amyl, benzyl, adamantyl, allyl, 4-methoxycarbonylphenyl, 2-(methylsulfonyl)ethyl, 2-(4-biphenylyl)-prop-2-yl, 2-(trimethylsilyl)ethyl, 2-bromoethyl, and 9-fluorenylmethyl.

In some embodiments, at least one metal-coordinating group is a guanidine or bis-guanidine group:

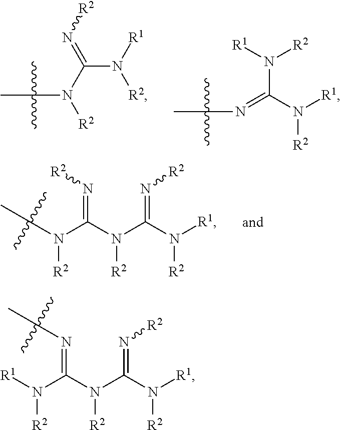

wherein each R¹ and R² is as defined above and described in classes and subclasses herein.

In some embodiments, each R¹ and R² is independently hydrogen or optionally substituted C₁₋₂₀ aliphatic. In some embodiments, each R¹ and R² is independently hydrogen or optionally substituted C₁₋₁₀ aliphatic. In some embodiments, any two or more R¹ or R² groups are taken together with intervening atoms to form one or more optionally substituted carbocyclic, heterocyclic, aryl, or heteroaryl rings. In certain embodiments, R¹ and R² groups are taken together to form an optionally substituted 5- or 6-membered ring. In some embodiments, three or more R¹ and/or R² groups are taken together to form an optionally substituted fused ring system.

In certain embodiments, where a metal-coordinating functional group is a guanidine or bis guanidine moiety, it is selected from the group consisting of:

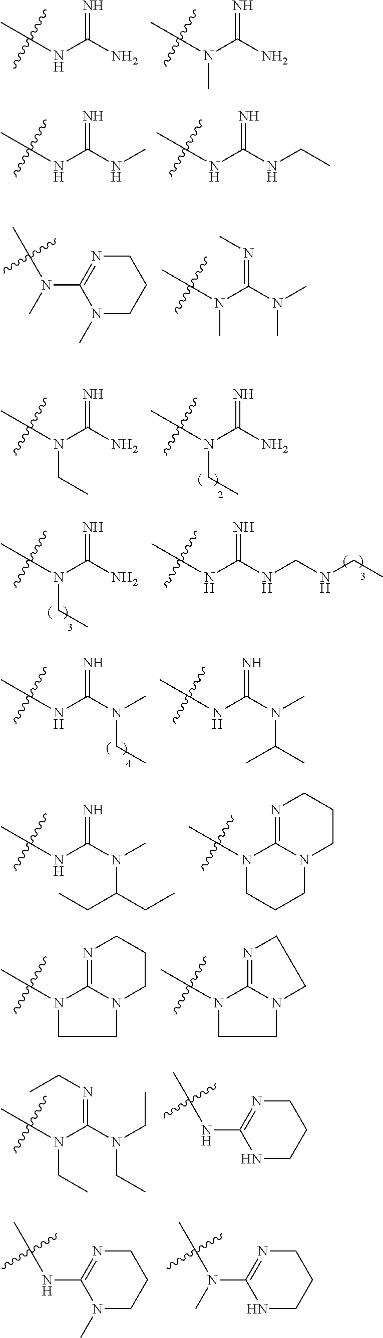

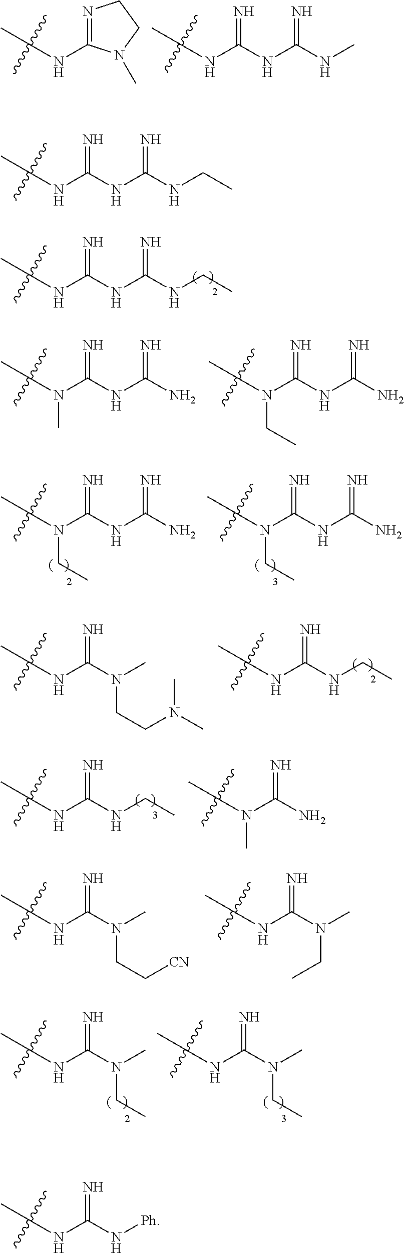

In some embodiments, a metal-coordinating functional group is a urea:

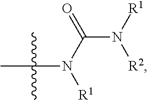

wherein each R¹ and R² is independently as defined above and described in classes and subclasses herein.

In certain embodiments, metal-coordinating functional groups are oxime or hydrazone groups:

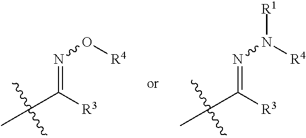

wherein each of R¹, R², R³, and R⁴ is as defined above and described in classes and subclasses herein.

In some embodiments, a metal-coordinating functional group is an N-oxide derivative:

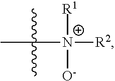

wherein each of R¹ and R² is as defined above and described in classes and subclasses herein.

In certain embodiments, an N-oxide metal-coordinating group is selected from the group consisting of:

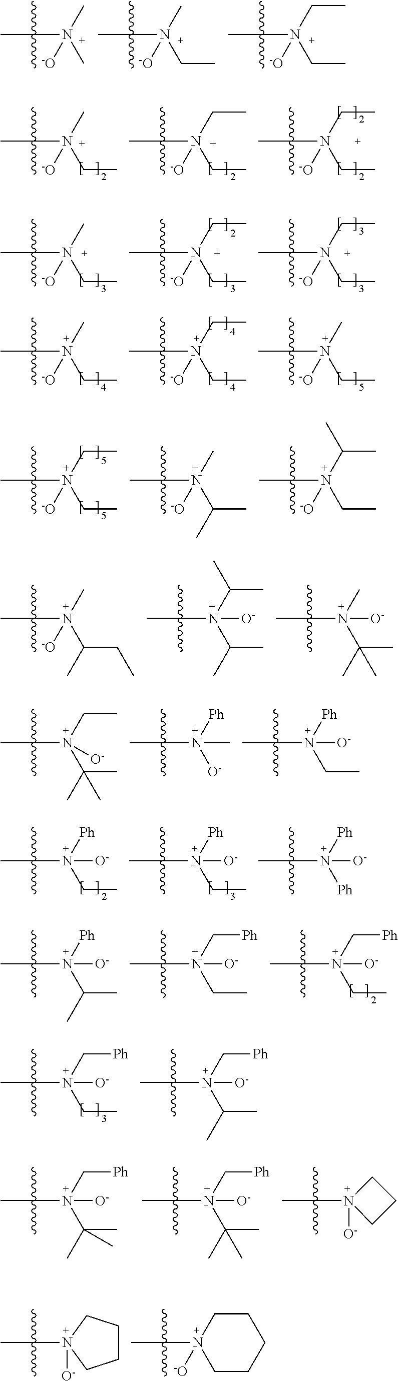

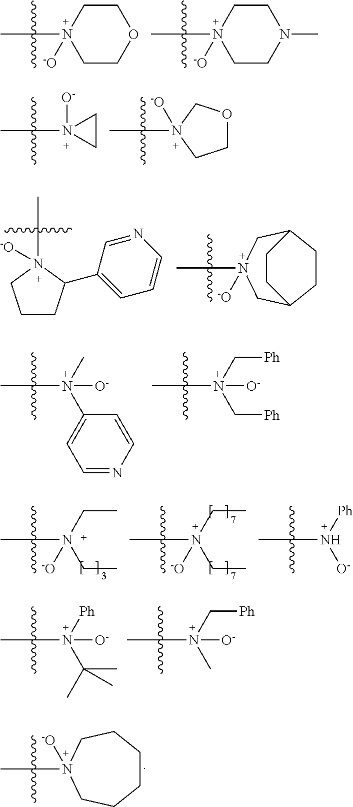

In certain embodiments, one or more tethered coordination groups (Z) comprises a nitrile group, —CN. In certain embodiments, one or more tethered coordination groups (Z) comprises an azide group, —N₃. In certain embodiments, one or more tethered coordination groups (Z) comprises a cyanate group, —OCN. In certain embodiments, one or more tethered coordination groups (Z) comprises a nitroso group, —N═O.

In certain embodiments, one or more tethered coordination groups (Z) comprises a neutral nitrogen-containing heterocycle or heteroaryl. In certain embodiments, one or more tethered coordination groups (Z) comprises a neutral nitrogen-containing heterocycle or heteroaryl selected from the group consisting of:

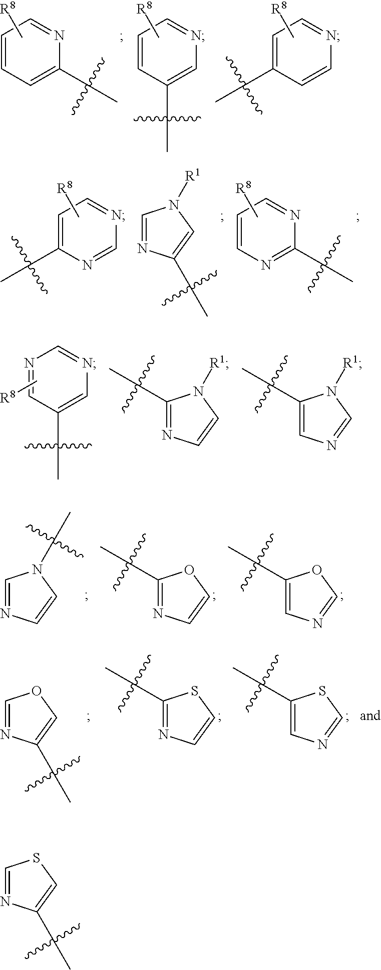

wherein R¹ is as defined above and in the classes and subclasses herein, and
R⁸ may be present on one or more substitutable carbon atoms, wherein each occurrence of R⁸ is independently selected from the group consisting of: halogen, —NO₂, —CN, —SR^{y}, —S(O)R^{y}, —S(O)₂R^{y}, —NR^{y}C(O)R^{y}, —OC(O)R^{y}, —CO₂R^{y}, —NCO, —N₃, —OR⁴, —OC(O)N(R^{y})₂, —N(R^{y})₂, —NR^{y}C(O)R^{y}, —NR^{y}C(O)OR^{y}; or an optionally substituted radical selected from the group consisting of C₁₋₂₀ aliphatic; C₁₋₂₀ heteroaliphatic; a 3- to 8-membered saturated or partially unsaturated monocyclic carbocycle; a 7- to 14-membered saturated or partially unsaturated polycyclic carbocycle; a 5- to 6-membered monocyclic heteroaryl ring having 1-4 heteroatoms independently selected from nitrogen, oxygen, or sulfur; an 8- to 14-membered polycyclic heteroaryl ring having 1-5 heteroatoms independently selected from nitrogen, oxygen, or sulfur; a 3- to 8-membered saturated or partially unsaturated monocyclic heterocyclic ring having 1-3 heteroatoms independently selected from nitrogen, oxygen, or sulfur; a 6- to 14-membered saturated or partially unsaturated polycyclic heterocycle having 1-5 heteroatoms independently selected from nitrogen, oxygen, or sulfur; phenyl; or an 8- to 14-membered polycyclic aryl ring; wherein each R⁴ and R^{y} is independently as defined above and described in classes and subclasses herein, and where two or more adjacent R⁸ groups can be taken together to form an optionally substituted saturated, partially unsaturated, or aromatic 5- to 12-membered ring containing 0 to 4 heteroatoms;

### Phosphorous-Containing Coordinating Groups

In certain embodiments, one or more tethered metal-coordinating groups (Z) on provided metal complexes (i.e. complexes of formulae I or II or any of the embodiments, classes or subclasses thereof described herein) is a neutral phosphorous-containing functional group:

In certain embodiments, a phosphorous-containing functional group is chosen from the group consisting of: phosphines (—PR^{y}₂); phosphine oxides —P(O)(R^{y})₂; phosphinites P(OR⁴)(R^{y})₂; phosphonites P(OR⁴)₂R^{y}; phosphites P(OR⁴)₃; phosphinates OP(OR⁴)(R^{y})₂; phosphonates; OP(OR⁴)₂R^{y}; and phosphates —OP(OR⁴)₃; where a phosphorous-containing functional group may be linked to a metal complex through any available position (e.g. direct linkage via the phosphorous atom, linkage through an aliphatic or aromatic group attached to the phosphorous atom or in some cases via an oxygen atom or an aliphatic or aromatic group attached to an oxygen atom), wherein each R⁴ and R^{y} is independently as defined above and described in classes and subclasses herein

In certain embodiments, a phosphorous-containing functional group is chosen from the group consisting of:

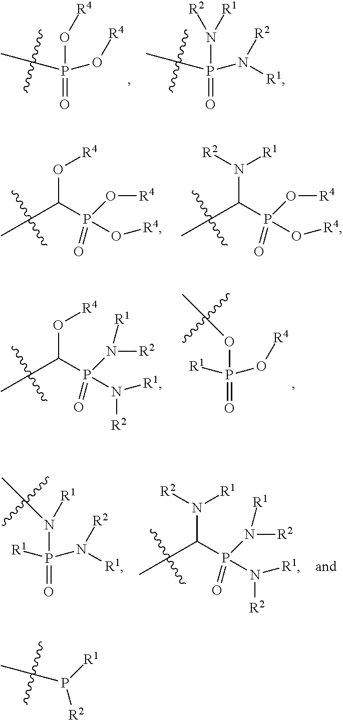

or a combination of two or more of these
wherein each R¹, R², and R⁴ is as defined above and described in classes and subclasses herein, both singly and in combination; and where two R⁴ groups can be taken together with intervening atoms to form an optionally substituted ring optionally containing one or more heteroatoms, or an R⁴ group can be taken with an R¹ or R² group to form an optionally substituted carbocyclic, heterocyclic, heteroaryl, or aryl ring.

In some embodiments, phosphorous containing functional groups include those disclosed in The Chemistry of Organophosphorus Compounds. Volume 4. Ter- and Quincquevalent Phosphorus Acids and their Derivatives. The Chemistry of Functional Group Series Edited by Frank R. Hartley (Cranfield University, Cranfield, U.K.). Wiley: New York. 1996. ISBN 0-471-95706-2, the entirety of which is hereby incorporated herein by reference.

In certain embodiments, phosphorous containing functional groups have the formula:

—(V)_{b}—[(R⁹R¹⁰R¹¹P)⁺]_{n′}W^{n′}—, wherein:
V is —O—, —N═, or —NR^{z}—;
b is 1 or 0;
each of R⁹, R¹⁰, and R¹¹ are independently present or absent and, if present, are independently selected from the group consisting of optionally substituted C₁-C₂₀ aliphatic, optionally substituted phenyl, optionally substituted C₈-C₁₄ aryl, optionally substituted 3- to 14-membered heterocyclic, optionally substituted 5- to 14-membered heteroaryl, halogen, ═O, —OR^{z}, ═NR^{z}, and N(R^{z})₂, where R^{z} is hydrogen, or an optionally substituted C₁-C₂₀ aliphatic, optionally substituted phenyl, optionally substituted 8- to 14-membered aryl, optionally substituted 3- to 14-membered heterocyclic, or optionally substituted 5- to 14-membered heteroaryl;
W is any anion; and
n′ is an integer from 1 to 4, inclusive

In some embodiments, metal-coordinating functional group is a phosphonate group:

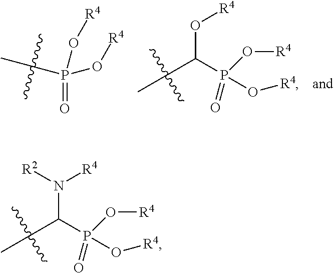

wherein each R¹, R², and R⁴ is independently as defined above and described in classes and subclasses herein, both singly and in combination.

In specific embodiments, a phosphonate metal-coordinating functional group is selected from the group consisting of:

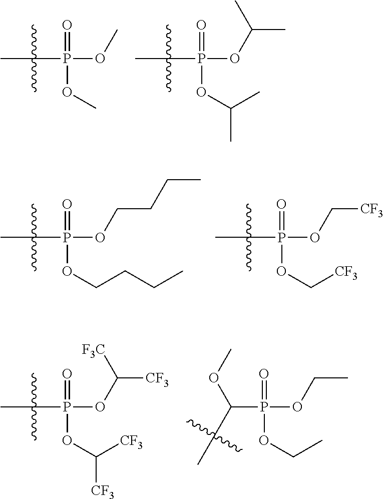

In some embodiments, a metal-coordinating functional group is a phosphonic diamide group:

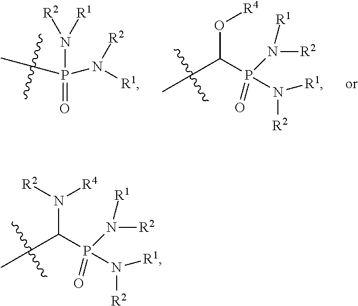

wherein each R¹, R², and R⁴ is independently as defined above and described in classes and subclasses herein. In certain embodiments, each R¹ and R² group in a phosphonic diamide is methyl.

In some embodiments, a metal-coordinating functional group is a phosphine group:

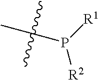

wherein R¹, and R² are as defined above and described in classes and subclasses herein, both singly and in combination.

In specific embodiments, a phosphine functional group is selected from the group consisting of:

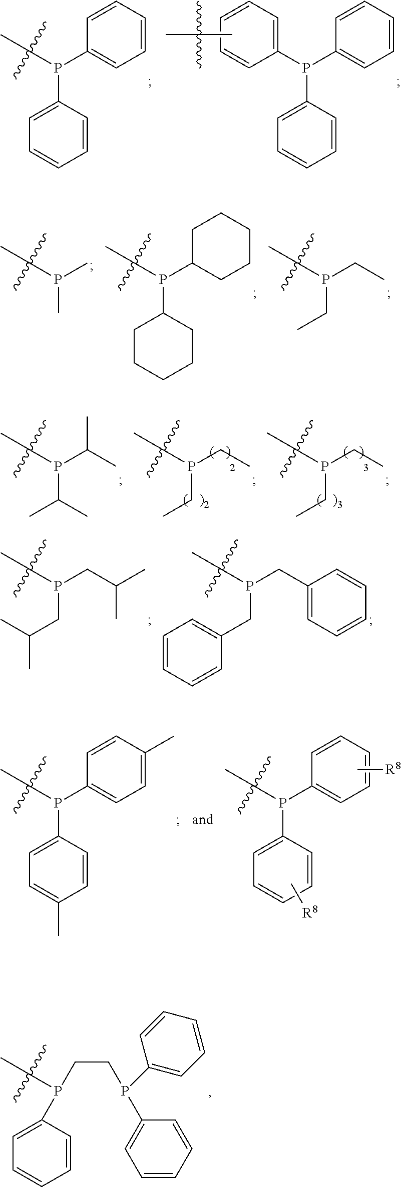

where each R⁸ is independently as defined above and in the classes and subclasses herein.

In some embodiments, a metal-coordinating functional group is a phosphite group:

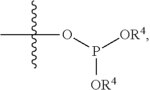

wherein each R⁴ is independently as defined above and described in classes and subclasses herein, both singly and in combination.

In specific embodiments, a phosphite metal-coordinating functional group is selected from the group consisting of:

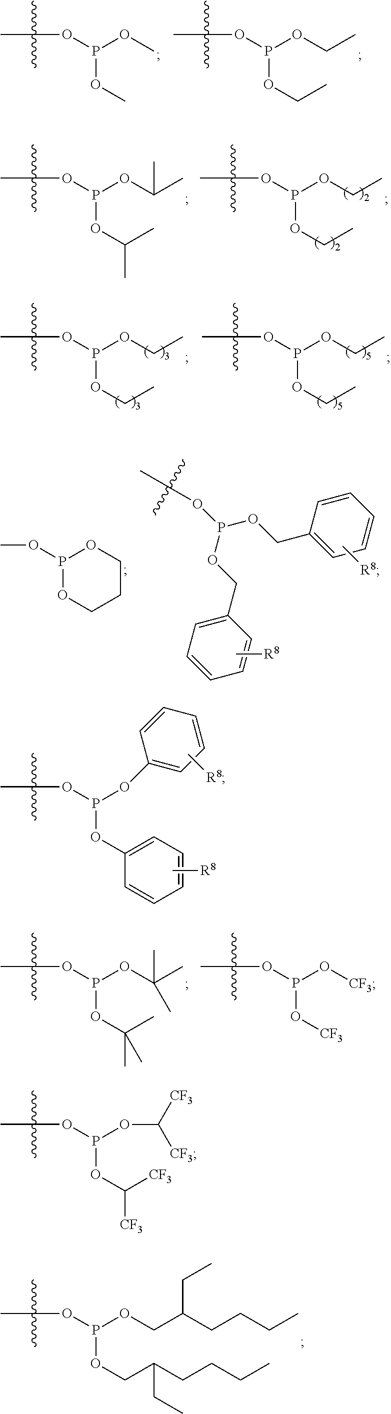

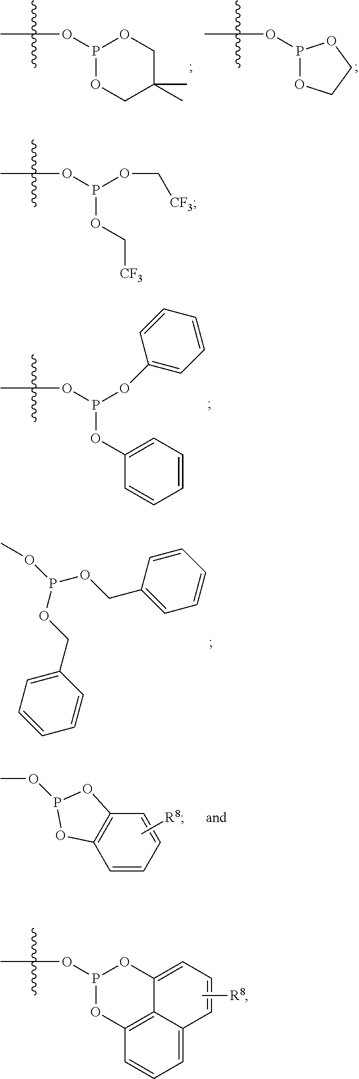

where each occurrence of R⁸ is as defined above and in the classes and subclasses herein.

### Boron-Containing Coordinating Groups

In certain embodiments, one or more tethered metal-coordinating groups (Z) on provided metal complexes (i.e. complexes of formulae I or II or any of the embodiments, classes or subclasses thereof described herein) is a neutral boron-containing functional group.

In certain embodiments, a boron-containing functional group is chosen from the group consisting of: —B(OR⁴)₂; —OB(R^{y})OR⁴; —B(R^{y})OR⁴—OB(R^{y})₂ wherein each R⁴ and R^{y} is independently as defined above and described in classes and subclasses herein and where the boron-containing functional group may be linked to the metal complex through any available position (e.g. direct linkage via the boron atom, linkage through an aliphatic or aromatic group attached to the boron atom or in some cases via an oxygen atom or an aliphatic or aromatic group attached to an oxygen atom),

### II. The Lewis Acidic Metal Complex

As described above, in certain embodiments the catalysts of the present invention comprise metal-containing Lewis acid complexes containing one or more ligands. While many examples and embodiments herein are focused on the presence of a single multidentate ligand in such complexes, this is not a limiting principle of the present invention and it is to be understood that two or more mono- or multidentate ligands may also be used, when two or more ligands are used, they need not all be substituted with tethered metal-coordinating moieties, only one ligand may be so substituted, or more than one may be substituted with one or more metal-coordinating moieties.

IIa. Ligands in the Acidic Metal Complexes

Suitable multidentate ligands for the metal-containing Lewis acids include, but are not limited to: porphyrin derivatives 1, salen derivatives 2, dibenzotetramethyltetraaza[14]annulene (tmtaa) derivatives 3, phthalocyaninate derivatives 4, derivatives of the Trost ligand 5, and tetraphenylporphyrin derivatives 6. In certain embodiments, the multidentate ligand is a salen derivative. In other embodiments, the multidentate ligand is a tetraphenylporphyrin derivative.

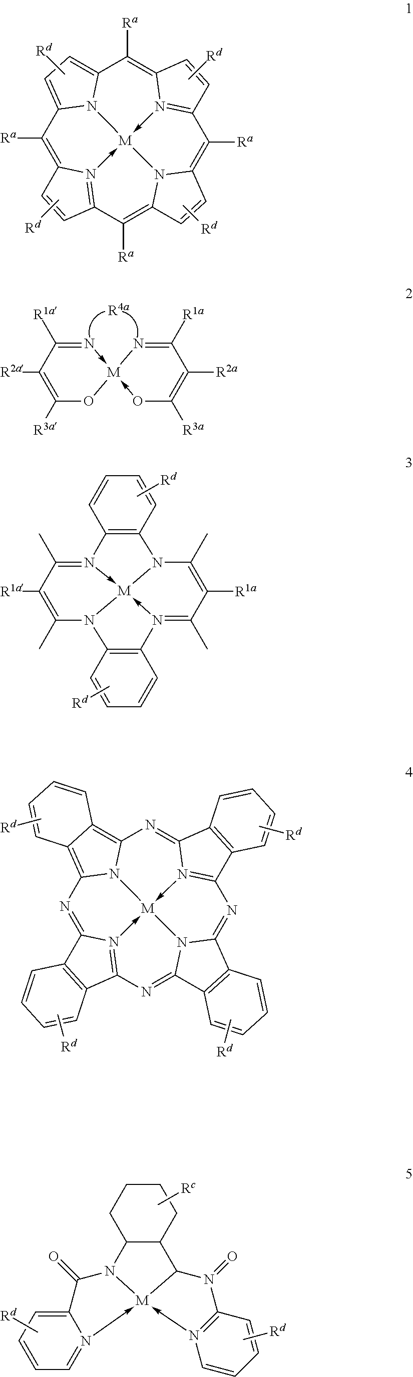

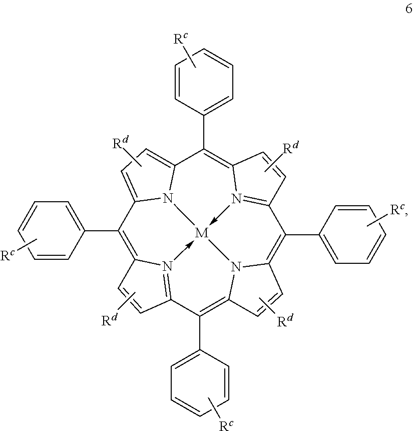

where each of R^{c}, R^{d}, R^{a}, R^{1a}, R^{2a}, R^{3a}, R^{1a′}, R^{2a′}, R^{3a′}, and R^{4a} is as defined and described in the classes and subclasses herein.

In certain embodiments, catalysts of the present invention comprise metal-porphinato complexes. In some embodiments,

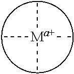

is a metal-porpinato complex. In certain embodiments, the moiety

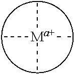

has the structure:

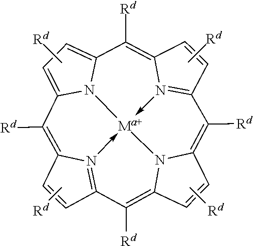

where each of M and a is as defined above and described in the classes and subclasses herein, and
R^{d} at each occurrence is inndpendently a metal-coordinating moiety ( [symbol] (Z)_{b}), hydrogen, halogen, —OR⁴, —N(R^{y})₂, —SR, —CN, —NO₂, —SO₂R^{y}, —SOR^{y}, —SO₂N(R^{y})₂; —CNO, —NRSO₂R^{y}, —NCO, —N₃, —SiR₃; or an optionally substituted group selected from the group consisting of C₁₋₂₀ aliphatic; C₁₋₂₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, or sulfur; and 4- to 7-membered heterocyclic having 1-2 heteroatoms independently selected from the group consisting of nitrogen, oxygen, and sulfur, where two or more R^{d} groups may be taken together to form one or more optionally substituted rings, where each R^{y} is independently hydrogen, an optionally substituted group selected the group consisting of acyl; carbamoyl, arylalkyl; 6- to 10-membered aryl; C₁₋₁₂ aliphatic; C₁₋₁₂ heteroaliphatic having 1-2 heteroatoms independently selected from the group consisting of nitrogen, oxygen, and sulfur; 5- to 10-membered heteroaryl having 1-4 heteroatoms independently selected from the group consisting of nitrogen, oxygen, and sulfur; 4- to 7-membered heterocyclic having 1-2 heteroatoms independently selected from the group consisting of nitrogen, oxygen, and sulfur; an oxygen protecting group; and a nitrogen protecting group; or two R^{y} on the same nitrogen atom are taken with the nitrogen atom to form an optionally substituted 4- to 7-membered heterocyclic ring having 0-2 additional heteroatoms independently selected from the group consisting of nitrogen, oxygen, and sulfur; and
each R⁴ is —H, a hydroxyl protecting group or R^{y}.

In certain embodiments, the multidentate ligand is a porphyrin moiety. Examples include, but are not limited to:

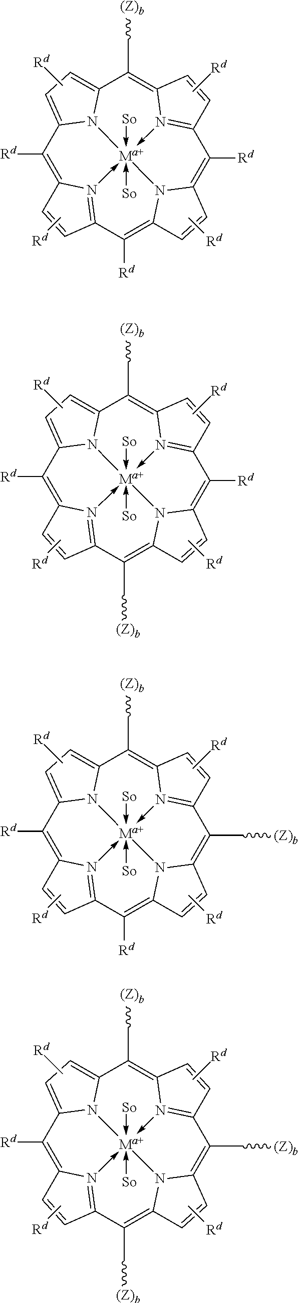

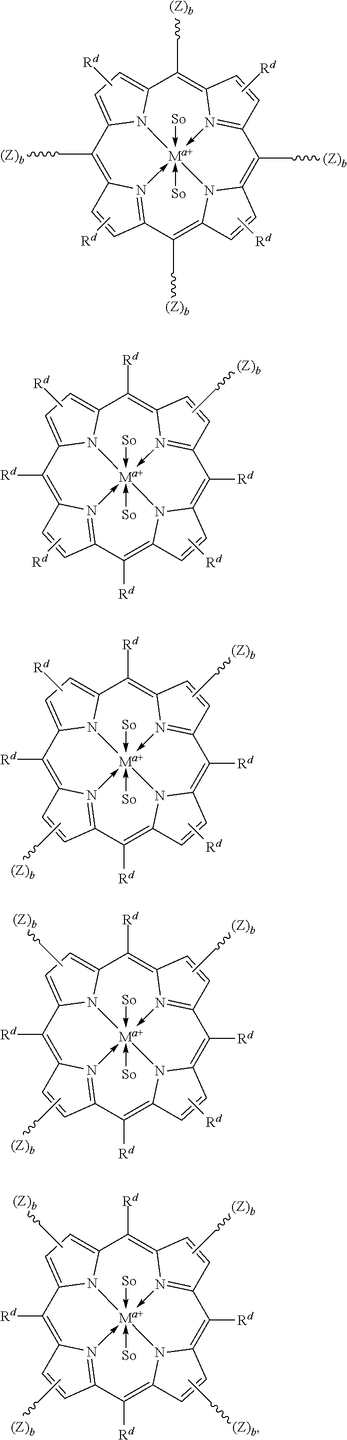

where M, a, [symbol] (Z)_{b}, and R^{d} are as defined above and in the classes and subclasses herein,

and So, is an optionally present coordinated solvent molecule, such as an ether, epoxide, DMSO, amine, or other Lewis basic moiety.

In certain embodiments, the moiety

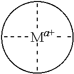

has the structure:

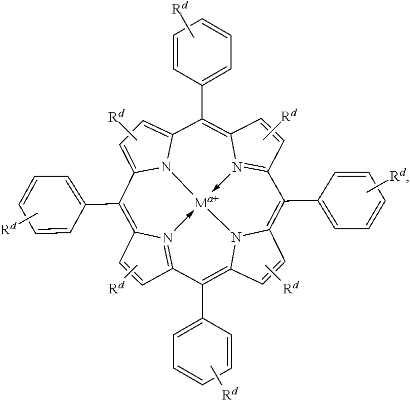

where M, a, and R^{d} are as defined above and in the classes and subclasses herein.

In certain embodiments, the multidentate ligand is an optionally substituted tetraphenyl porphyrin. Suitable examples include, but are not limited to:

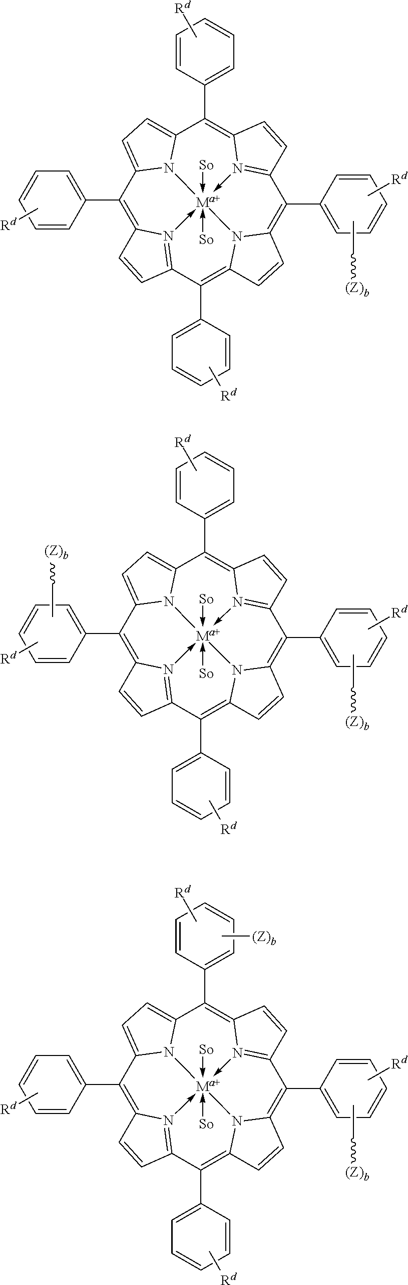

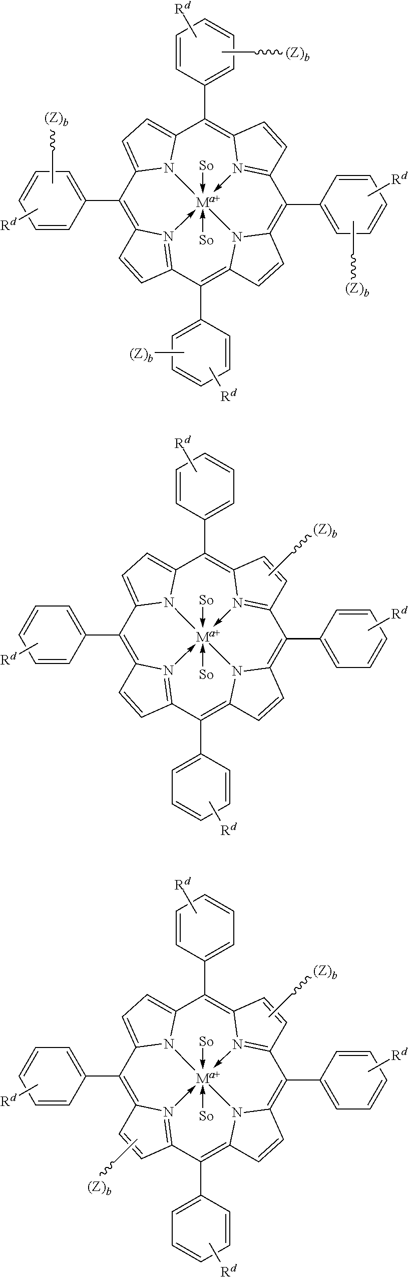

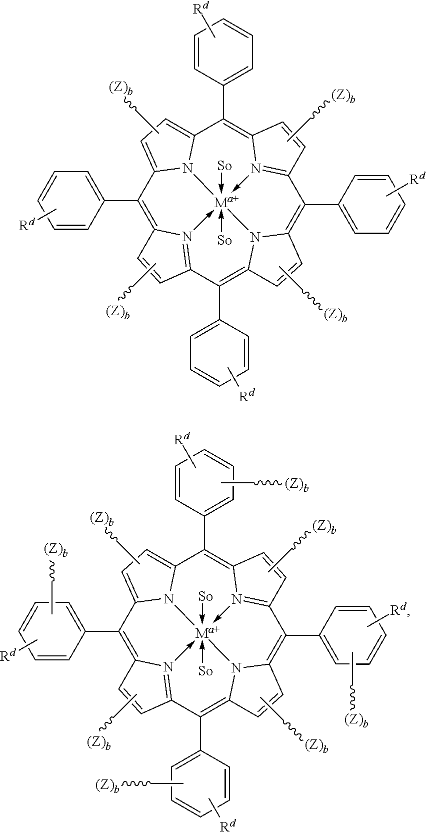

where M, a, R^{d}, So, and [symbol] (Z)_{b} are as defined above and described in the classes and subclasses herein.

In certain embodiments, the moiety

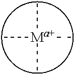

has the structure:

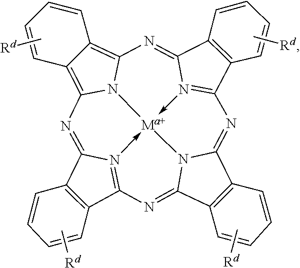

where M, a, and R^{d} are as defined above and in the classes and subclasses herein.

In certain embodiments, catalysts of the present invention comprise metallo salenate complexes. In certain embodiments, the moiety

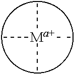

has the structure:

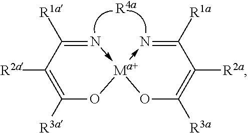

wherein:
M and a are as defined above and in the classes and subclasses herein;
R^{1a}, R^{1a′}, R^{2a}, R^{2a′}, R^{3a}, and R^{3a′} are independently a metal-coordinating moiety ( [symbol] (Z)_{b}), hydrogen, halogen, —OR⁴, —N(R^{y})₂, —SR, —CN, —NO₂, —SO₂R^{y}, —SOR, —SO₂N(R^{y})₂; —CNO, —NRSO₂R^{y}, —NCO, —N₃, —SiR₃; or an optionally substituted group selected from the group consisting of C₁₋₂₀ aliphatic; C₁₋₂₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, or sulfur; and 4- to 7-membered heterocyclic having 1-2 heteroatoms independently selected from the group consisting of nitrogen, oxygen, and sulfur; wherein each R, R⁴, and R^{y} is independently as defined above and described in classes and subclasses herein,
wherein any of (R^{2a′} and R^{3a′}), (R^{2a} and R^{3a}), (R^{1a} and R^{2a}), and (R^{1a′} and R^{2a′}) may optionally be taken together with the carbon atoms to which they are attached to form one or more rings which may in turn be substituted with one or more R groups; and
R^{4a} is selected from the group consisting of:

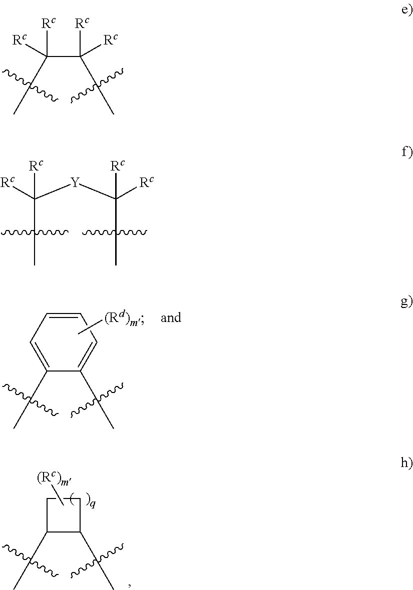

where
R^{c} at each occurrence is independently a metal-coordinating moiety ( [symbol] (Z)_{b}), hydrogen, halogen, —OR, —N(R^{y})₂, —SR, —CN, —NO₂, —SO₂R^{y}, —SOR^{y}, —SO₂N(R^{y})₂; —CNO, —NRSO₂R^{y}, —NCO, —N₃, —SiR₃; or an optionally substituted group selected from the group consisting of C₁₋₂₀ aliphatic; C₁₋₂₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, or sulfur; and 4- to 7-membered heterocyclic having 1-2 heteroatoms independently selected from the group consisting of nitrogen, oxygen, and sulfur;
where:
   two or more R^{c} groups may be taken together with the carbon atoms to which they are attached and any intervening atoms to form one or more rings;
   when two R^{c} groups are attached to the same carbon atom, they may be taken together along with the carbon atom to which they are attached to form a moiety selected from the group consisting of: a 3- to 8-membered spirocyclic ring, a carbonyl, an oxime, a hydrazone, an imine;
R^{d} is as defined above and described in classes and subclasses herein;
Y is a divalent linker selected from the group consisting of: —NR^{y}—, —N(R)C(O)—, —C(O)NR^{y}—, —O—, —C(O)—, —OC(O)—, —C(O)O—, —S—, —SO—, —SO₂—, —C(═S)—, —C(═NR^{y})—, —N═N—; a polyether; a C₃ to C₈ substituted or unsubstituted carbocycle; a 6- to 10-membered aryl; a 5- to 10-membered heteroaryl; and a 3- to 8-membered substituted or unsubstituted heterocycle; each m′ is independently 0 or an integer from 1 to 4, inclusive;
q is 0 or an integer from 1 to 4, inclusive; and
x is 0, 1, or 2.

In certain embodiments, a provided metal complex comprises at least one metal-coordinating moiety tethered to a carbon atom of only one phenyl ring of the salicylaldehyde-derived portion of a salen ligand, as shown in formula Ia:

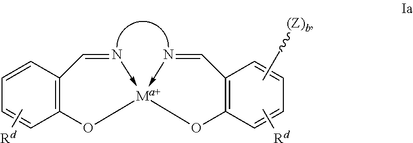

wherein each of [symbol] (Z)_{b}, M, R^{d}, and a is as defined above and in the classes and subclasses herein,
[symbol] represents is an optionally substituted moiety linking the two nitrogen atoms of the diamine portion of the salen ligand, where [symbol] is selected from the group consisting of a C₃-C₁₄ carbocycle, a C₆-C₁₀ aryl group, a C₃-C₁₄ heterocycle, and a C₅-C₁₀ heteroaryl group; or an optionally substituted C₂₋₂₀ aliphatic group, wherein one or more methylene units are optionally and independently replaced by —NR^{y}—, —N(R^{y})C(O)—, —C(O)N(R^{y})—, —OC(O)N(R^{y})—, —N(R^{y})C(O)O—, —OC(O)O—, —O—, —C(O)—, —OC(O)—, —C(O)O—, —S—, —SO—, —SO₂—, —C(═S)—, —C(═NR^{y})—, —C(═NOR^{y})— or —N═N—.

In certain embodiments, provided metal complexes of the present invention feature metal-coordinating moieties tethered to only one salicylaldehyde-derived portion of the salen ligand, while in other embodiments both salicylaldehyde-derived portions of the salen ligand bear one or more metal-coordinating moieties as in formula IIa:

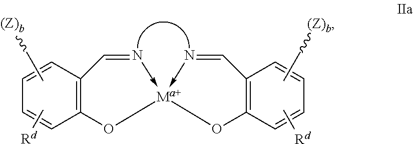

where each of M, a, R^{d}, [symbol] , and [symbol] (Z)_{b} are as defined above and in the classes and subclasses herein.

In certain embodiments of metal complexes having formulae Ia or IIa above, at least one of the phenyl rings comprising the salicylaldehyde-derived portion of the metal complex is independently selected from the group consisting of:

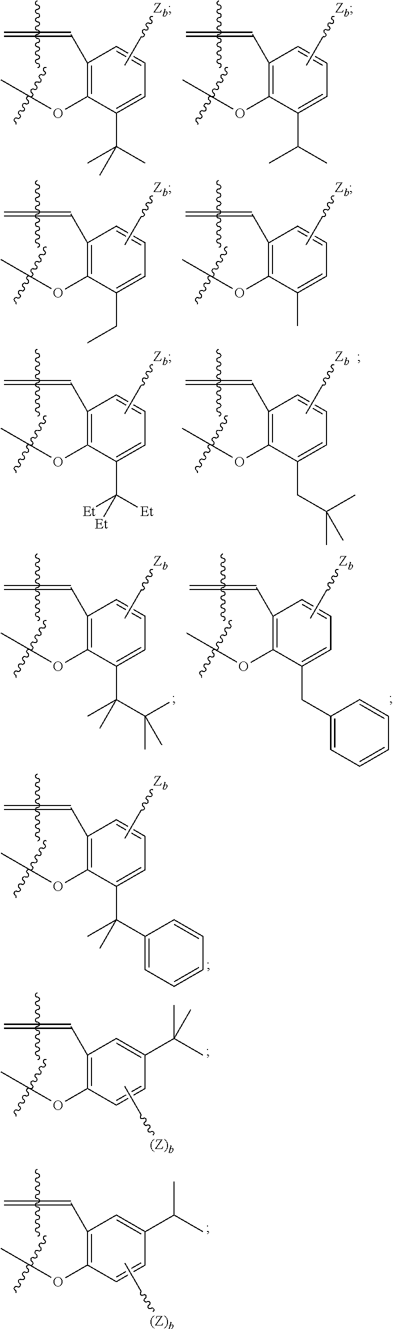

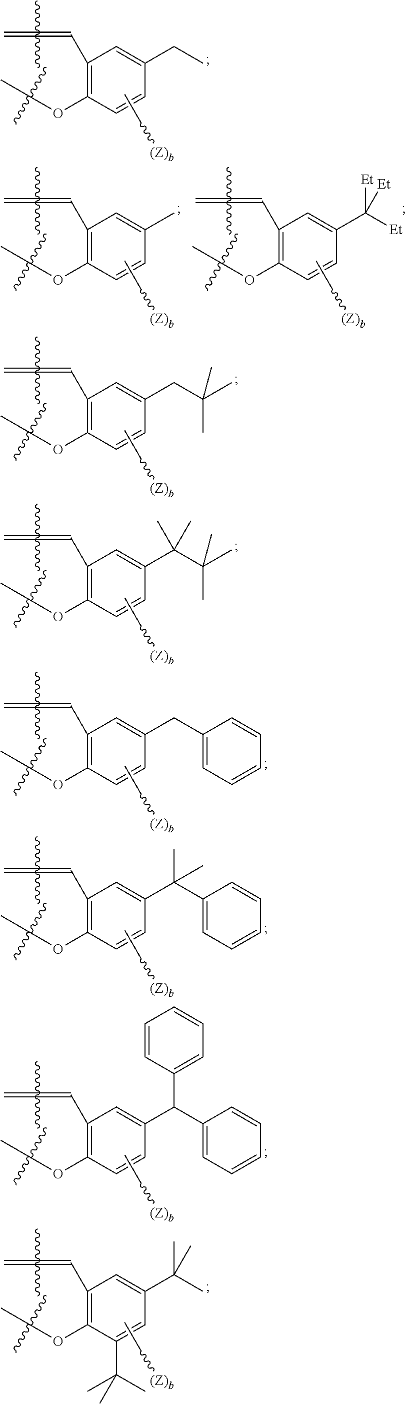

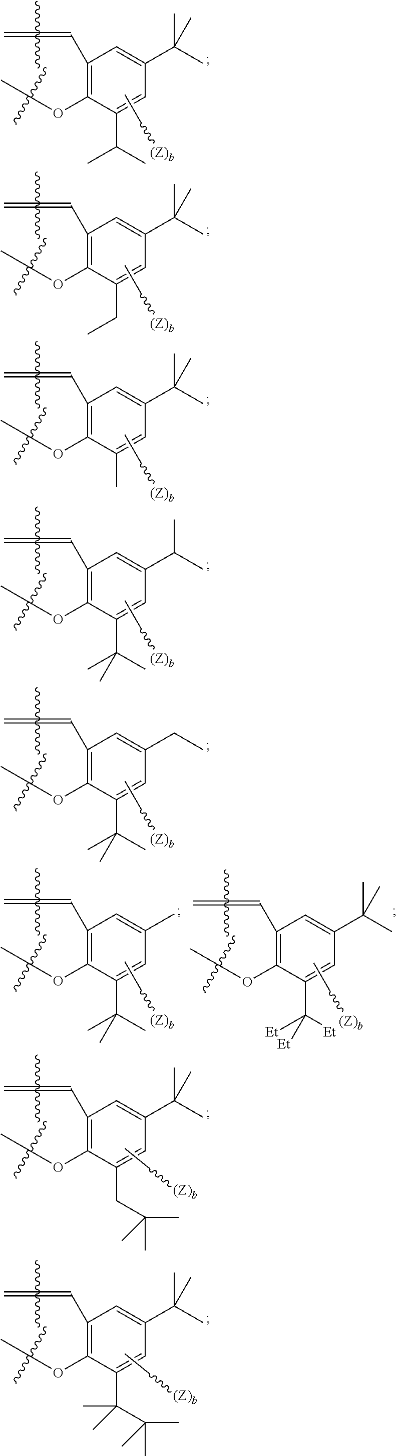

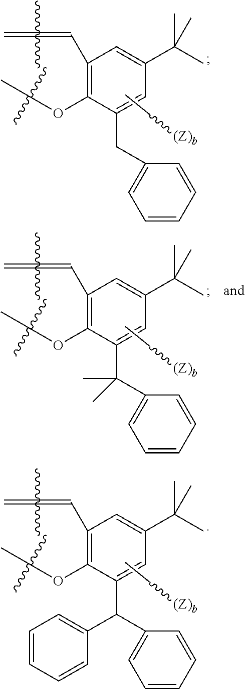

where [symbol] (Z)_{b} represents one or more independently-defined metal-coordinating moieties which may be bonded to any one or more of the unsubstituted positions of the salicylaldehyde-derived phenyl ring.

In certain embodiments, there is a metal-coordinating moiety tethered to the position ortho to the metal-bound oxygen substituent of one or both of the salicylaldehyde-derived phenyl rings of the salen ligand as in formulae IIIa and IIIb:

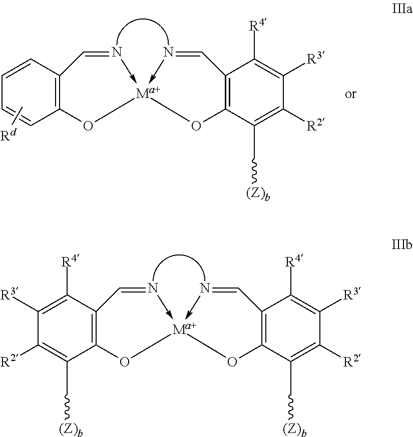

where each of M, a, R^{d}, [symbol] , and [symbol] (Z)_{b} is as defined above, and in the classes and subclasses herein, and
   R^{2′}, R^{3′}, and R^{4′}, are independently at each occurrence selected from the group consisting of: hydrogen, halogen, —NO₂, —CN, —SR^{y}, —S(O)R^{y}, —S(O)₂R^{y}, —NR^{y}C(O)R^{y}, —OC(O)R^{y}, —CO₂R, —NCO, —N₃, —OR⁴, —OC(O)N(R^{y})₂, —N(R^{y})₂, —NR^{y}C(O)R^{y}, —NR^{y}C(O)OR^{y}; SiR₃; or an optionally substituted group selected from the group consisting of C₁₋₂₀ aliphatic; C₁₋₂₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, or sulfur; and 4- to 7-membered heterocyclic having 1-2 heteroatoms independently selected from the group consisting of nitrogen, oxygen, and sulfur, where two or more adjacent R groups can be taken together to form an optionally substituted saturated, partially unsaturated, or aromatic 5- to 12-membered ring containing 0 to 4 heteroatoms, where R^{y} is as defined above.

In certain embodiments of metal complexes having formulae IIIa or IIIb, R^{2′} and R^{4′} are each hydrogen, and each R^{3′} is, independently, —H, or optionally substituted C₁-C₂₀ aliphatic.

In certain embodiments of metal complexes IIIa and IIIb, at least one of the phenyl rings comprising the salicylaldehyde-derived portion of the metal complex is independently selected from the group consisting of:

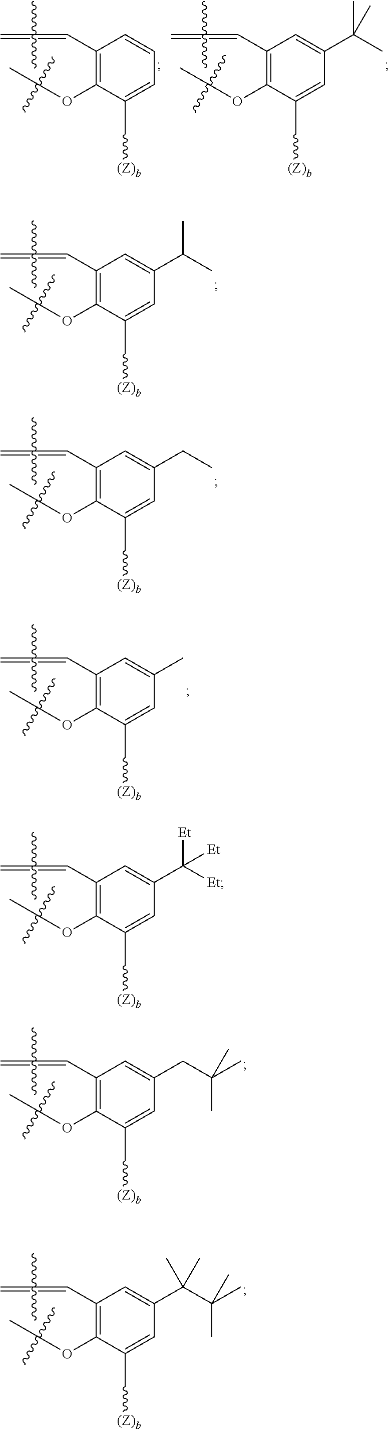

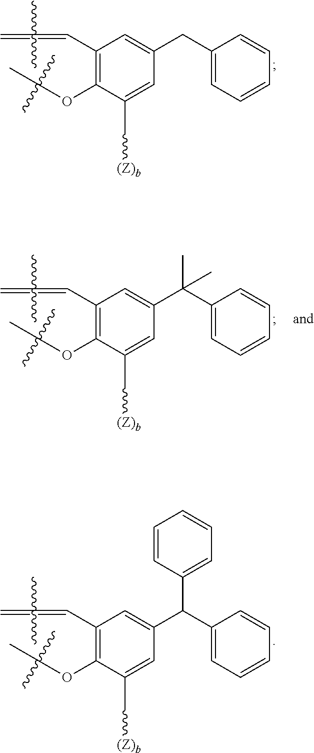

In other embodiments, there is a metal-coordinating moiety tethered to the position para to the phenolic oxygen of one or both of the salicylaldehyde-derived phenyl rings of the salen ligand as in structures IVa and IVb:

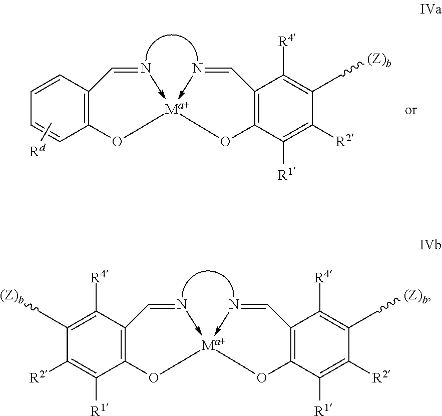

where each R^{1′} is independently selected from the group consisting of: hydrogen, halogen, —NO₂, —CN, —SR^{y}, —S(O)R^{y}, —S(O)₂R^{y}, —NR^{y}C(O)R^{y}, —OC(O)R^{y}, —CO₂R^{y}, —NCO, —N₃, —OR^{y}, —OC(O)N(R^{y})₂, —N(R^{y})₂, —NR^{y}C(O)R, —NR^{y}C(O)OR^{y}; or an optionally substituted group selected from the group consisting of C₁₋₂₀ aliphatic; C₁₋₂₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, or sulfur; and 4- to 7-membered heterocyclic having 1-2 heteroatoms independently selected from the group consisting of nitrogen, oxygen, and sulfur, where adjacent R¹ and R^{2′} groups can be taken together to form an optionally substituted saturated, partially unsaturated, or aromatic 5- to 12-membered ring containing 0 to 4 heteroatoms.

In certain embodiments of metal complexes having formulae IVa or IVb, R^{2′} and R^{4′} are hydrogen, and each R¹ is, independently, optionally substituted C₁-C₂₀ aliphatic.

In certain embodiments of metal complexes IVa and IVb, at least one of the phenyl rings comprising the salicylaldehyde-derived portion of the metal complex is independently selected from the group consisting of:

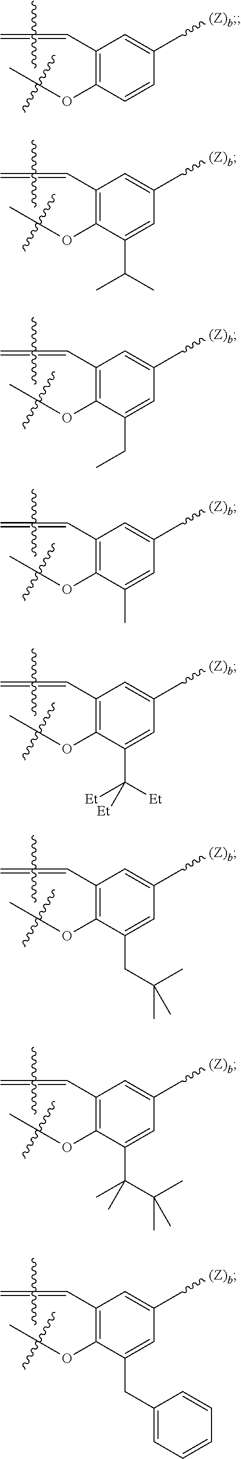

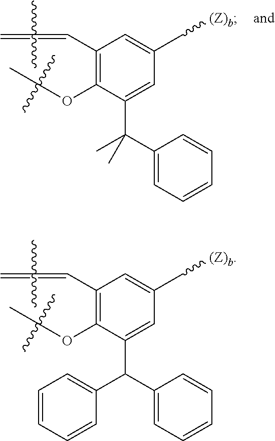

In still other embodiments, there is a metal-coordinating moiety tethered to the position para to the imine substituent of one or both of the salicylaldehyde-derived phenyl rings of the salen ligand as in formulae Va or Vb:

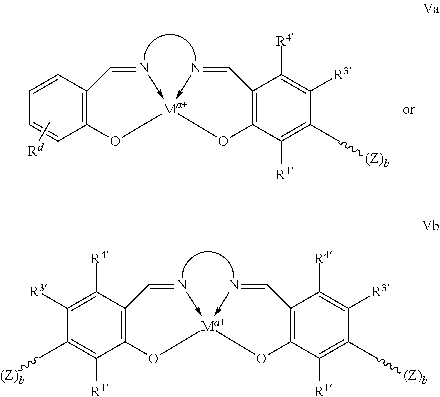

where M, a, R^{d}, R^{1′}, R^{3′}, R^{4′}, [symbol] , and [symbol] (Z)_{b} are as defined above and in the classes and subclasses herein.

In certain embodiments of metal complexes having formulae Va or Vb, each R^{4′} is hydrogen, and each R^{1′} and R^{3′} is, independently, hydrogen or optionally substituted C₁-C₂₀ aliphatic.

In certain embodiments of metal complexes Va and Vb, at least one of the phenyl rings comprising the salicylaldehyde-derived portion of the metal complex is independently selected from the group consisting of:

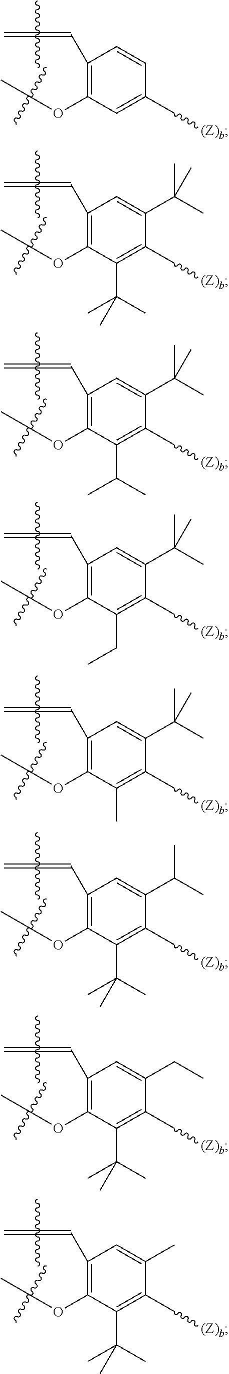

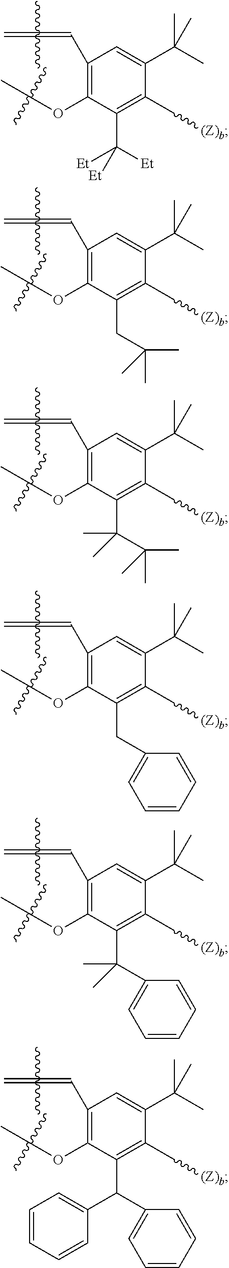

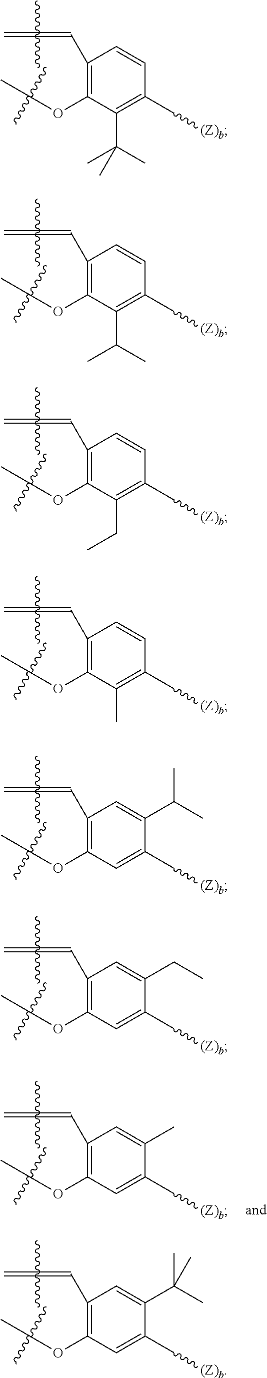

In still other embodiments, there is a metal-coordinating moiety tethered to the position ortho to the imine substituent of one or both of the salicylaldehyde-derived phenyl rings of the salen ligand as in formulae VIa and VIb:

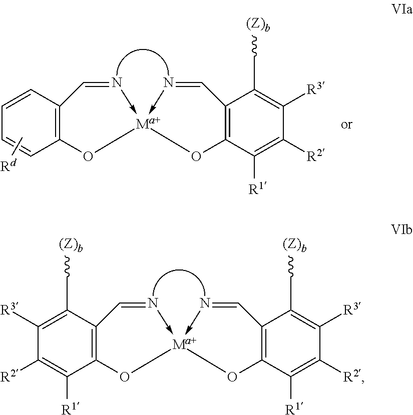

where M, a, R^{d}, R¹, R^{2′}, R^{3′}, [symbol] , and [symbol] (Z)_{b} are as defined above and in the classes and subclasses herein.

In certain embodiments of metal complexes having formulae VIa or VIb, each R^{2′} is hydrogen, and each R^{1′} and R^{3′} is, independently, hydrogen or optionally substituted C₁-C₂₀ aliphatic.

In certain embodiments of metal complexes VIa and VIb, at least one of the phenyl rings comprising the salicylaldehyde-derived portion of the metal complex is independently selected from the group consisting of:

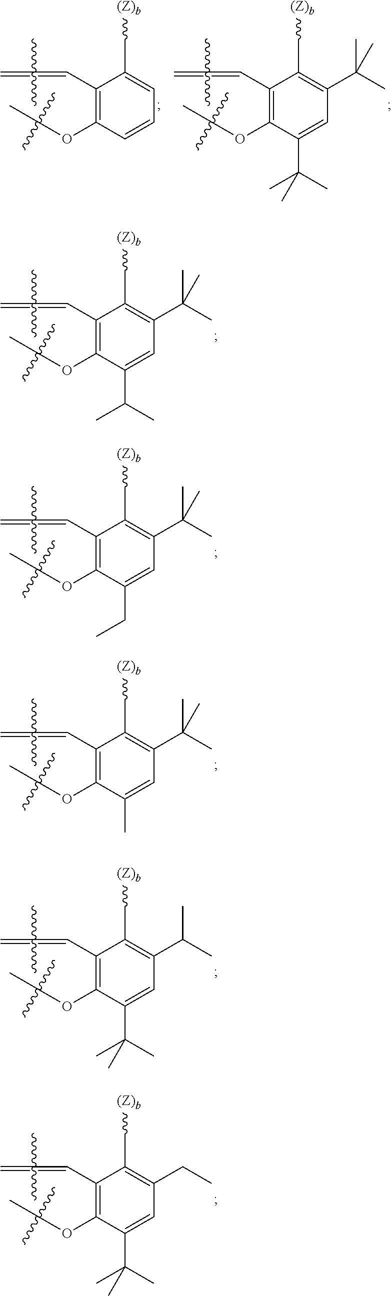

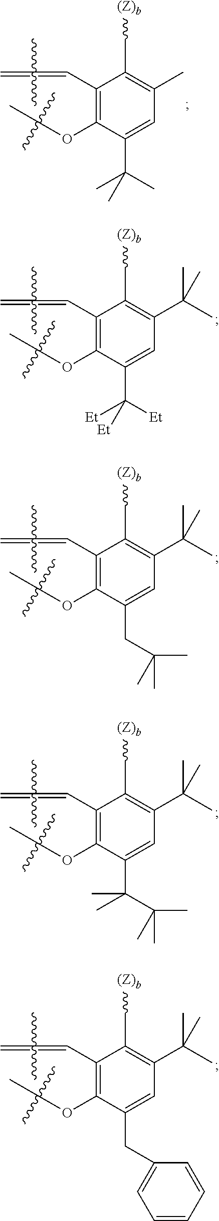

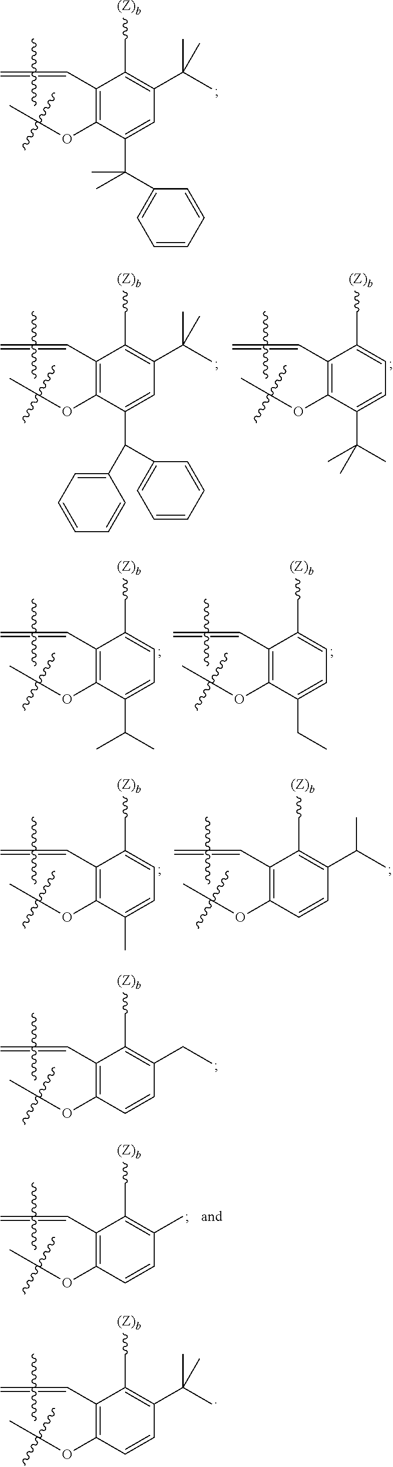

In still other embodiments, there are metal-coordinating moieties tethered to the position ortho to para to the phenolic oxygen of one or both of the salicylaldehyde-derived phenyl rings of the salen ligand as in formulae VIIa and VIIb:

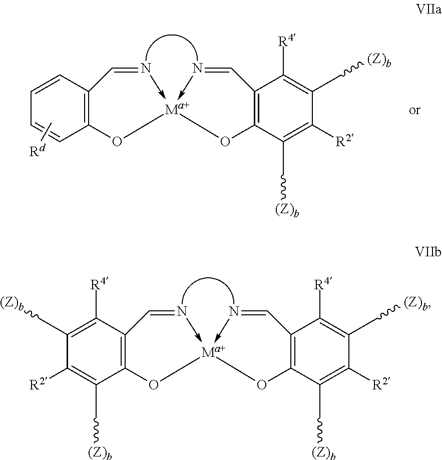

where each of M, a, R^{d}, R^{2′}, R^{4′}, [symbol] , and [symbol] n(Z)_{b} is as defined above and in the classes and subclasses herein.

In certain embodiments of compounds having formulae VIIa or VIIb, each R^{2′} and R^{4′}, independently, hydrogen or optionally substituted C₁-C₂₀ aliphatic.

In certain embodiments of compounds having formulae VIIa or VIIb, each R^{2′} and R^{4′} is hydrogen.

In still other embodiments, there are metal-coordinating moieties tethered to the positions ortho and para to the imine substituent of one or both of the salicylaldehyde-derived phenyl rings of the salen ligand as in formulae VIIIa and VIIIb:

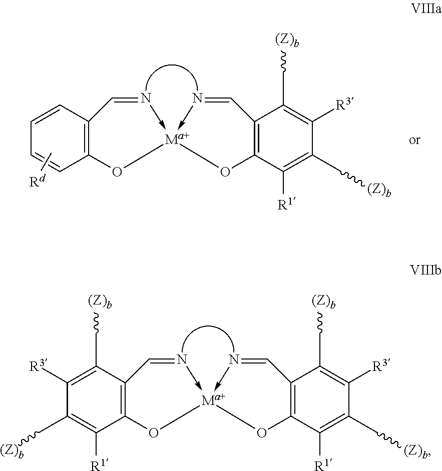

where each of M, a, R^{d}, R^{1′}, R^{3′}, [symbol] and [symbol] (Z)_{b} is as defined above and in the classes and subclasses herein.

In certain embodiments of metal complexes having formulae VIIIa or VIIIb, each R^{1′} and R^{3′} is, independently, optionally, hydrogen or substituted C₁-C₂₀ aliphatic.

In certain embodiments of the present invention, metal complexes of structures VIlla or VIIIb above, at least one of the phenyl rings comprising the salicylaldehyde-derived portion of the catalyst is independently selected from the group consisting of:

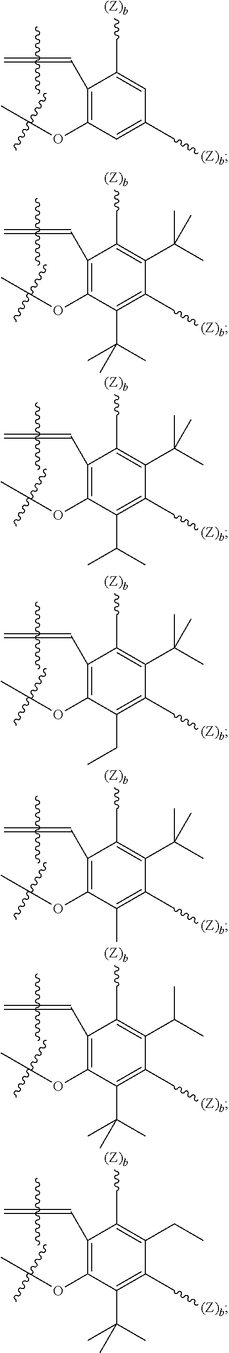

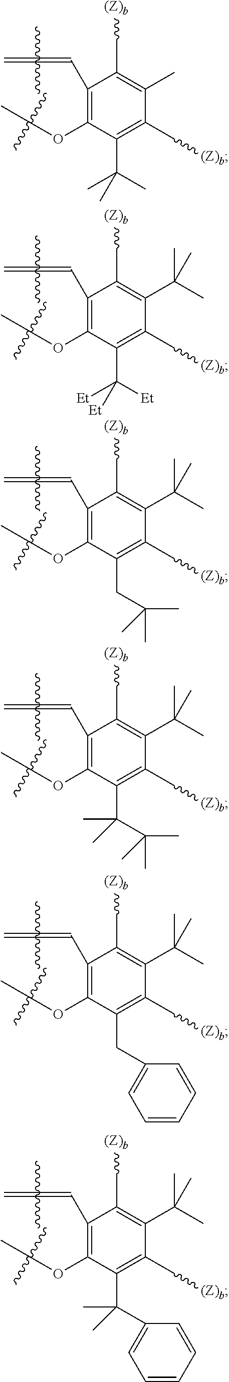

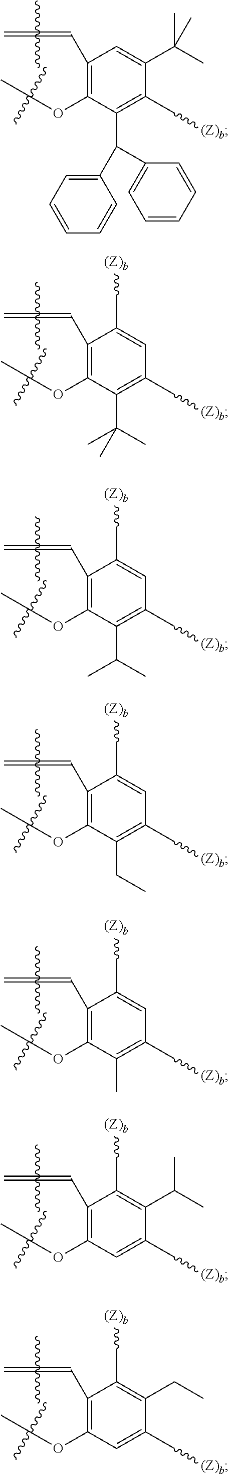

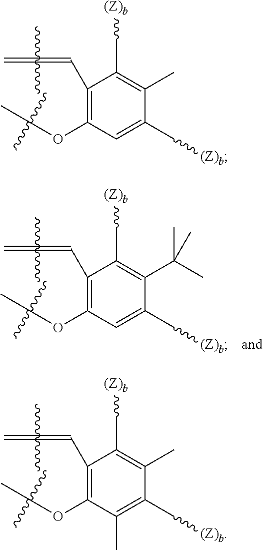

In yet other embodiments, there is a metal-coordinating moiety tethered to the imine carbon of the salen ligand as in formulae IXa and IXb:

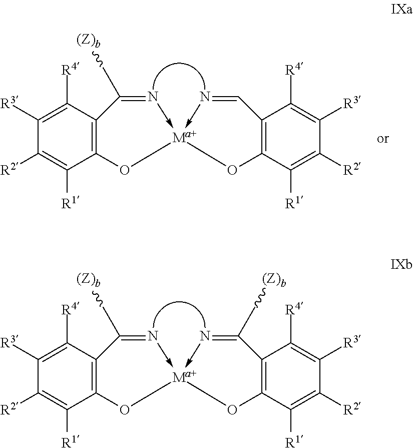

where M, a, R^{1′}, R^{2′}, R^{3′}, R^{4′}, [symbol] , and [symbol] (Z)_{b} are as defined above with the proviso that the atom of the metal-coordinating moiety attached to the salen ligand is a carbon atom.

In certain embodiments of compounds having formulae IXa or IXb, each R^{2′} and R^{4′} is hydrogen, and each R^{1′} and R^{3′} is, independently, hydrogen or optionally substituted C₁-C₂₀ aliphatic.

In certain embodiments of the present invention, catalysts of structures IXa or IXb above, at least one of the phenyl rings comprising the salicylaldehyde-derived portion of the metal complex is independently selected from the group consisting of:

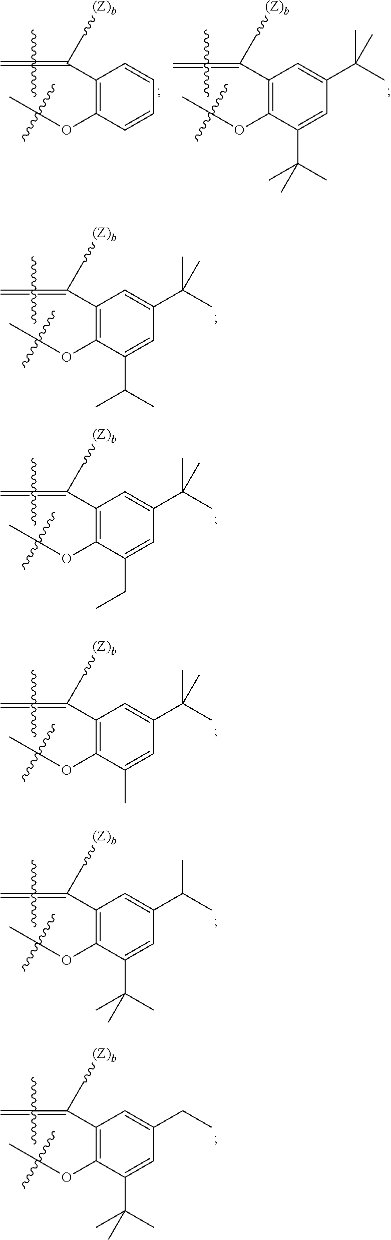

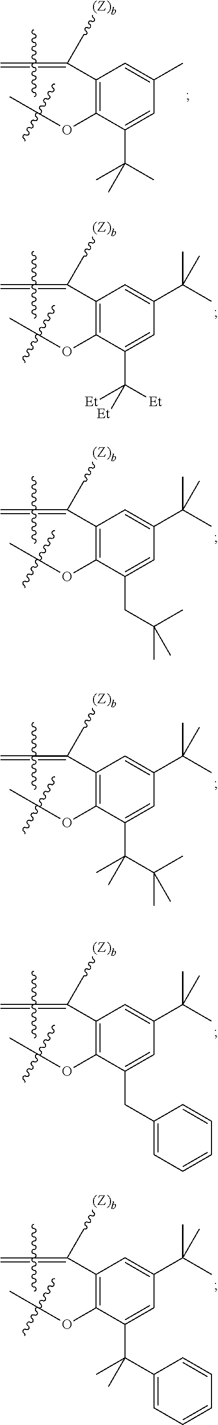

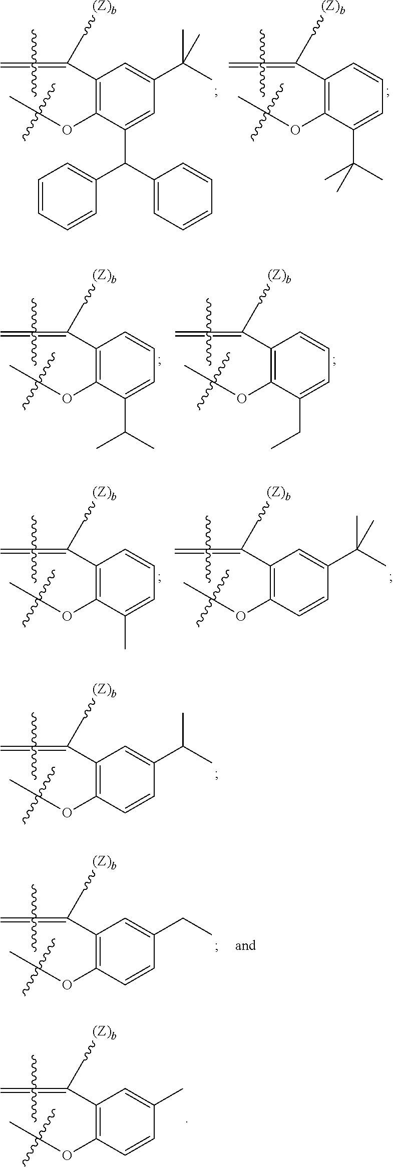

As shown above, the two phenyl rings derived from salicylaldehyde in the core salen structures need not be the same. Though not explicitly shown in formulae Ia through IXb above, it is to be understood that a metal complex may have a metal-coordinating moiety attached to different positions on each of the two rings, and such metal complexes are specifically encompassed within the scope of the present invention. Furthermore, metal-coordinating moieties can be present on multiple parts of the ligand, for instance metal-coordinating moieties can be present on the diamine bridge and on one or both phenyl rings in the same metal complex.

In certain embodiments, the salen ligand cores of metal complexes Ia through IXb above are selected from the group shown below wherein any available position may be independently substituted with one or more R-groups or one or more metal-coordinating moieties as described above.

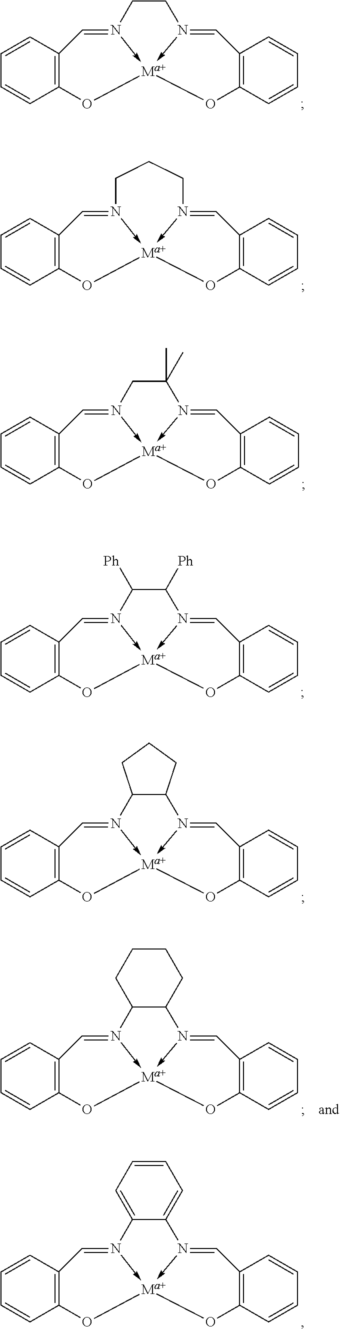

where M, a, and [symbol] (Z)_{b} are as defined above and in the classes and subclasses herein.

In another embodiment, at least one metal-coordinating moiety is tethered to the diamine-derived portion of the salen ligand, as shown in formula X:

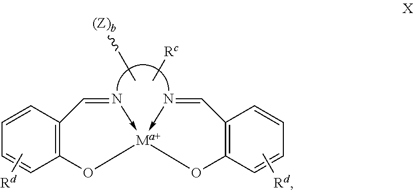

where M, a, R^{d}, R^{c}, [symbol] and [symbol] (Z)_{b} are as defined above and in the classes and subclasses herein.

In certain embodiments, salen ligands of formula X are selected from an optionally substituted moiety consisting of:

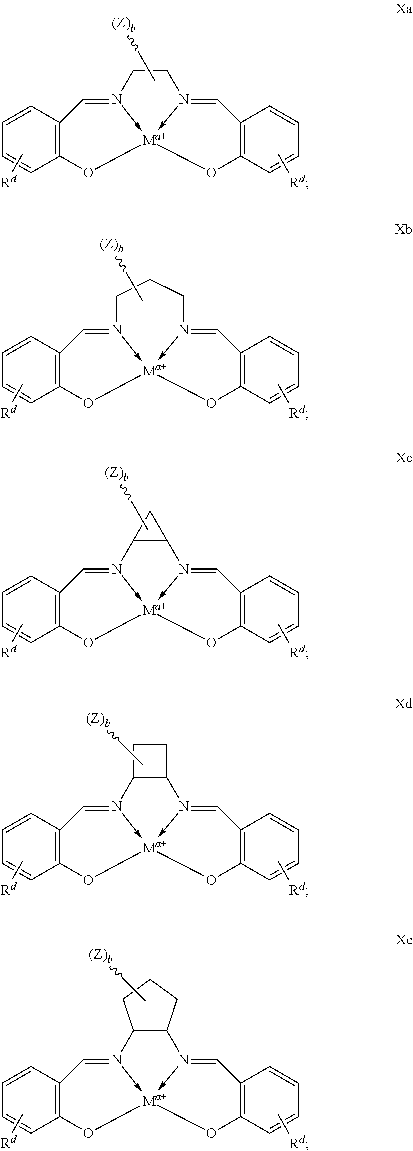

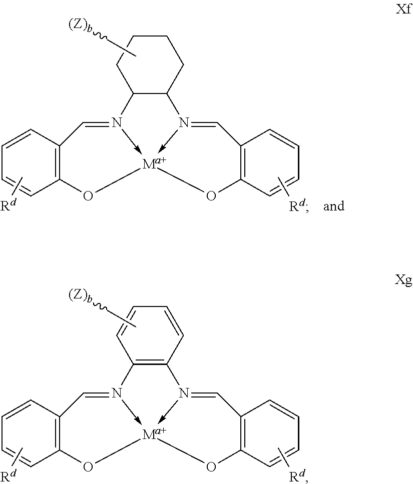

where M, a, R^{d}, and [symbol] (Z)_{b} are as defined above and in the classes and subclasses herein.

In certain embodiments, the diamine bridge of metal complexes of formula Xa an optionally substituted moiety selected from the group consisting of:

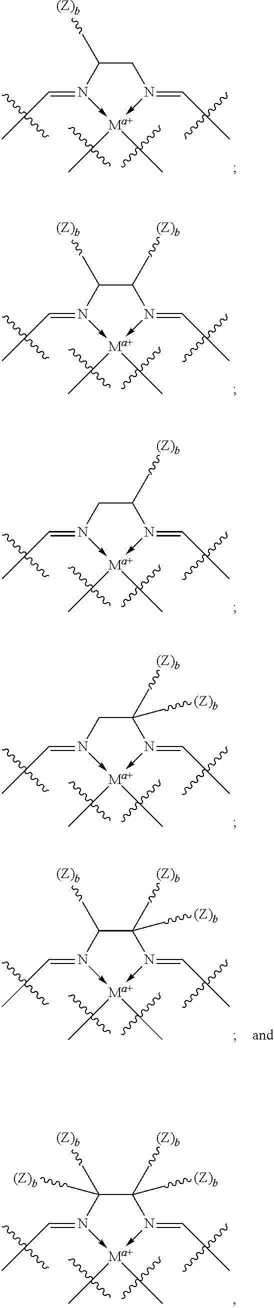

where each of M, a, and [symbol] (Z)_{b} is as defined above and described in the classes and subclasses herein.

In certain embodiments, catalysts of the present invention comprise metal-tmtaa complexes. In certain embodiments, the moiety

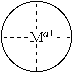

has the structure:

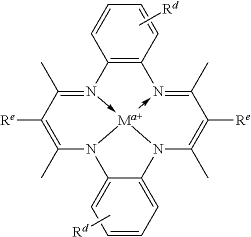

where M, a and R^{d} are as defined above and in the classes and subclasses herein, and
R^{e} at each occurrence is independently a metal-coordinating moiety ( [symbol] (Z)_{b}), hydrogen, halogen, —OR, —N(R₂), —SR, —CN, —NO₂, —SO₂R, —SOR, —SO₂N(R₂); —CNO, —NRSO₂R, —NCO, —N₃, —SiR₃; or an optionally substituted group selected from the group consisting of C₁₋₂₀ aliphatic; C₁₋₂₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, or sulfur; and 4- to 7-membered heterocyclic having 1-2 heteroatoms independently selected from the group consisting of nitrogen, oxygen, and sulfur.

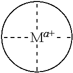

In certain embodiments, the moiety has the structure:

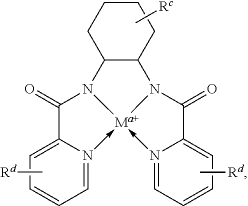

where each of M, a, R^{c}, and R^{d} is as defined above and in the classes and subclasses herein.

In certain embodiments, at least one metal-coordinating moiety is tethered to a diamine bridge of a ligand, as shown in formula III-a, III-b, and III-c:

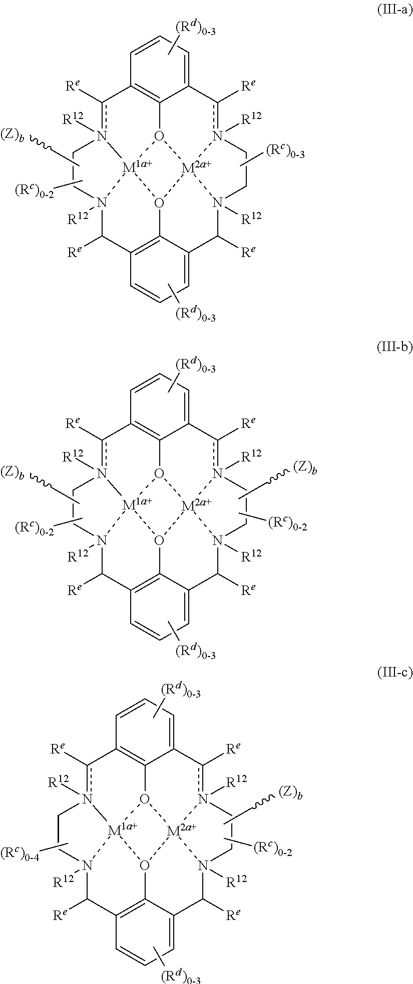

wherein each of R^{c}, R^{d}, R^{e}, Z, b, a, M¹, and M², is independently as defined above the described in classes and subclasses herein, and
R¹² is optionally present, and if present is selected from the group consisting of: a [symbol] (Z)_{b} group; or an optionally substituted radical selected from the group consisting of C₁₋₂₀ aliphatic; C₁₋₂₀ heteroaliphatic; and phenyl.

In certain embodiments, at least one metal-coordinating moiety is tethered to a diamine bridge of a ligand, as shown in formula IV-a, IV-b, and IV-c:

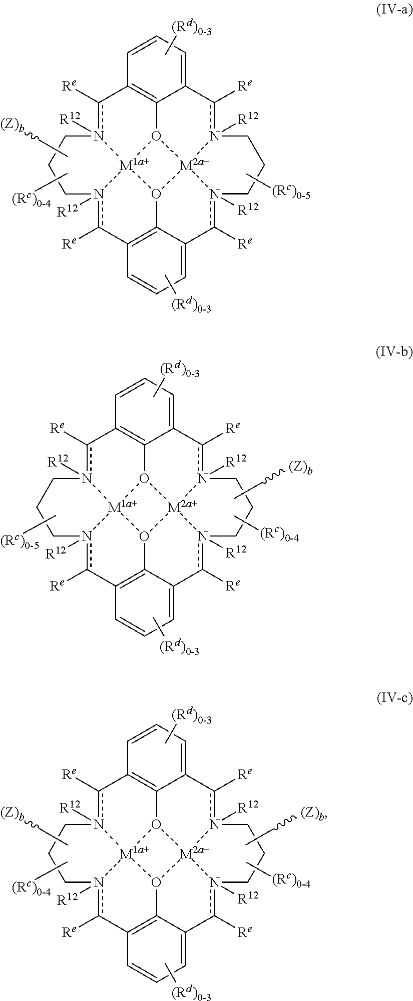

wherein each of R^{c}, R^{d}, R^{e}, Z, b, a, M¹, M², and R¹² is independently as defined above the described in classes and subclasses herein.

In certain embodiments, at least one metal-coordinating moiety is tethered to a cyclic diamine bridge of a ligand, as shown in formula V-a, V-b, and V-c:

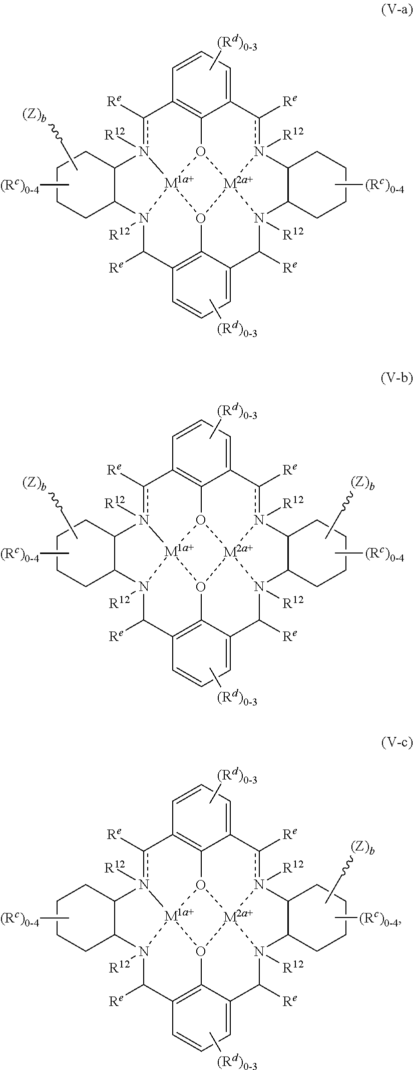

wherein each of R^{e}, R^{d}, R^{e}, Z, b, a, M¹, M², and R¹² is independently as defined above the described in classes and subclasses herein.

In certain embodiments, at least one metal-coordinating moiety is tethered to a cyclic diamine bridge of a ligand, as shown in formula VI-a, VI-b, and VI-c:

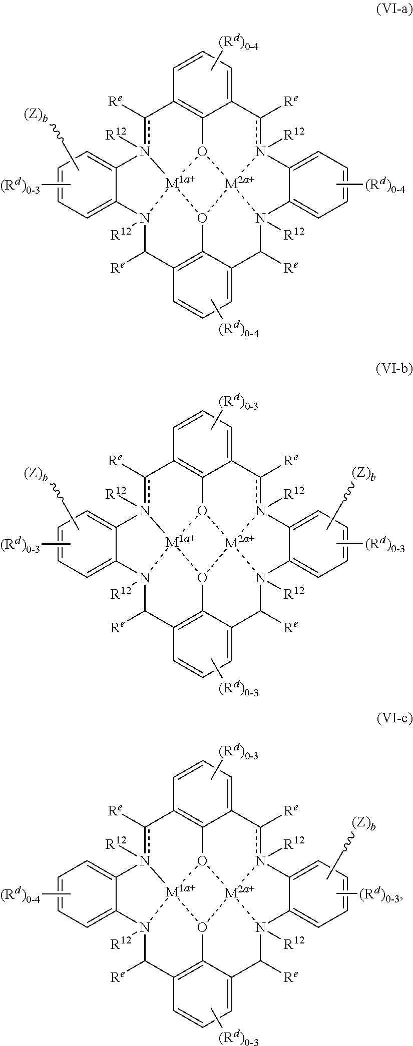

wherein each of R^{c}, R^{d}, R^{e}, Z, b, a, M¹, M², and R² is independently as defined above the described in classes and subclasses herein.

In certain embodiments, catalysts of the present invention comprise ligands capable of coordinating two metal atoms.

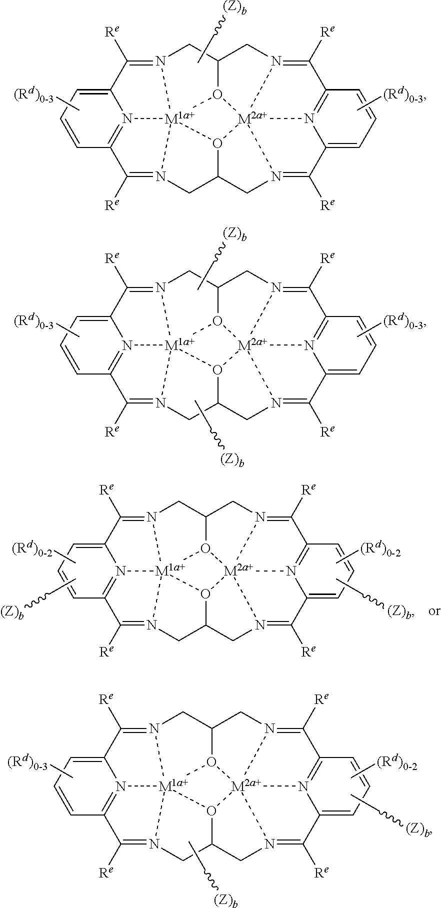

wherein each of R^{d}, R^{e}, M¹, M², b, a, and [symbol] (Z)_{b} is independently as defined above and described in classes and subclasses herein.
   IIb. Metal Atoms in the Acidic Metal Complexes

In certain embodiments, the metal atom M in any of the Lewis acidic metal complexes described above and in the classes, subclasses and tables herein, is selected from the periodic table groups 2-13, inclusive. In certain embodiments, M is a transition metal selected from the periodic table groups 4, 6, 11, 12 and 13. In certain embodiments, M is aluminum, chromium, titanium, indium, gallium, zinc cobalt, or copper. In certain embodiments, M is aluminum. In other embodiments, M is chromium.

In certain embodiments, M has an oxidation state of +2. In certain embodiments, M is Zn(II), Cu(II), Mn(II), Co(II), Ru(II), Fe(II), Co(II), Rh(II), Ni(II), Pd(II) or Mg(II). In certain embodiments M is Zn(II). In certain embodiments M is Cu(II).

In certain embodiments, M has an oxidation state of +3. In certain embodiments, M is Al(III), Cr(III), Fe(III), Co(III), Ti(III) In(III), Ga(III) or Mn(III). In certain embodiments M is Al(III). In certain embodiments M is Cr(III).

In certain embodiments, M has an oxidation state of +4. In certain embodiments, M is Ti(IV) or Cr(IV).

In certain embodiments, M¹ and M² are each independently a metal atom selected from the periodic table groups 2-13, inclusive. In certain embodiments, each M¹ and M² is a transition metal selected from the periodic table groups 4, 6, 11, 12 and 13. In certain embodiments, M¹ and M² are selected from aluminum, chromium, titanium, indium, gallium, zinc cobalt, or copper. In certain embodiments, M¹ and M² are aluminum. In other embodiments, M¹ and M² are chromium. In certain embodiments, M¹ and M² are the same. In certain embodiments, M¹ and M² are the same metal, but have different oxidation states. In certain embodiments, M¹ and M² are different metals.

In certain embodiments, one or more of M¹ and M² has an oxidation state of +2. In certain embodiments, M¹ is Zn(II), Cu(II), Mn(II), Co(II), Ru(II), Fe(II), Co(II), Rh(II), Ni(II), Pd(II) or Mg(II). In certain embodiments M¹ is Zn(II). In certain embodiments M¹ is Cu(II). In certain embodiments, M² is Zn(II), Cu(II), Mn(II), Co(II), Ru(II), Fe(II), Co(II), Rh(II), Ni(II), Pd(II) or Mg(II). In certain embodiments M² is Zn(II). In certain embodiments M² is Cu(II).

In certain embodiments, one or more of M¹ and M² has an oxidation state of +3. In certain embodiments, M¹ is Al(III), Cr(III), Fe(III), Co(III), Ti(III) In(III), Ga(III) or Mn(III). In certain embodiments M¹ is Al(III). In certain embodiments M¹ is Cr(III). In certain embodiments, M² is Al(III), Cr(III), Fe(III), Co(III), Ti(III) In(III), Ga(III) or Mn(III). In certain embodiments M² is Al(III). In certain embodiments M² is Cr(III).

In certain embodiments, one or more of M¹ and M² has an oxidation state of +4. In certain embodiments, M¹ is Ti(IV) or Cr(IV). In certain embodiments, M² is Ti(IV) or Cr(IV).

In certain embodiments, one or more neutral two electron donors coordinate to M M¹ or M² and fill the coordination valence of the metal atom. In certain embodiments, the neutral two electron donor is a solvent molecule. In certain embodiments, the neutral two electron donor is an ether. In certain embodiments, the neutral two electron donor is tetrahydrofuran, diethyl ether, acetonitrile, carbon disulfide, or pyridine. In certain embodiments, the neutral two electron donor is tetrahydrofuran. In certain embodiments, the neutral two electron donor is an epoxide. In certain embodiments, the neutral two electron donor is an ester or a lactone.

### III. The Metal Carbonyl Component

As noted above, catalysts of the present invention comprise at least one metal carbonyl compound. Typically, a single metal carbonyl compound is provided, but in certain embodiments mixtures of two or more metal carbonyl compounds are provided. (Thus, when a provided metal carbonyl compound “comprises”, e.g., a neutral metal carbonyl compound, it is understood that the provided metal carbonyl compound can be a single neutral metal carbonyl compound, or a neutral metal carbonyl compound in combination with one or more other metal carbonyl compounds.) Preferably, the provided metal carbonyl compound is capable of ring-opening an epoxide and facilitating the insertion of CO into the resulting metal carbon bond. Metal carbonyl compounds with this reactivity are well known in the art and are used for laboratory experimentation as well as in industrial processes such as hydroformylation.

In certain embodiments, a provided metal carbonyl compound comprises an anionic metal carbonyl moiety. In other embodiments, a provided metal carbonyl compound comprises a neutral metal carbonyl compound. In certain embodiments, a provided metal carbonyl compound comprises a metal carbonyl hydride or a hydrido metal carbonyl compound. In some embodiments, a provided metal carbonyl compound acts as a pre-catalyst which reacts in situ with one or more other components to provide an active species different from the compound initially provided. Such pre-catalysts are specifically encompassed by the present invention as it is recognized that the active species in a given reaction may not be known with certainty; thus the identification of such a reactive species in situ does not itself depart from the spirit or teachings of the present invention.

In certain embodiments, the metal carbonyl compound comprises an anionic metal carbonyl species. In certain embodiments, such anionic metal carbonyl species have the general formula [Q_{d}M′ₑ(CO)_{w}]^{y-}, where Q is any ligand and need not be present, M′ is a metal atom, d is an integer between 0 and 8 inclusive, e is an integer between 1 and 6 inclusive, w is a number such as to provide the stable anionic metal carbonyl complex, and y is the charge of the anionic metal carbonyl species. In certain embodiments, the anionic metal carbonyl has the general formula [QM′(CO)_{w}]^{y-}, where Q is any ligand and need not be present, M′ is a metal atom, w is a number such as to provide the stable anionic metal carbonyl, and y is the charge of the anionic metal carbonyl.

In certain embodiments, the anionic metal carbonyl species include monoanionic carbonyl complexes of metals from groups 5, 7, or 9 of the periodic table or dianionic carbonyl complexes of metals from groups 4 or 8 of the periodic table. In some embodiments, the anionic metal carbonyl compound contains cobalt or manganese. In some embodiments, the anionic metal carbonyl compound contains rhodium. Suitable anionic metal carbonyl compounds include, but are not limited to: [Co(CO)₄], [Ti(CO)₆]²⁻, [V(CO)₆]⁻, [Rh(CO)₄]⁻, [Fe(CO)₄]²⁻, [Ru(CO)₄]²⁻, [Os(CO)₄]²⁻, [Cr₂(CO)₁₀]²⁻, [Fe₂(CO)₈]²⁻, [Tc(CO)₅]⁻, [Re(CO)₅]⁻, [Mn(CO)₅]⁻, or combinations thereof. In certain embodiments, the anionic metal carbonyl comprises [Co(CO)₄]⁻. In some embodiments, a mixture of two or more anionic metal carbonyl complexes may be present in the polymerization system.

The term “such as to provide a stable anionic metal carbonyl” for [Q_{d}M′ₑ(CO)_{w}]^{y-} is used herein to mean that [Q_{d}M′ₑ(CO)_{w}]^{y-} is a species characterizable by analytical means, e.g., NMR, IR, X-ray crystallography, Raman spectroscopy and/or electron spin resonance (EPR) and isolable in catalyst form in the presence of a suitable cation or a species formed in situ. It is to be understood that metals which can form stable metal carbonyl complexes have known coordinative capacities and propensities to form polynuclear complexes which, together with the number and character of optional ligands Q that may be present and the charge on the complex will determine the number of sites available for CO to coordinate and therefore the value of w. Typically, such compounds conform to the “18-electron rule”. Such knowledge is within the grasp of one having ordinary skill in the arts pertaining to the synthesis and characterization of metal carbonyl compounds.

In embodiments where the provided metal carbonyl compound is an anionic species, one or more cations must also necessarily be present. The present invention places no particular constraints on the identity of such cations. In certain embodiments, the cation associated with an anionic metal carbonyl compound comprises a reaction component of another category described hereinbelow. For example, in certain embodiments, the metal carbonyl anion is associated with a Lewis acidic metal complex as described above wherein the metal complex has a net positive charge. In other embodiments a cation associated with a provided anionic metal carbonyl compound is a simple metal cation such as those from Groups 1 or 2 of the periodic table (e.g. Na⁺, Li⁺, K⁺, Mg²⁺ and the like). In other embodiments a cation associated with a provided anionic metal carbonyl compound is a bulky non electrophilic cation such as an ‘onium salt’ (e.g. Bu₄N+, PPN⁺, Ph₄P Ph₄As⁺, and the like). In other embodiments, a metal carbonyl anion is associated with a protonated nitrogen compound, (e.g. a cation may comprise a compound such as MeTBD-H⁺, DMAP-H⁺, DABCO-H⁺, DBU-H⁺ and the like).

In certain embodiments, a provided metal carbonyl compound comprises a neutral metal carbonyl. In certain embodiments, such neutral metal carbonyl compounds have the general formula Q_{d}M′ₑ(CO)_{w′}, where Q is any ligand and need not be present, M′ is a metal atom, d is an integer between 0 and 8 inclusive, e is an integer between 1 and 6 inclusive, and w′ is a number such as to provide the stable neutral metal carbonyl complex. In certain embodiments, the neutral metal carbonyl has the general formula QM′(CO)_{w′}. In certain embodiments, the neutral metal carbonyl has the general formula M′(CO)_{w′}. In certain embodiments, the neutral metal carbonyl has the general formula QM′₂(CO)_{w′}. In certain embodiments, the neutral metal carbonyl has the general formula M′₂(CO)_{w′}. Suitable neutral metal carbonyl compounds include, but are not limited to: Ti(CO)₇, V₂(CO)₁₂, Cr(CO)₆, Mo(CO)₆, W(CO)₆, Mn₂(CO)₁₀, Tc₂(CO)₁₀, Re₂(CO)₁₀, Fe(CO)₅, Ru(CO)₅, Os(CO)₅, Ru₃(CO)₁₂, Os₃(CO)₁₂, Fe₃(CO)₁₂, Fe₂(CO)₉, Co₄(CO)₁₂, Rh₄(CO)₁₂, Rh₆(CO)₁₆, Ir₄(CO)₁₂, Co₂(CO)₈, Ni(CO)₄, or a combination thereof.

The term “such as to provide a stable neutral metal carbonyl for Q_{d}M′ₑ(CO)_{w},” is used herein to mean that Q_{d}M′ₑ(CO)_{w}, is a species characterizable by analytical means, e.g., NMR, IR, X-ray crystallography, Raman spectroscopy and/or electron spin resonance (EPR) and isolable in pure form or a species formed in situ. It is to be understood that metals which can form stable metal carbonyl complexes have known coordinative capacities and propensities to form polynuclear complexes which, together with the number and character of optional ligands Q that may be present will determine the number of sites available for CO to coordinate and therefore the value of w′. Typically, such compounds conform to stoichiometries conforming to the “18-electron rule”. Such knowledge is within the grasp of one having ordinary skill in the arts pertaining to the synthesis and characterization of metal carbonyl compounds.

In certain embodiments, one or more of the CO ligands of any of the metal carbonyl compounds described above is replaced with a ligand Q. In certain embodiments, Q is a phosphine ligand. In certain embodiments, Q is a triaryl phosphine. In certain embodiments, Q is trialkyl phosphine. In certain embodiments, Q is a phosphite ligand. In certain embodiments, Q is an optionally substituted cyclopentadienyl ligand. In certain embodiments, Q is cp. In certain embodiments, Q is cp*.

In certain embodiments, catalysts of the present invention comprise hydrido metal carbonyl compounds. In certain embodiments, such compounds are provided as the hydrido metal carbonyl compound, while in other embodiments, the hydrido metal carbonyl is generated in situ by reaction with hydrogen gas, or with a protic acid using methods known in the art (see for example Chem. Rev., 1972, 72 (3), pp 231-281 DOI: 10.1021/cr60277a003, the entirety of which is incorporated herein by reference).

In certain embodiments, the hydrido metal carbonyl (either as provided or generated in situ) comprises one or more of HCo(CO)₄, HCoQ(CO)₃, HMn(CO)₅, HMn(CO)₄Q, HW(CO)₃Q, HRe(CO)₅, HMo(CO)₃Q, HOs(CO)₂Q, HMo(CO)₂Q₂, HFe(CO₂)Q, HW(CO)₂Q₂, HRuCOQ₂, H₂Fe(CO)₄, or H₂Ru(CO)₄, where each Q is independently as defined above and in the classes and subclasses herein. In certain embodiments, the metal carbonyl hydride (either as provided or generated in situ) comprises HCo(CO)₄. In certain embodiments, the metal carbonyl hydride (either as provided or generated in situ) comprises HCo(CO)₃PR₃, where each R is independently an optionally substituted aryl group, an optionally substituted C₁₋₂₀ aliphatic group, an optionally substituted C₁₋₁₀ alkoxy group, or an optionally substituted phenoxy group. In certain embodiments, the metal carbonyl hydride (either as provided or generated in situ) comprises HCo(CO)₃cp, where cp represents an optionally substituted pentadienyl ligand. In certain embodiments, the metal carbonyl hydride (either as provided or generated in situ) comprises HMn(CO)₅. In certain embodiments, the metal carbonyl hydride (either as provided or generated in situ) comprises H₂Fe(CO)₄.

In certain embodiments, for any of the metal carbonyl compounds described above, M′ comprises a transition metal. In certain embodiments, for any of the metal carbonyl compounds described above, M′ is selected from Groups 5 (Ti) to 10 (Ni) of the periodic table. In certain embodiments, M′ is a Group 9 metal. In certain embodiments, M′ is Co. In certain embodiments, M′ is Rh. In certain embodiments, M′ is Ir. In certain embodiments, M′ is Fe. In certain embodiments, M′ is Mn.

In certain embodiments, one or more ligands Q is present in a provided metal carbonyl compound. In certain embodiments, Q is a phosphine ligand. In certain embodiments, Q is a triaryl phosphine. In certain embodiments, Q is trialkyl phosphine. In certain embodiments, Q is a phosphite ligand. In certain embodiments, Q is an optionally substituted cyclopentadienyl ligand. In certain embodiments, Q is cp. In certain embodiments, Q is cp*.

In certain embodiments, the anionic metal carbonyl compound has the general formula [Q_{d}M′ₑ(CO)_{w}]Y, where Q is any ligand and need not be present, M′ is a metal atom, d is an integer between 0 and 8 inclusive, e is an integer between 1 and 6 inclusive, w is a number such as to provide the stable anionic metal carbonyl complex, and x is the charge of the anionic metal carbonyl compound. In certain embodiments, the anionic metal carbonyl has the general formula [QM′(CO)_{w}]^{y-}, where Q is any ligand and need not be present, M′ is a metal atom, w is a number such as to provide the stable anionic metal carbonyl, and y is the charge of the anionic metal carbonyl.

In certain embodiments, the anionic metal carbonyl compounds include monoanionic carbonyl complexes of metals from groups 5, 7, or 9 of the periodic table and dianionic carbonyl complexes of metals from groups 4 or 8 of the periodic table. In some embodiments, the anionic metal carbonyl compound contains cobalt or manganese. In some embodiments, the anionic metal carbonyl compound contains rhodium. Suitable anionic metal carbonyl compounds include, but are not limited to: [Co(CO)₄]⁻, [Ti(CO)₆]²⁻, [V(CO)₆]⁻, [Rh(CO)₄]⁻, [Fe(CO)₄]²⁻, [Ru(CO)₄]²⁻, [Os(CO)₄]²⁻, [Cr₂(CO)₁₀]²⁻, [Fe₂(CO)₈]²⁻, [Tc(CO)₅]⁻, [Re(CO)₅], [Mn(CO)₅], or combinations thereof. In certain embodiments, the anionic metal carbonyl is [Co(CO)₄]⁻. In some cases, a mixture of two or more anionic metal carbonyl complexes may be present in the catalyst.

The term “such as to provide a stable anionic metal carbonyl for [Q_{d}M′ₑ(CO)_{w}]^{y-}” is used herein to mean that [Q_{d}M′ₑ(CO)_{w}]^{y-} is a species characterizable by analytical means, e.g., NMR, IR, X-ray crystrallography, Raman spectroscopy and/or electron spin resonance (EPR) and isolable in catalyst form as the anion for a metal complex cation or a species formed in situ.

In certain embodiments, one or two of the CO ligands of any of the metal carbonyl compounds described above is replaced with a ligand Q. In certain embodiments, the ligand Q is present and represents a phosphine ligand. In certain embodiments, Q is present and represents a cyclopentadienyl (cp) ligand.

### IV. Carbonylation Catalysts

In certain embodiments, catalysts of the present invention include the combination of:
i) one or more metal-coordinating moieties, where each metal-coordinating moiety comprises the combination of a linker as defined in Section Ia above and 1 to 4 metal-coordinating groups as defined in Section Ib above;
ii) one or more ligands as defined in Section IIa to which at least one metal-coordinating moiety is covalently tethered and the ligand(s) is/are coordinated to one or two metal atoms as described in Section IIb to form a Lewis acidic metal complex; and
iii) at least one metal carbonyl species as described in Section III.

In certain embodiments, catalysts of the present invention include the combination of:
i) a Lewis acidic metal complex comprising one or two metal atoms coordinated to at least one ligand said ligand bearing at least one covalently tethered metal-coordinating moiety of formula [symbol] (Z)_{b},
   where, [symbol] is selected from the group consisting of:

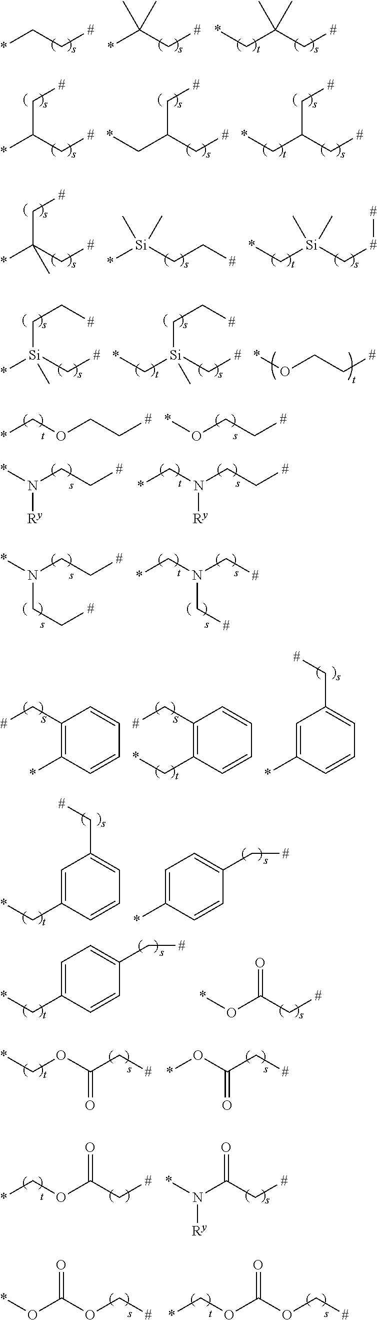

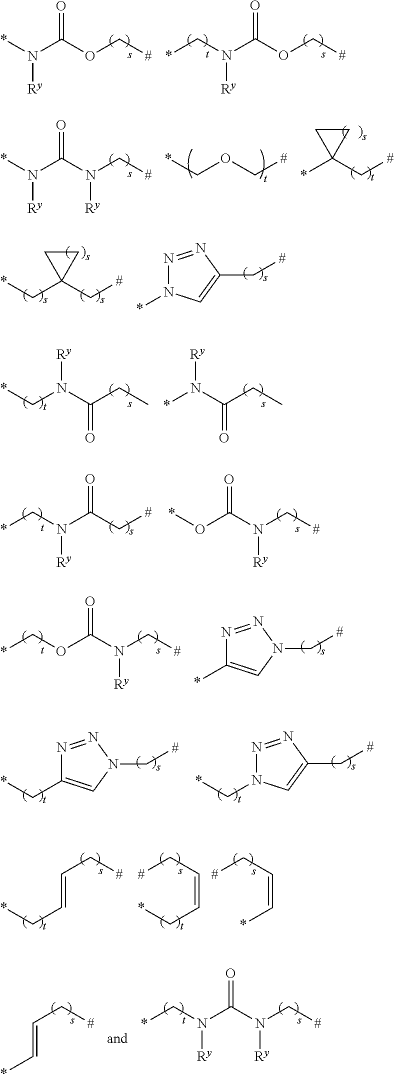

where R^{y} is as defined above and described in classes and subclasses herein, and each s is independently 0-6, t is 0-4, * represents the site of attachment to a ligand, and each # represents a site of attachment of a metal-coordinating group Z, and
each —Z is independently selected from a neutral nitrogen-containing functional group, a neutral nitrogen-containing heterocycle or heteroaryl, a phosphorous-containing functional group and a boron containing functional group;
and,
ii) an anionic metal carbonyl compound of formula [Q_{d}M′ₑ(CO)_{w}]^{y-},
   where Q is any ligand and need not be present,
   M′ is a metal atom,
   d is an integer between 0 and 8 inclusive,
   e is an integer between 1 and 6 inclusive,
   w is a number such as to provide the stable anionic metal carbonyl complex, and
   y is the charge of the anionic metal carbonyl species.

In certain embodiments, catalysts of the present invention include the combination of:
a metal carbonyl compound, and
a Lewis acidic metal complex selected from Table A1, where Z and M are as defined above and in the classes and subclasses herein:

TABLE A1

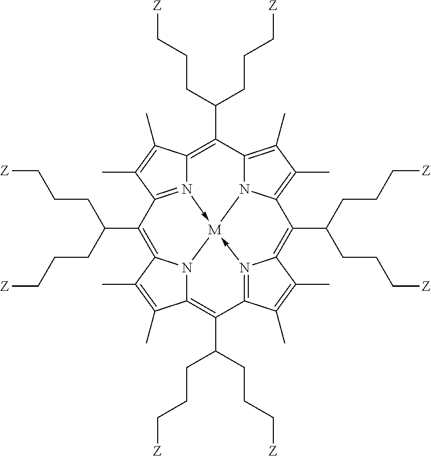

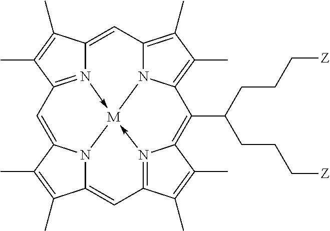

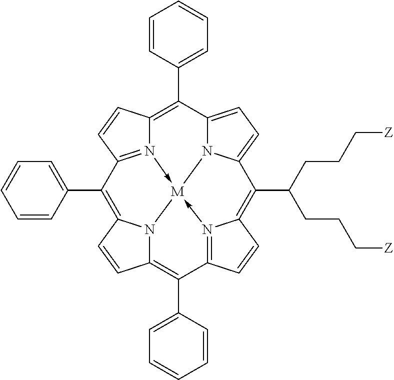

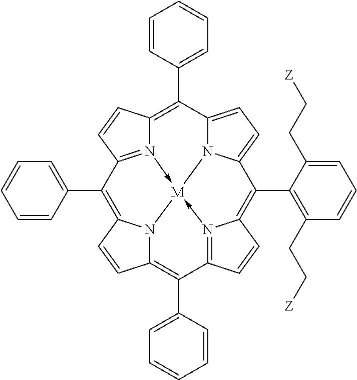

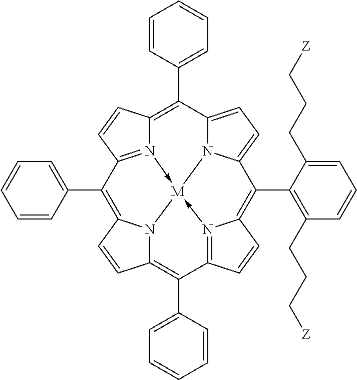

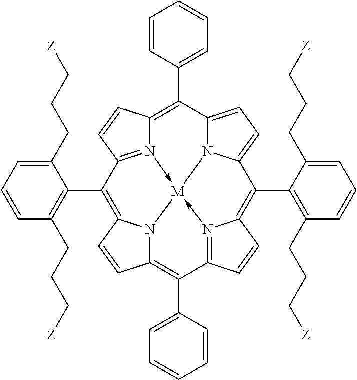

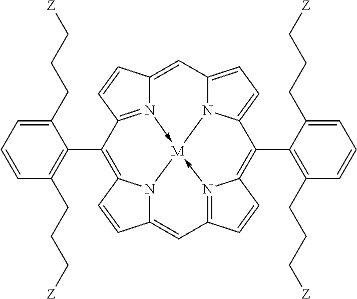

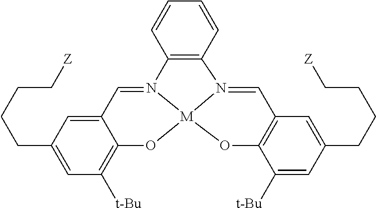

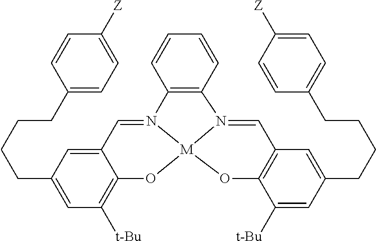

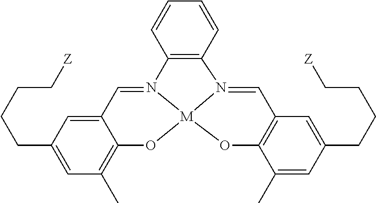

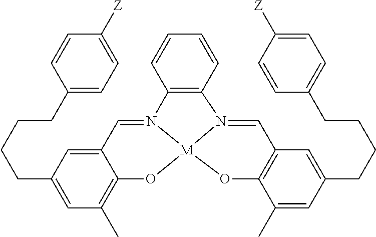

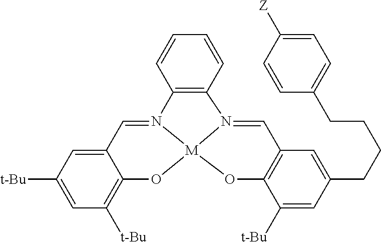

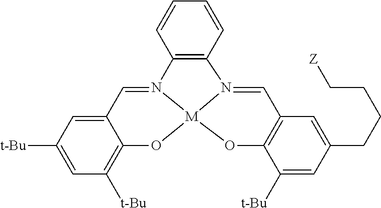

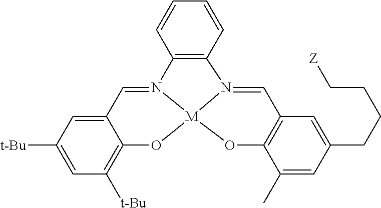

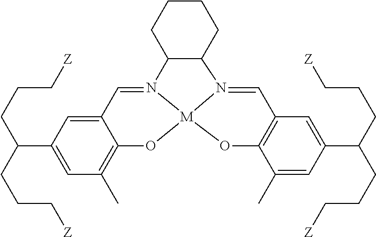

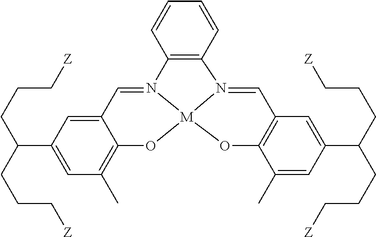

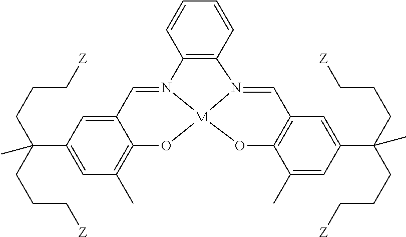

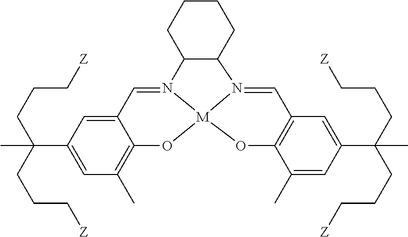

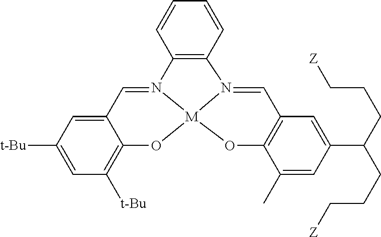

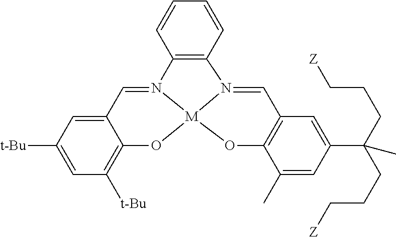

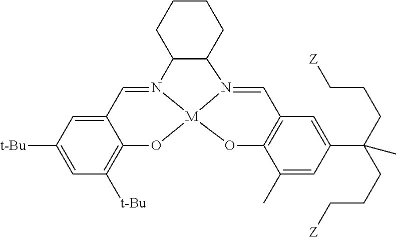

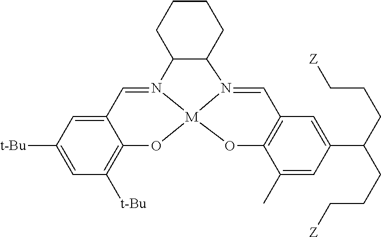

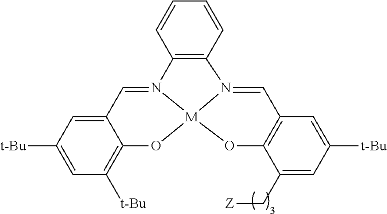

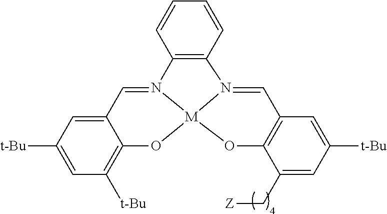

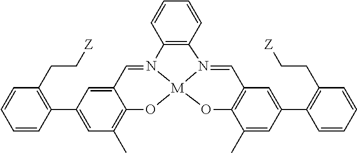

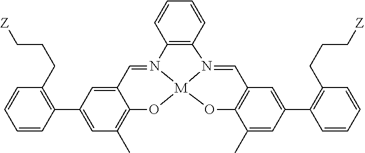

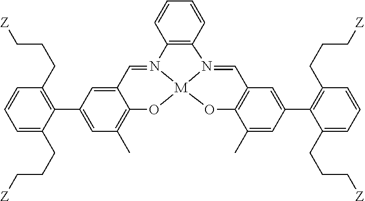

In certain embodiments, each occurrence of M in any complex in Table A1 comprises a moiety:

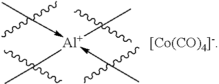

In certain embodiments, each occurrence of M in any complex in Table A1 comprises a moiety:

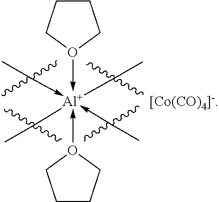

In certain embodiments, each occurrence of M in any complex in Table A1 comprises a moiety:

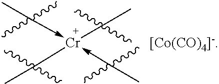

In certain embodiments, each occurrence of M in any complex in Table A1 comprises a moiety:

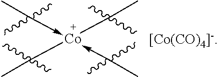

In certain embodiments, each occurrence of M in any complex in Table A1 comprises a moiety:

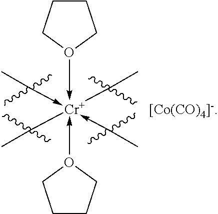

In certain embodiments, for catalysts of Table A1, (Z) comprises a neutral nitrogen-containing functional group. In certain embodiments, for catalysts of Table A1, (Z) comprises a neutral phosphorous-containing functional group. In certain embodiments, for catalysts of Table A1, (Z) comprises a neutral boron-containing functional group. In certain embodiments, for catalysts of Table A1, (Z) comprises a neutral nitrogen-containing heterocycle or heteroaryl. In certain embodiments, for catalysts of Table A1, (Z) comprises a phosphine. In certain embodiments, for catalysts of Table A1, (Z) comprises a phosphite. In certain embodiments, for catalysts of Table A1, (Z) comprises a nitrile.

In certain embodiments, catalysts of the present invention include the combination of:
a metal carbonyl compound, and
a Lewis acidic metal complex selected from Table A2, where Z and each M is independently as defined above and in the classes and subclasses herein:

TABLE A2

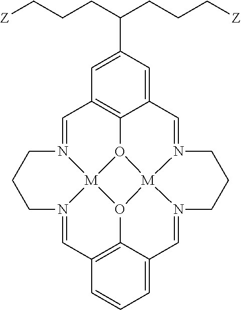

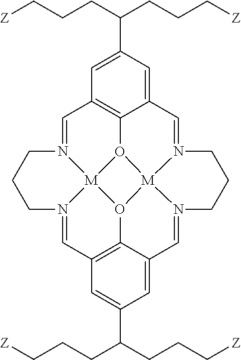

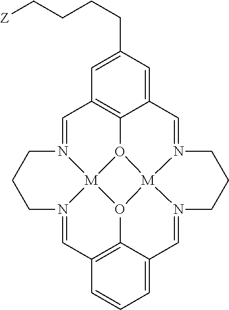

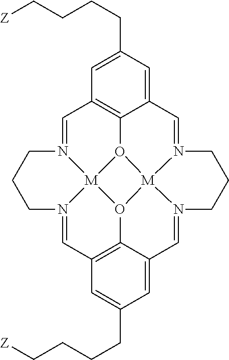

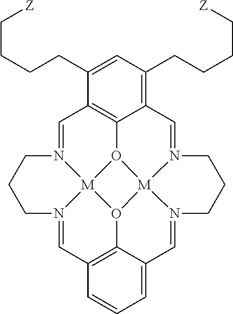

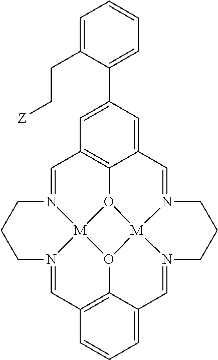

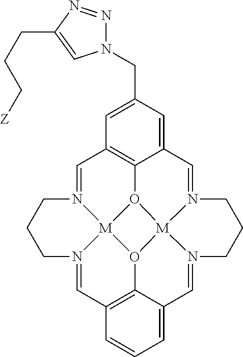

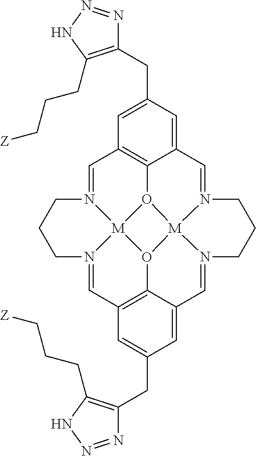

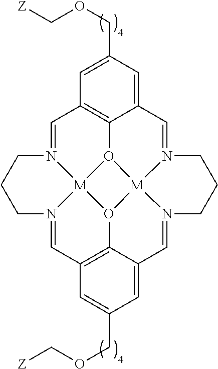

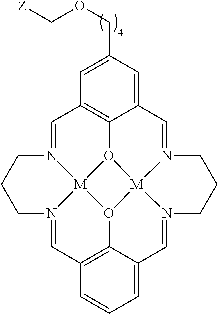

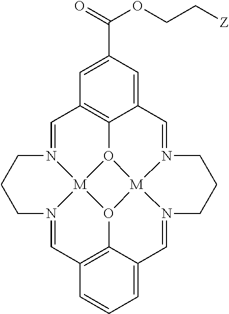

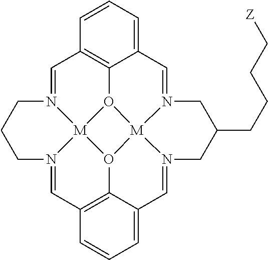

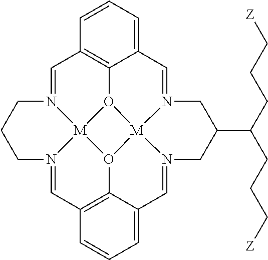

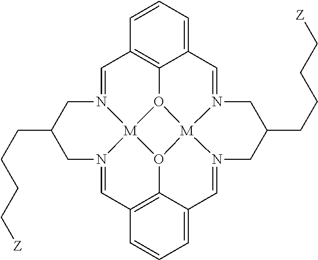

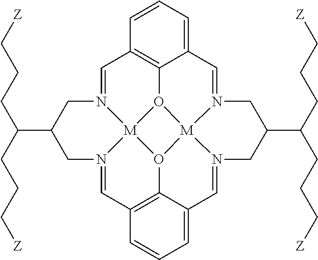

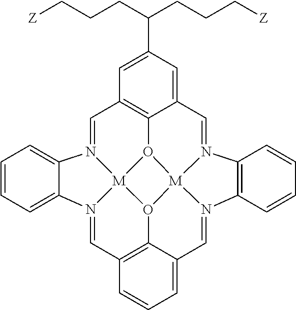

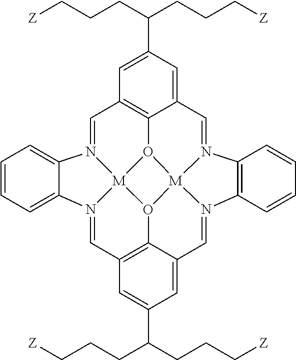

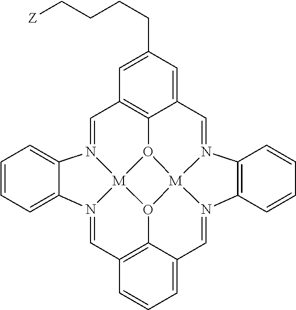

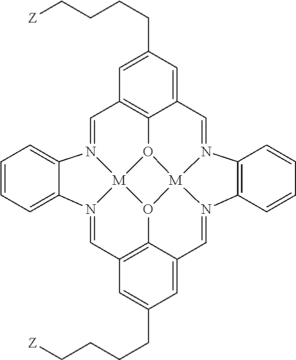

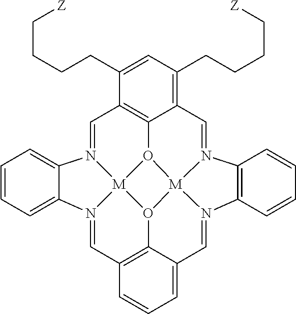

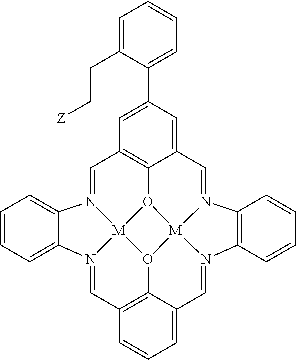

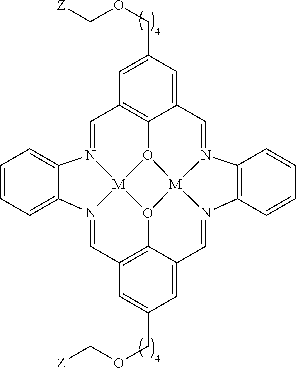

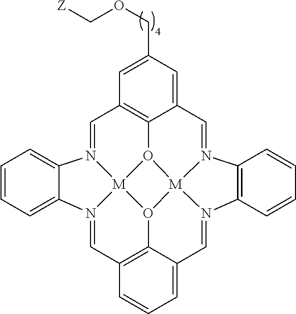

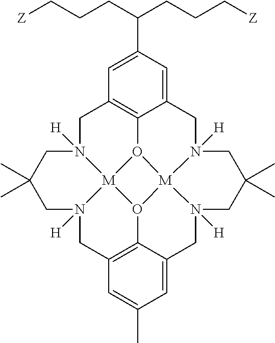

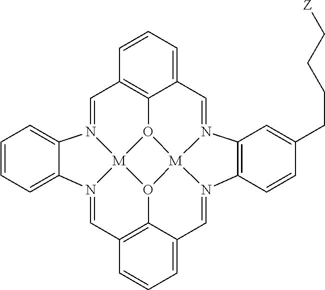

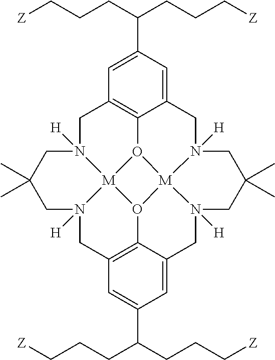

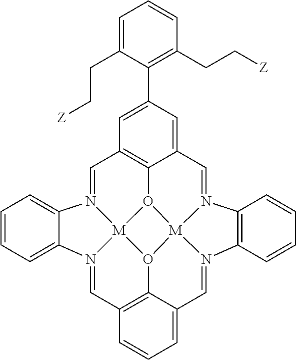

In certain embodiments, each occurrence of M in any complex in Table A2 comprises a moiety:

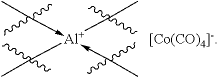

In certain embodiments, each occurrence of M in any complex in Table A2 comprises a moiety:

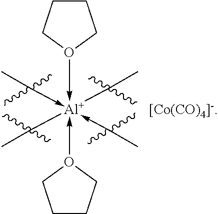

In certain embodiments, each occurrence of M in any complex in Table A2 comprises a moiety:

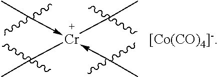

In certain embodiments, each occurrence of M in any complex in Table A2 comprises a moiety:

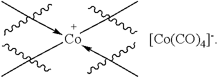

In certain embodiments, each occurrence of M in any complex in Table A2 comprises a moiety:

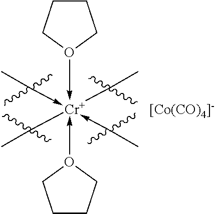

In certain embodiments, for catalysts of Table A2, (Z) comprises a neutral nitrogen-containing functional group. In certain embodiments, for catalysts of Table A2, (Z) comprises a neutral phosphorous-containing functional group. In certain embodiments, for catalysts of Table A2, (Z) comprises a neutral boron-containing functional group. In certain embodiments, for catalysts of Table A2, (Z) comprises a neutral nitrogen-containing heterocycle or heteroaryl. In certain embodiments, for catalysts of Table A2, (Z) comprises a phosphine. In certain embodiments, for catalysts of Table A2, (Z) comprises a phosphite. In certain embodiments, for catalysts of Table A2, (Z) comprises a nitrile.

In certain embodiments, catalysts of the present invention include a Lewis Acidic metal complex chosen from Catalyst Table 1:

CATALYST TABLE 1

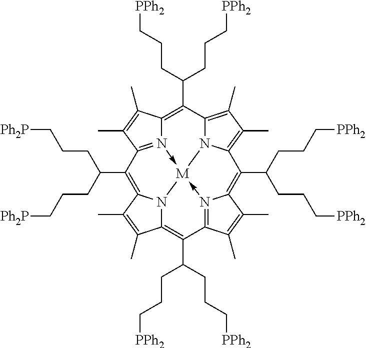

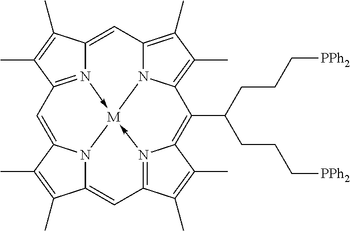

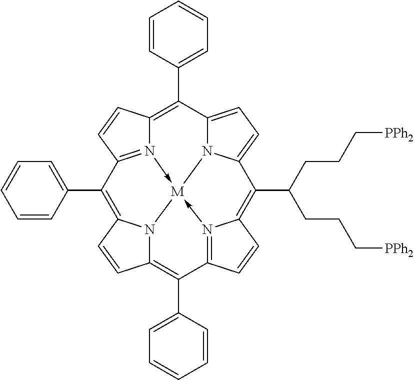

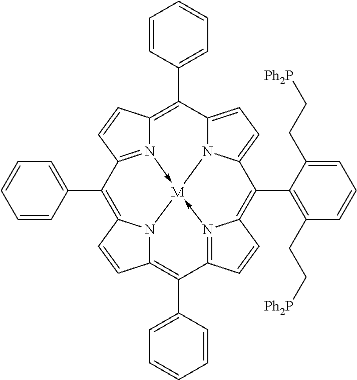

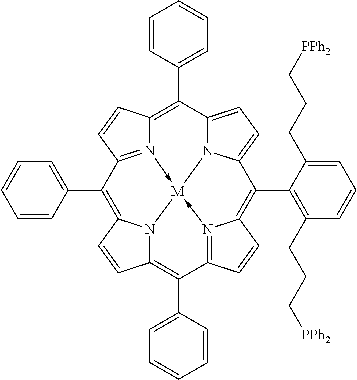

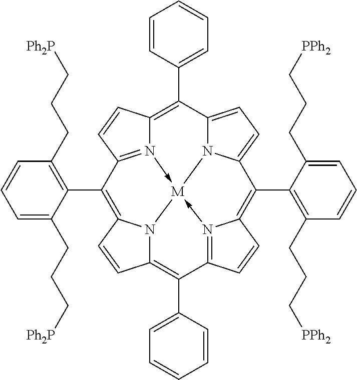

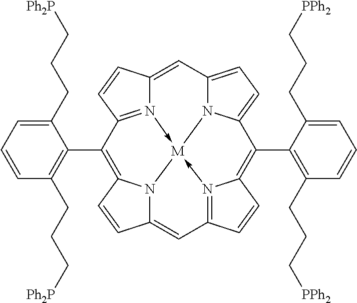

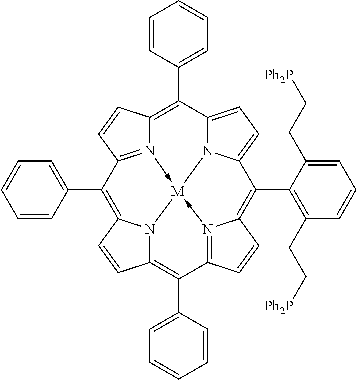

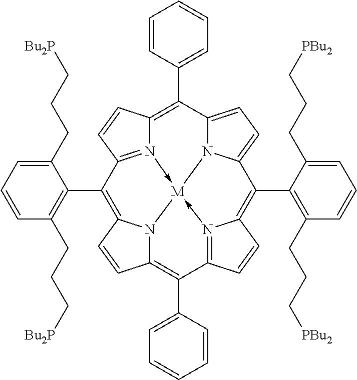

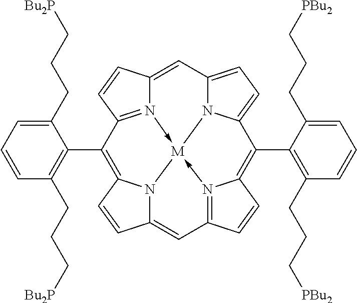

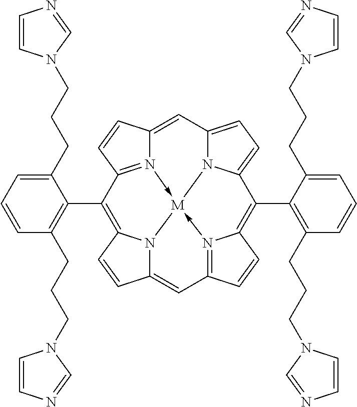

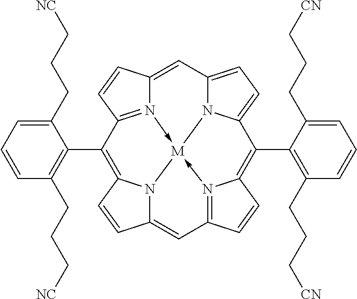

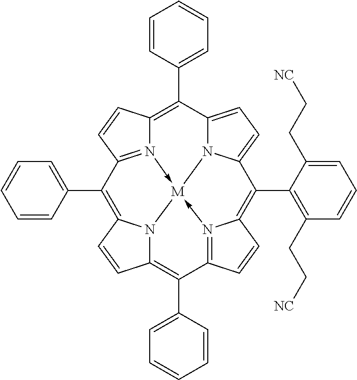

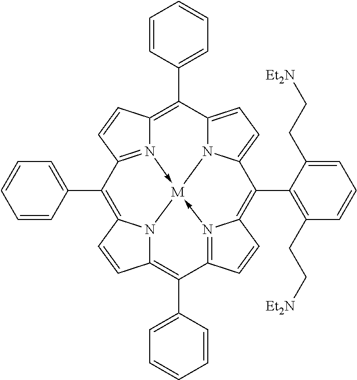

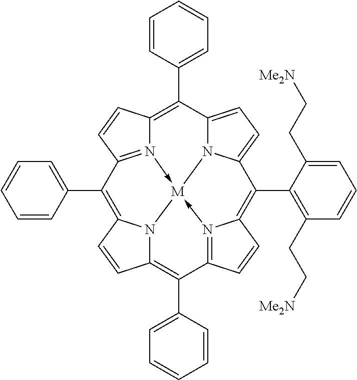

In certain embodiments, catalysts of the present invention include a complex chosen from Catalyst Table 2:

CATALYST TABLE 2

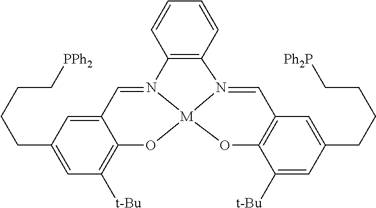

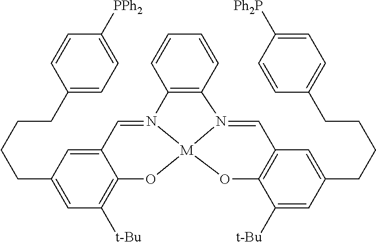

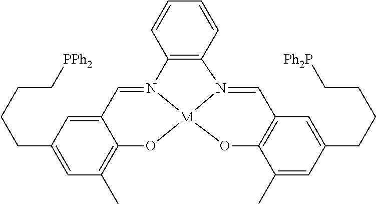

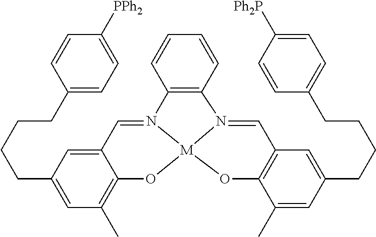

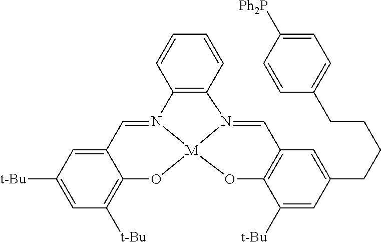

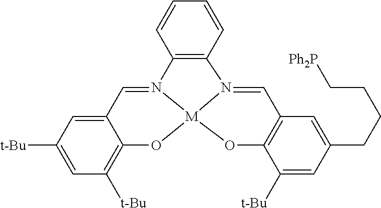

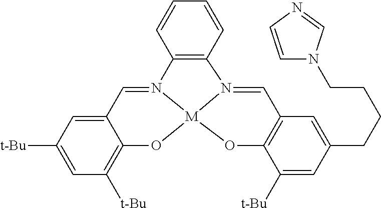

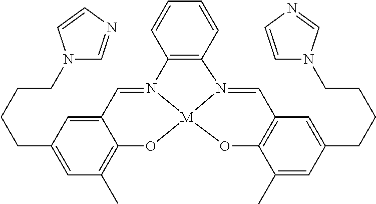

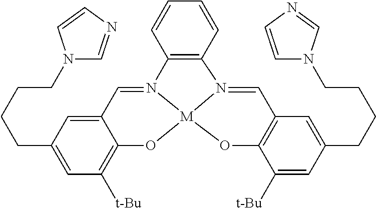

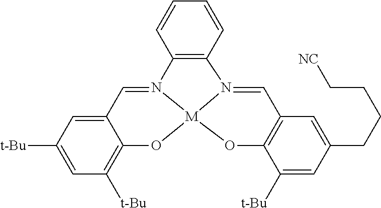

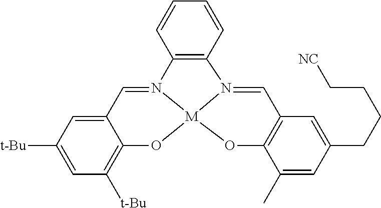

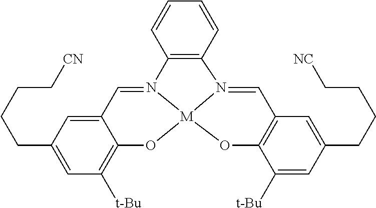

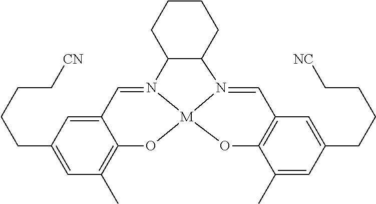

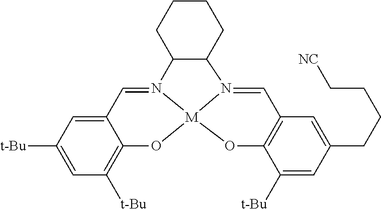

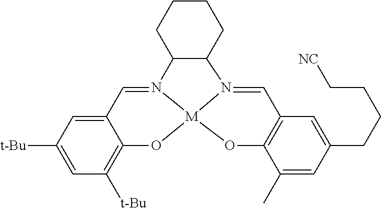

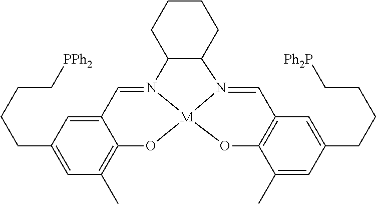

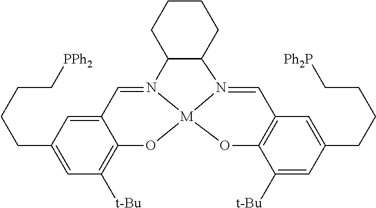

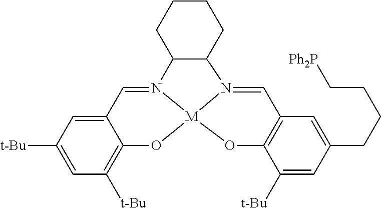

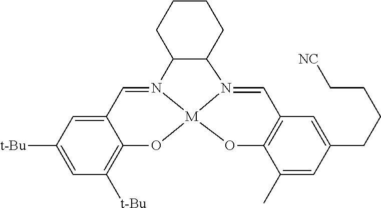

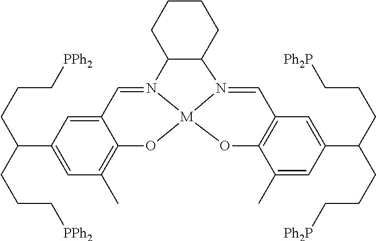

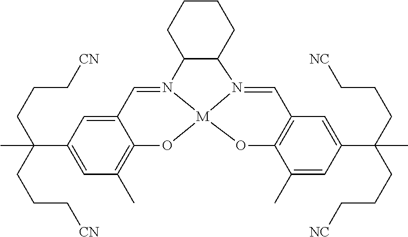

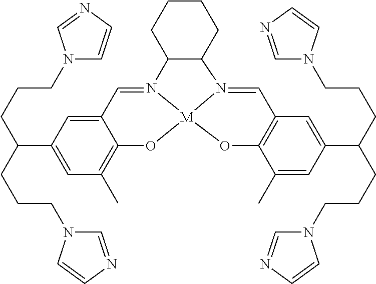

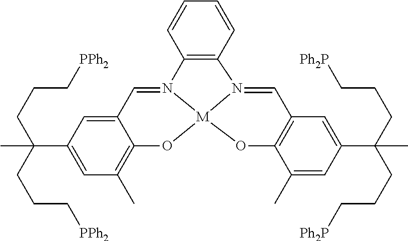

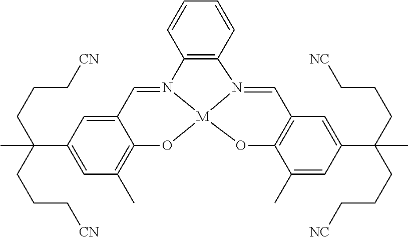

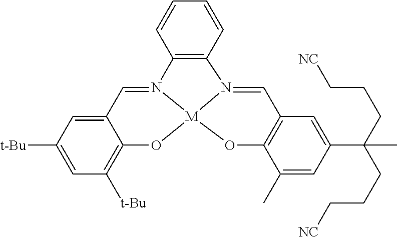

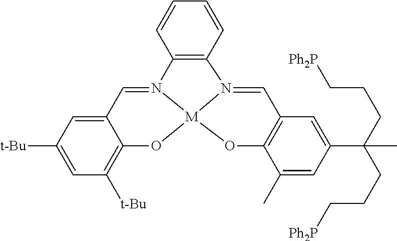

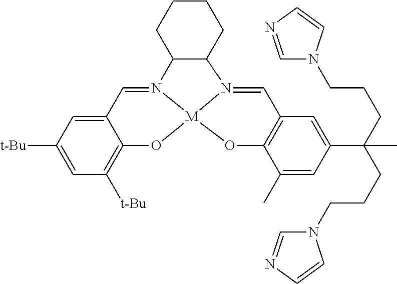

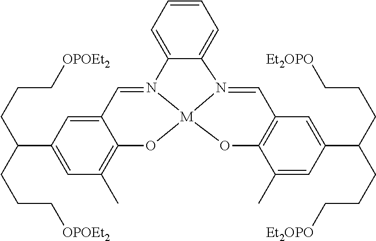

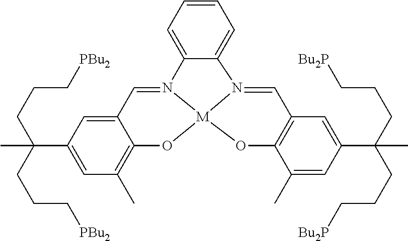

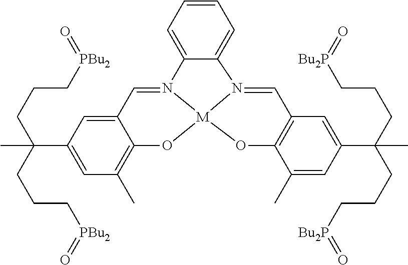

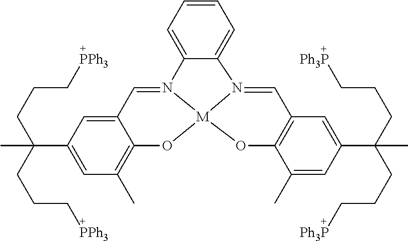

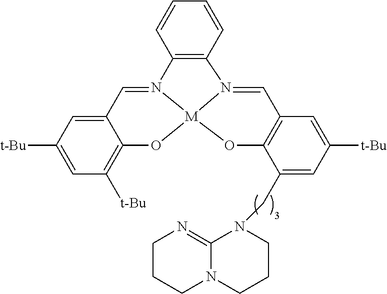

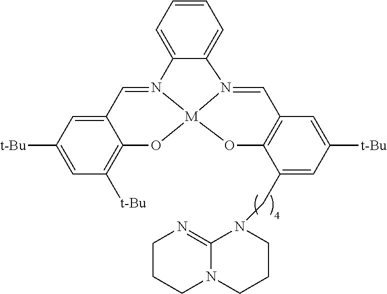

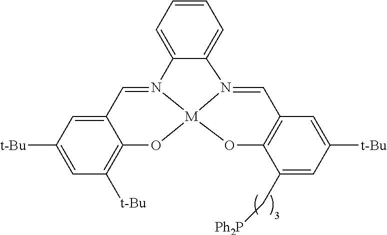

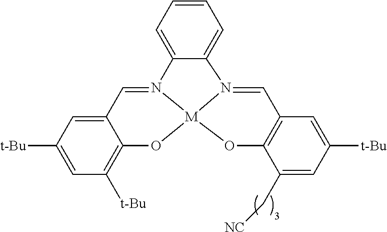

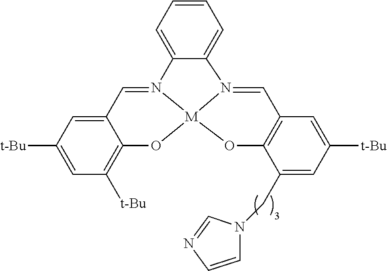

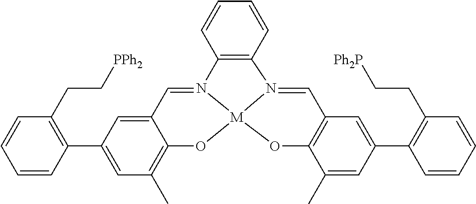

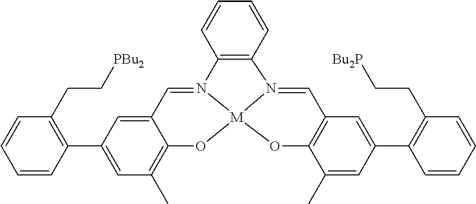

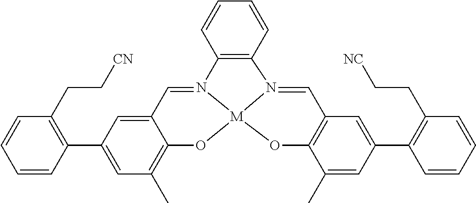

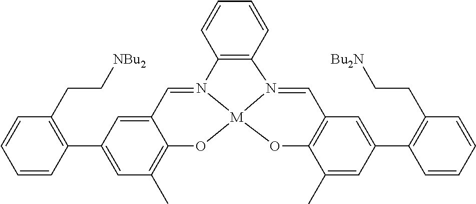

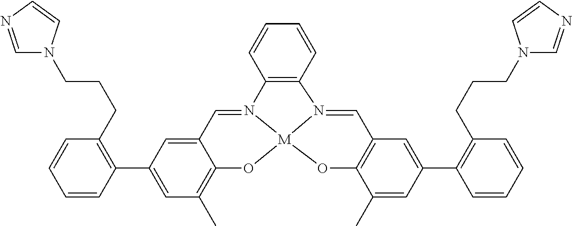

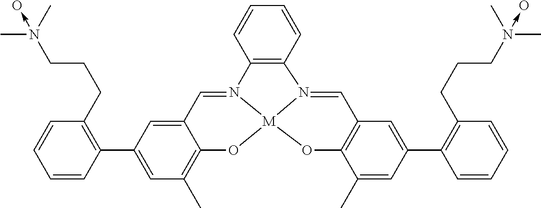

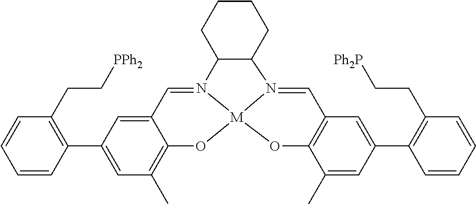

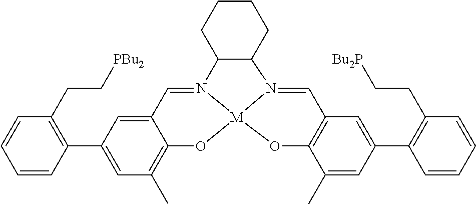

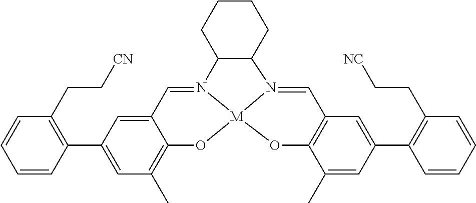

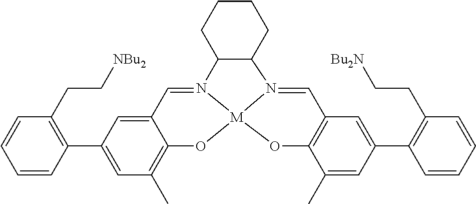

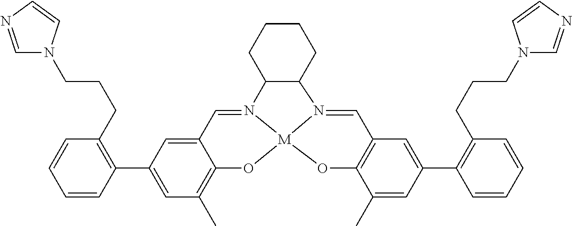

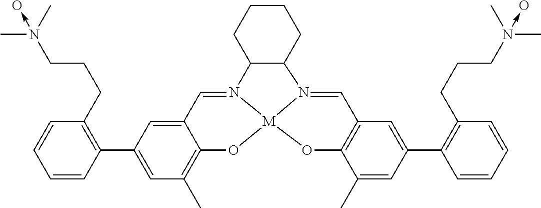

In certain embodiments, catalysts of the present invention include a complex chosen from Catalyst Table 3:

CATALYST TABLE 3

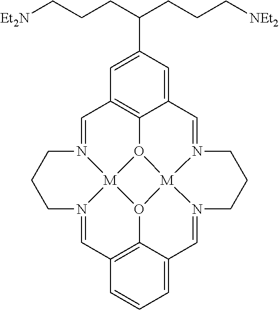

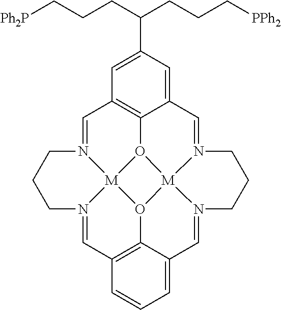

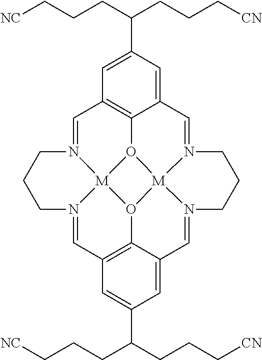

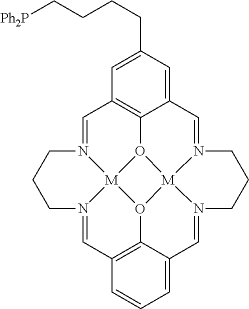

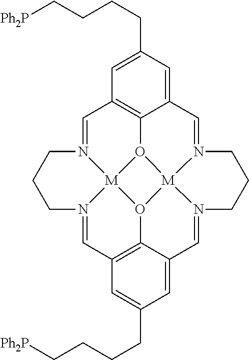

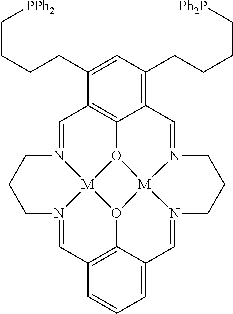

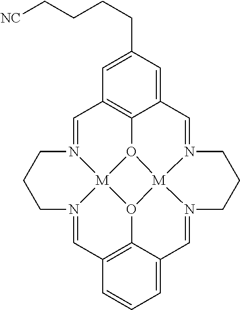

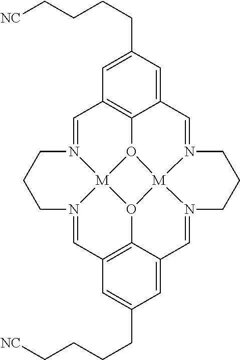

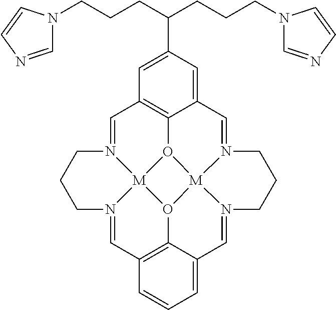

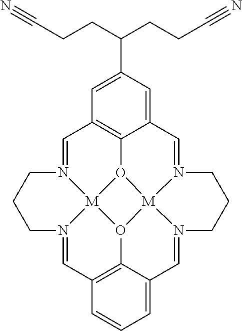

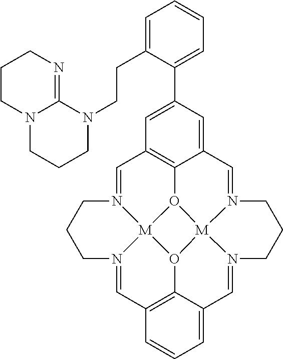

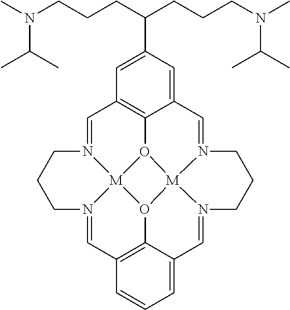

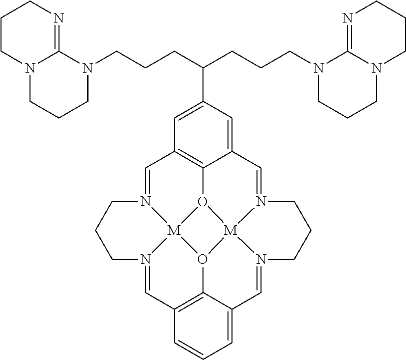

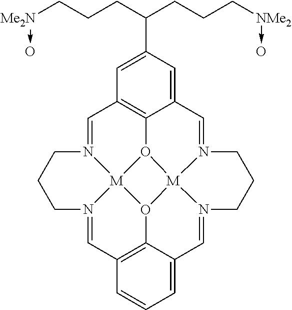

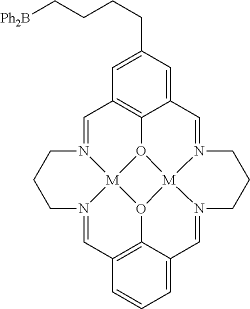

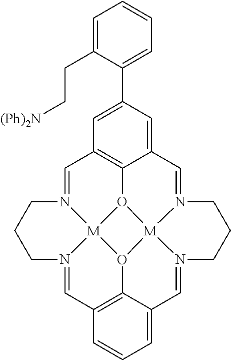

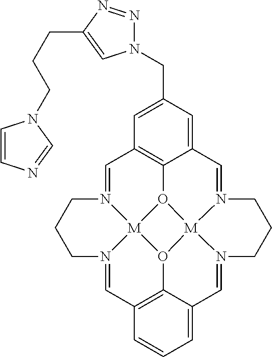

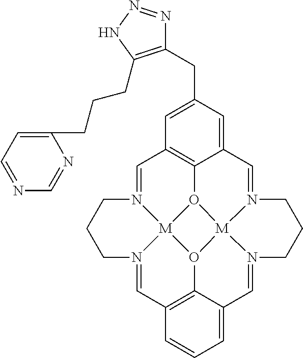

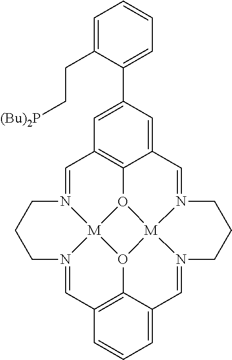

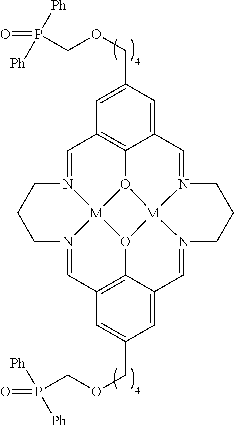

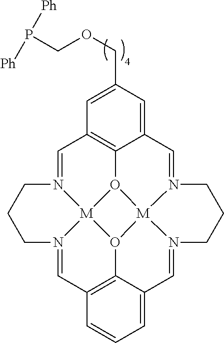

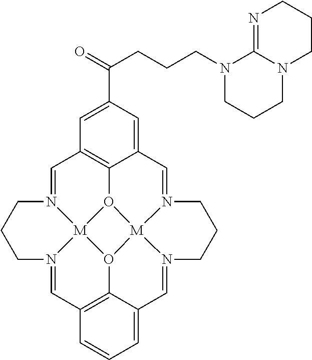

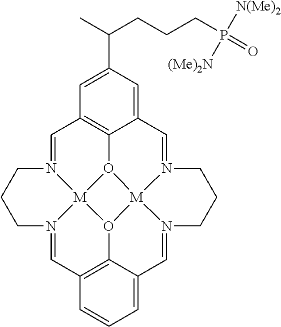

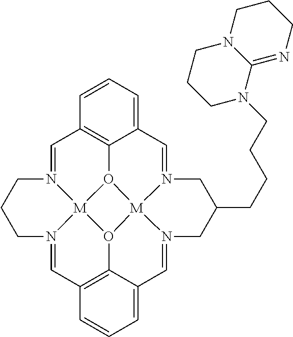

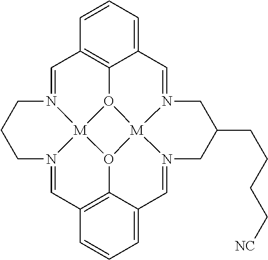

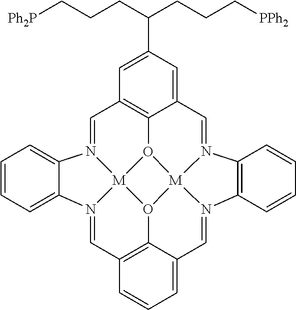

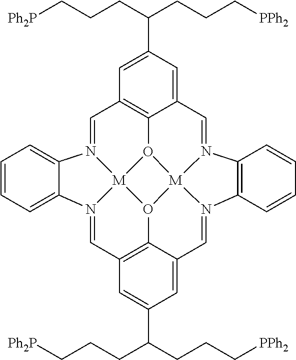

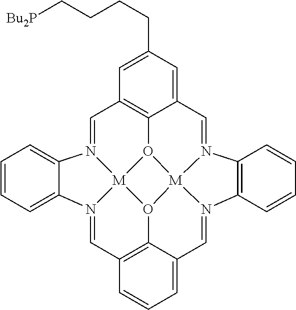

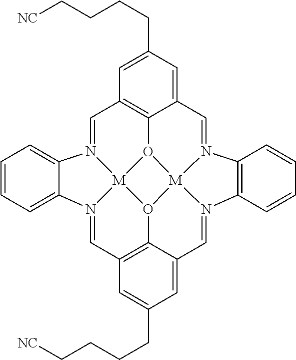

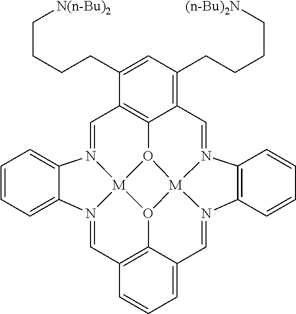

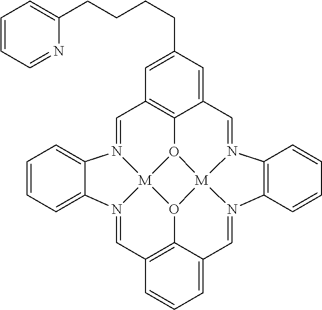

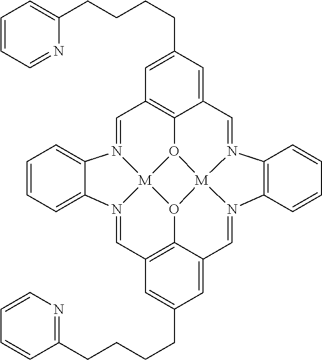

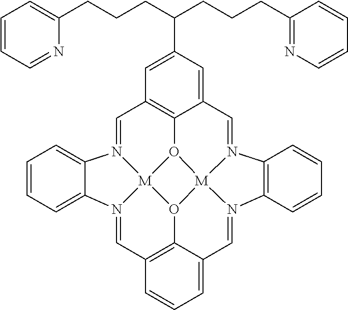

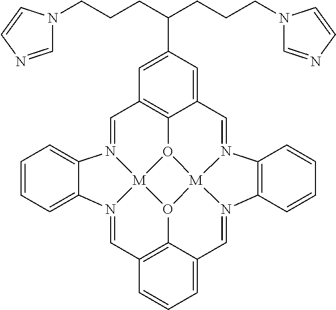

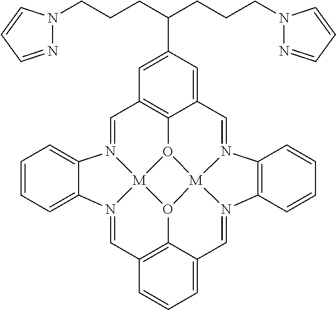

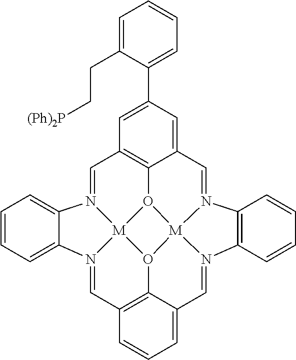

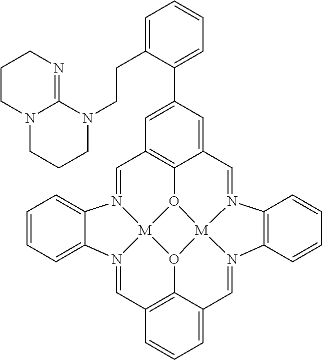

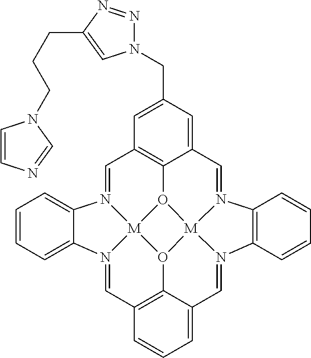

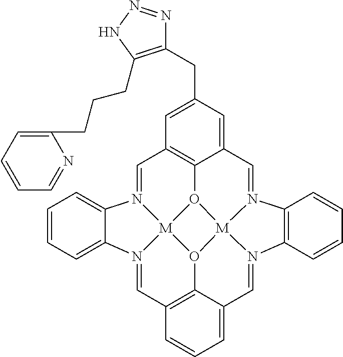

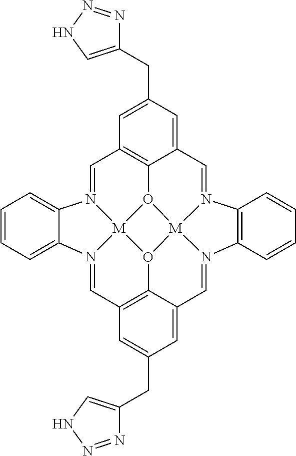

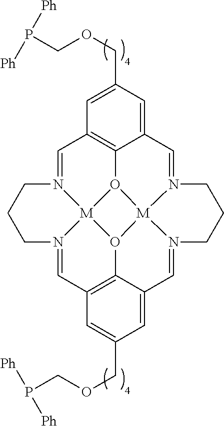

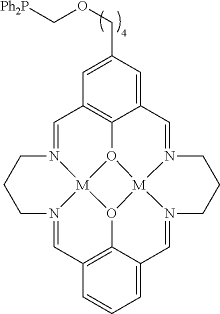

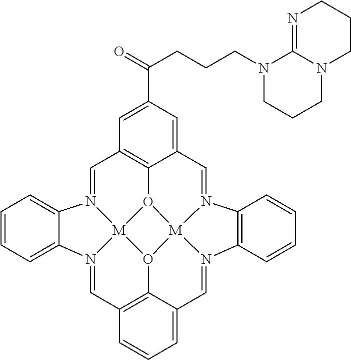

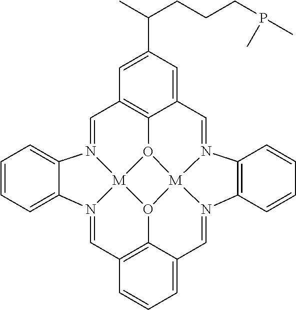

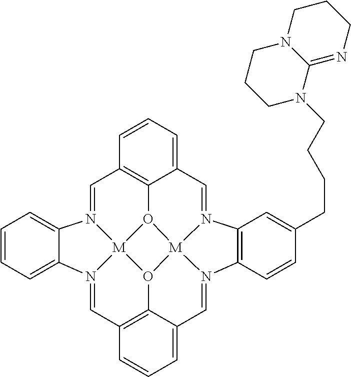

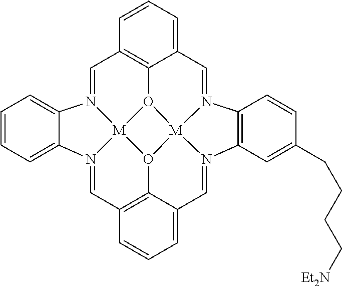

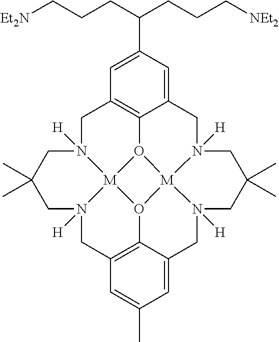

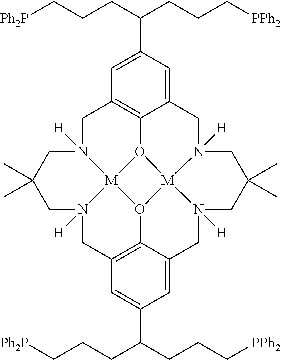

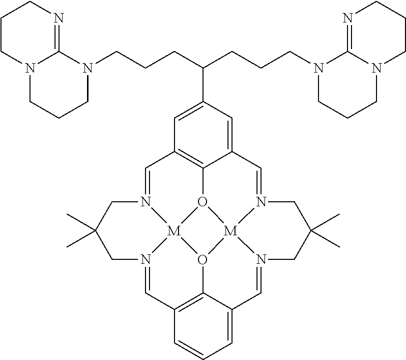

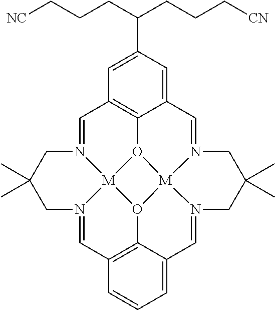

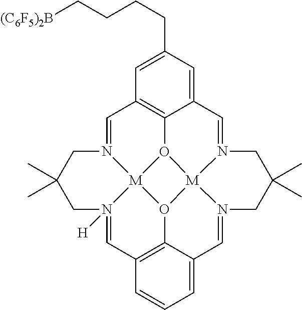

In certain embodiments, each occurrence of M in any compound of Catalyst Tables 1-3 comprises a moiety:

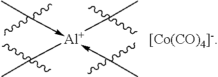

In certain embodiments, each occurrence of M in any compound of Catalyst Tables 1-3 comprises a moiety:

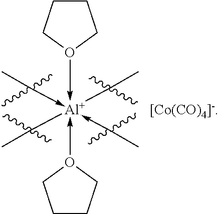

In certain embodiments, each occurrence of M in any compound of Catalyst Tables 1-3 comprises a moiety:

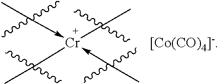

In certain embodiments, each occurrence of M in any compound of Catalyst Tables 1-3 comprises a moiety:

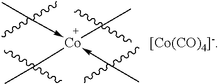

In certain embodiments, each occurrence of M in any compound of Catalyst Tables 1-3 comprises a moiety:

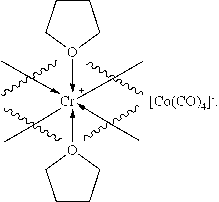

While not depicted, it will be appreciated that a tetracarbonyl cobaltate anion as shown above can be associated with any of the compounds in Table A1, Table A2 or in Catalyst Tables 1-3, and the present invention encompasses such complexes.

In certain embodiments, tetracarbonyl cobaltate anions associated with any of the compounds in Table A1, Table A2 or in Catalyst Tables 1-3 are replaced by [Rh(CO)₄]⁻. In certain embodiments, tetracarbonyl cobaltate anions associated with any of the compounds in Catalyst Tables 1-3 are replaced by [Fe(CO)₅]²⁻. In certain embodiments, tetracarbonyl cobaltate anions associated with any of the compounds in Catalyst Tables 1-3 are replaced by [Mn(CO)₅]⁻.

In another aspect, the present invention encompasses compositions of matter arising from any of the Lewis acidic metal complexes described above when a metal carbonyl is associated with one or more of the metal-coordinating groups tethered to the complex. In certain embodiments, such compounds arise from the interaction of a metal carbonyl compound of formula [Q_{d}M′ₑ(CO)_{w}]^{y-} with a Z group on the Lewis acidic metal complex to produce a new metal carbonyl species having a formula [Z_{f}Q_{d′}M′ₑ(CO)_{w′}]^{y-} where Q, M′, e, d, w, and y are as defined above and in the classes and subclasses herein and f is an integer representing the number of coordination sites occupied by the Z group or groups present in the new metal carbonyl complex—for clarity, it is meant to be understood here that f may be equal to the number of Z groups coordinated with the metal or metals in the new complex (for example when Z is a monodentate coordinating group) or f may be lesser than the number of Z groups present if one or more Z groups is a polydentate coordinating group. The variables d′ and w′ in the product metal carbonyl compound have the same meanings as d and w in the starting metal carbonyl compound, but the sum of d′ and w′ will be reduced relative to d and w because of the presence of one or more Z groups in the new metal carbonyl compound. In certain embodiments, the sum of f, d′, and w′ and is equal to the sum of d and w. In certain embodiments, d is equal to d′ and f is equal to w minus w′.

In certain embodiments, the present invention encompasses compositions of matter comprising compounds of formula: [Z:Co(CO)₃]⁻ where Z is selected from any of the metal-coordinating groups described above and in the classes and subclasses herein, “:” represents a non-covalent coordinative bond between a lone pair of electrons on a heteroatom in the Z group and where Z is covalently tethered to a ligand of a Lewis-acidic metal complex as described above.

In certain embodiments, the present invention encompasses compositions of matter comprising compounds of formula: [Z:Co₂(CO)₇] where Z is selected from any of the metal-coordinating groups described above and in the classes and subclasses herein, “:” represents a non-covalent coordinative bond between a lone pair of electrons on a heteroatom in the Z group and where Z is covalently tethered to a ligand of a Lewis-acidic metal complex as described above.

In certain embodiments, the present invention encompasses compositions of matter comprising compounds of formula: [Z:Rh(CO)₃]⁻ where Z is selected from any of the metal-coordinating groups described above and in the classes and subclasses herein, ‘:’ represents a non-covalent coordinative bond between a lone pair of electrons on a heteroatom in the Z group and where Z is covalently tethered to a ligand of a Lewis-acidic metal complex as described above.

In certain embodiments, the present invention encompasses compositions of matter comprising compounds of formula: [(Z:)₂Co(CO)₂]⁻ where each Z is independently selected from any of the metal-coordinating groups described above and in the classes and subclasses herein, each “:” represents a non-covalent coordinative bond between a lone pair of electrons on a heteroatom in the Z group where each Z is covalently tethered to the ligand of a Lewis-acidic metal complex as described above. In this case, the two Z groups may be attached to the same metal complex, or each may be tethered to a separate metal complex.

In certain embodiments, the present invention encompasses compositions of matter comprising compounds of formula: [Z:Co₂(CO)₇] where Z is selected from any of the metal-coordinating groups described above and in the classes and subclasses herein, “:” represents a non-covalent coordinative bond between a lone pair of electrons on a heteroatom in the Z group and where Z is covalently tethered to a ligand of a Lewis-acidic metal complex as described above.

In certain embodiments, the present invention encompasses compositions of matter comprising compounds of formula: [(Z:)₂Co(CO)₆] where each Z is independently selected from any of the metal-coordinating groups described above and in the classes and subclasses herein, each “:” represents a non-covalent coordinative bond between a lone pair of electrons on a heteroatom in the Z group where each Z is covalently tethered to the ligand of a Lewis-acidic metal complex as described above. In this case, the two Z groups may be attached to the same metal complex, or each may be tethered to a separate metal complex.

To further clarify what is meant by the description above and avoid ambiguity, the scheme below shows a composition arising from the combination of a chromium-based Lewis acidic metal complex (bearing a metal-coordinating group —PPh₂ according to the present invention) and the metal carbonyl compound tetracarbonyl cobaltate. The resulting coordination compound arising from the displacement of one CO ligand on the cobalt atom by the phosphine group on the Lewis acidic metal complex is depicted as compound E-1.

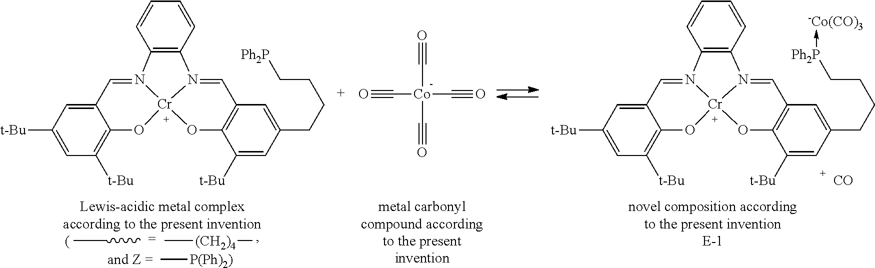

E-1 thus corresponds to a composition [Z_{f}Q_{d′}M′ₑ(CO)_{w}]^{y-} where Z is the —PPh₂ group and the metal complex to which it is covalently tethered, Q is absent (i.e. d′ is 0), M′ is Co, e is 1, w′ is 3, and y is 1. In this case, the sum of d and w in the starting metal carbonyl compound (0+4) equals the sum of f, d′, and w′ in E-1 (1+0+3). Corresponding compositions arising from any of the Lewis acidic metal complexes described herein in combination any of the metal carbonyl compounds described are encompassed by the present invention.

### VI. Carbonylation Methods

In another aspect, the present invention provides methods of carbonylating heterocycles using the catalysts disclosed hereinabove. In certain embodiments, the invention encompasses a method comprising the steps:
a) providing a compound having formula:

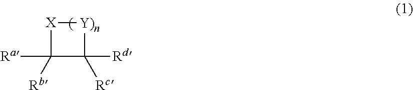

wherein:
R^{a}′ is hydrogen or an optionally substituted group selected from the group consisting of C₁₋₃₀ aliphatic; C₁₋₃₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, or sulfur; and 4- to 7-membered heterocyclic having 1-3 heteroatoms independently selected from the group consisting of nitrogen, oxygen, and sulfur;
each of R^{b}′, R^{c}′, and R^{d}′ is independently hydrogen or an optionally substituted group selected from the group consisting of C₁₋₁₂ aliphatic; C₁₋₁₂ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, or sulfur; and 4- to 7-membered heterocyclic having 1-3 heteroatoms independently selected from the group consisting of nitrogen, oxygen, and sulfur;
wherein any of (R^{b}′ and R^{c}′), (R^{d}′ and R^{d}′), and (R^{a}′ and R^{b}′) can be taken together with their intervening atoms to form one or more rings selected from the group consisting of: optionally substituted C₃-C₁₄ carbocycle, optionally substituted C₃-C₁₄ heterocycle, optionally substituted C₆-C₁₀ aryl, and optionally substituted C₅-C₁₀ heteroaryl;
X is selected from the group consisting of O, S, and NR^{e}′ where R^{e}′ is selected from the group consisting of hydrogen or an optionally substituted group selected from the group consisting of C₁₋₃₀ aliphatic; C₁₋₃₀ heteroaliphatic having 1-4 heteroatoms independently selected from the group consisting of nitrogen, oxygen, and sulfur; 6- to 10-membered aryl; 5- to 10-membered heteroaryl having 1-4 heteroatoms independently selected from nitrogen, oxygen, or sulfur; and 4- to 7-membered heterocyclic having 1-3 heteroatoms independently selected from the group consisting of nitrogen, oxygen, and sulfur;
n is 0 or 1; and
Y is C═O or CH₂;
b) contacting the compound having the formula (1) and carbon monoxide in the presence of a catalyst described above, to provide a product having formula:

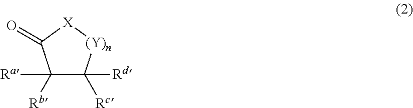

where R^{a}′, R^{b}′, R^{e}′, R^{d}′, and X, correspond to R^{a}′, R^{b}′, R^{e}′, R^{d}′, and X, in (1) including R^{b}′ and R^{c}′ forming a ring if that is the case for (1); and in the case where n for (1) is 0, n for (2) is 0 or 1, and in the case where n for (1) is 1, n for (2) is 1.

In certain embodiments of the carbonylation method described above, n for (1) is 0 so that the formula for (1) becomes:

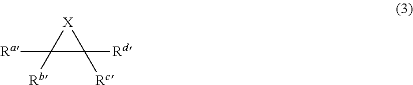

and the product has the formula:

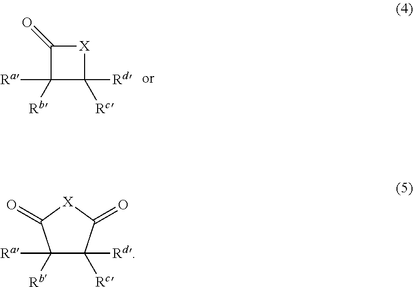

In certain embodiments of the carbonylation method described above, X for (3) is oxygen so that compound is an epoxide and the formula for (3) becomes:

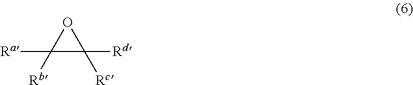

and the product has the formula:

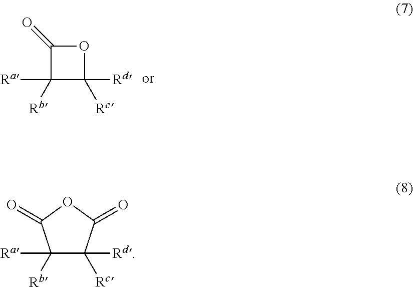

In certain embodiments, methods of the present invention comprise treating heterocycles where R^{a}′, R^{b}′, and R^{c}′ are —H, and R^{d}′ comprises an optionally substituted C₁₋₂₀ aliphatic group. In certain embodiments, methods of the present invention comprise treating heterocycles where R^{a}′, R^{b}′, R^{c}′, and R^{d}′ are all —H. In certain embodiments, methods of the present invention comprise treating heterocycles where R^{a}′, R^{b}′, and R^{c}′ are —H, and R^{d}′ comprises an optionally substituted C₁₋₆ aliphatic group. In certain embodiments, methods of the present invention comprise treating heterocycles where R^{a}′, R^{b}′, and R^{c}′ are —H, and R^{d}′ is methyl. In certain embodiments, methods of the present invention comprise treating heterocycles where R^{a}′, R^{b}′, and R^{c}′ are —H, and R^{d}′ is —CH₂Cl. In certain embodiments, methods of the present invention comprise treating heterocycles where R^{a}′, R^{b}′, and R^{c}′ are —H, and R^{d}′ is —CH₂OR^{y}, —CH₂OC(O)R^{y}, where R^{y} is as defined above. In certain embodiments, methods of the present invention comprise treating heterocycles where R^{a}′, R^{b}′, and R^{c}′ are —H, and R^{d}′ is —CH₂CH(R^{c})OH, where R^{c} is as defined above and in the classes and subclasses herein.

In certain embodiments, methods of the present invention comprise the step of contacting ethylene oxide with carbon monoxide in the presence of any of the catalysts defined hereinabove or described in the classes, subclasses and Tables herein. In certain embodiments, the method comprises treating the ethylene oxide with carbon monoxide in the presence of the catalyst until a substantial portion of the ethylene oxide has been converted to beta propiolactone. In certain embodiments, the method comprises treating the ethylene oxide with carbon monoxide in the presence of the catalyst until a substantial portion of the ethylene oxide has been converted to succinic anhydride.

In certain embodiments, methods of the present invention comprise the step of contacting propylene oxide with carbon monoxide in the presence of any of the catalysts defined hereinabove or described in the classes, subclasses and Tables herein. In certain embodiments, the method comprises treating the propylene oxide with carbon monoxide in the presence of the catalyst until a substantial portion of the propylene oxide has been converted to beta butyrolactone. In certain embodiments, the method comprises treating the propylene oxide with carbon monoxide in the presence of the catalyst until a substantial portion of the propylene oxide has been converted to methyl succinic anhydride.

In another embodiment, the present invention encompasses methods of making copolymers of epoxides and CO by contacting an epoxide with CO in the presence of any of the catalysts defined hereinabove or described in the classes, subclasses and Tables herein. In certain embodiments, such processes conform to the scheme:

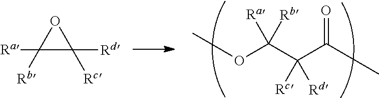

where each of R^{a}, R^{b}, R^{c}, and R^{d}, are as defined above.

In certain embodiments, methods of the present invention comprise the step of contacting ethylene oxide with carbon monoxide in the presence of any of the catalysts defined hereinabove or described in the classes, subclasses and Tables herein to provide polypropiolactone polymer.

In certain embodiments, methods of the present invention comprise the step of contacting propylene oxide with carbon monoxide in the presence of any of the catalysts defined hereinabove or described in the classes, subclasses and Tables herein to provide poly-3-hydroxybutyrate polymer.

In other embodiments, the present invention includes methods for carbonylation of epoxides, aziridines, thiiranes, oxetanes, lactones, lactams, and analogous compounds using the above-described catalysts. Suitable methods and reaction conditions for the carbonylation of such compounds are disclosed in Yutan et al. (J. Am. Chem. Soc. 2002, 124, 1174-1175), Mahadevan et al. (Angew. Chem. Int. Ed. 2002, 41, 2781-2784), Schmidt et al. (Org. Lett. 2004, 6, 373-376 and J. Am. Chem. Soc. 2005, 127, 11426-11435), Kramer et al. (Org. Lett. 2006, 8, 3709-3712 and Tetrahedron 2008, 64, 6973-6978) and Rowley et al. (J. Am. Chem. Soc. 2007, 129, 4948-4960, in U.S. Pat. Nos. 6,852,865 and 7,569,709, all of which are hereby incorporated herein in their entirety.

In certain embodiments, methods of the present invention comprise the step of carbonylating ethylene oxide by contacting it with carbon monoxide in the presence of any of the catalysts defined hereinabove or described in the classes, subclasses and Tables herein in a continuous process. In certain embodiments, the continuous process includes a catalyst recovery and recycling step where product of the ethylene oxide carbonylation is separated from a product stream and at least a portion of the catalyst from the product stream is returned to the ethylene oxide carbonylation step. In certain embodiments, the catalyst recovery step entails subjecting the product stream to conditions where little CO is present. In certain embodiments, under such CO depleted conditions, the inventive catalyst has improved stability compared to a comparable catalyst lacking any metal coordination moieties.

### EXAMPLES

### Example 1

A typical route to a representative catalyst of the present invention is shown in Scheme E1, below:

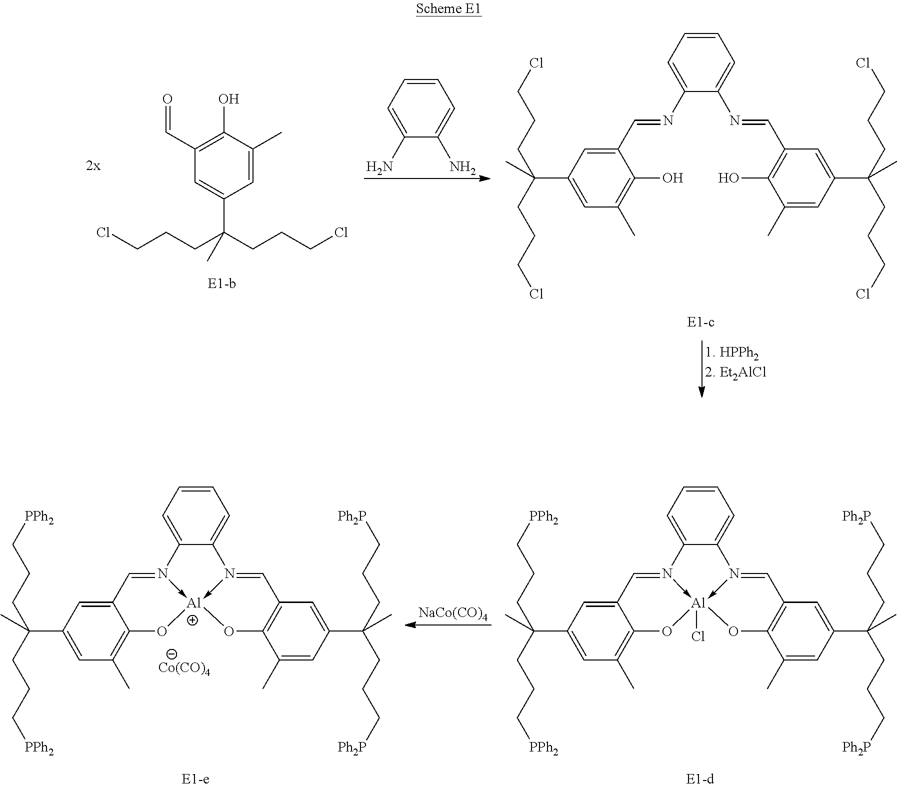

As shown in Scheme E1, a compound of the invention is made from known salicylaldehyde derivative E1-b. Two equivalents of this aldehyde are reacted with a diamine (in this case 1,2-benzenediamine) to afford Schiff base E1-c. This compound is then reacted with diphenyl phosphine followed by diethyl aluminum chloride and sodium cobalt tetracarbonyl to give the active Al(III)-salen catalyst E1-e. Similar chemistries can be applied to synthesis of the catalysts described hereinabove. One skilled in the art of organic synthesis can adapt this chemistry as needed to provide the specific catalysts described herein, though in some cases routine experimentation to determine acceptable reaction conditions and functional group protection strategies may be required.

### Example 2

Synthesis of [{tetrakis-(4-nitrilobutyl)phenyl-porphyrin} Al(THF)₂][Co(CO)₄] is shown in Scheme E2, below:

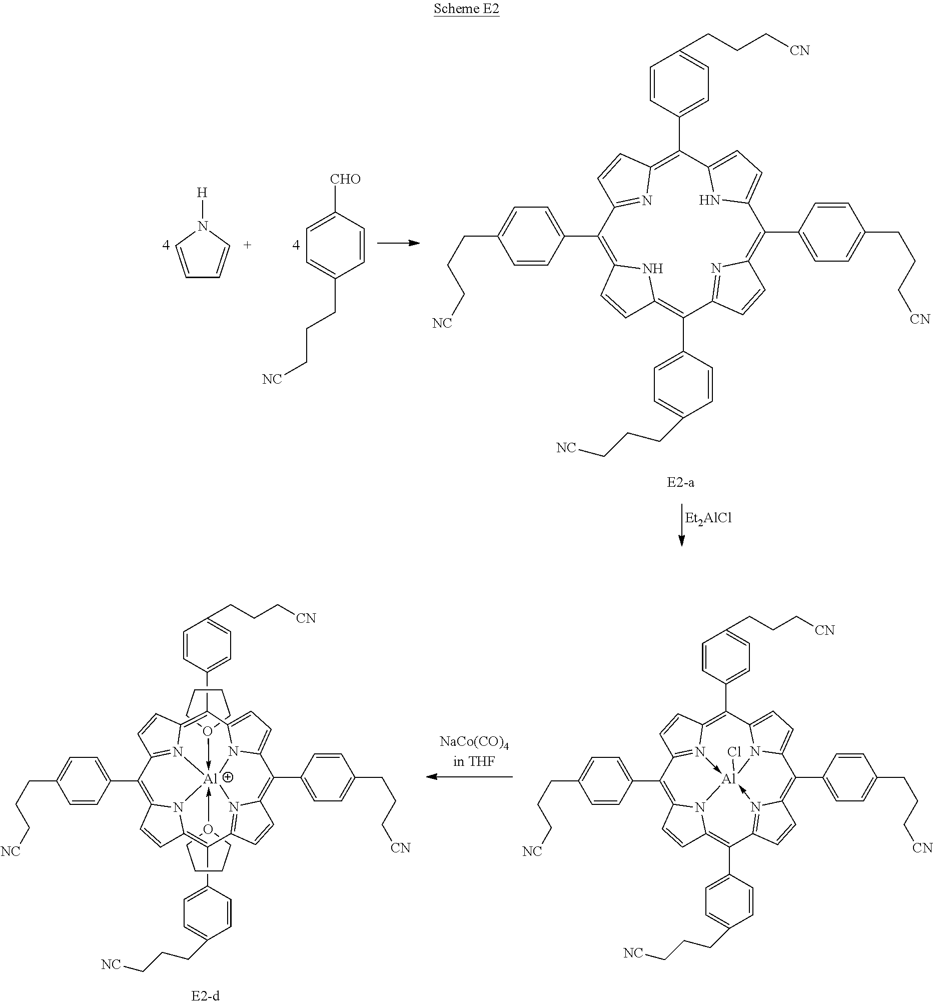

As shown in Scheme E2, pyrrole, para (4-butylnitrile)benzaldehyde and salicylic acid are refluxed in xylene to give porphyrin E2-a. E2-a is reacted with diethyl aluminum chloride and then with NaCo(CO)₄ in THF to afford the active Al(III)-salen catalyst E2-d. One skilled in the art of organic synthesis can adapt this chemistry as needed to provide the specific catalysts described herein, though in some cases routine experimentation to determine acceptable reaction conditions and functional group protection strategies may be required.

This application refers to various issued patents, published patent applications, journal articles, and other publications all of which are incorporated herein by reference.

### OTHER EMBODIMENTS

The foregoing has been a description of certain non-limiting embodiments of the invention. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A metal complex for the carbonylation of heterocycles comprising the combination of:
i) one or more tethered metal-coordinating moieties, where each metal-coordinating moiety comprises a linker and 1 to 4 metal-coordinating groups;
ii) one or more ligands to which the one or more metal-coordinating moieties are covalently tethered, wherein the one or more ligands are coordinated to one or two metal atoms; and
iii) at least one metal carbonyl species associated with a metal-coordinating moiety present on the metal complex.

2. The metal complex of claim 1, wherein the one or more ligands to which at least one metal-coordinating moiety is covalently tethered is selected from the group consisting of porphryin ligands and salen ligands.

3. The metal complex of claim 2, wherein metal complex comprises a salen or porphyrin complex of a metal selected from the group consisting of: Zn(II), Cu(II), Mn(II), Co(II), Ru(II), Fe(II), Co(II), Rh(II), Ni(II), Pd(II), Mg(II), Al(III), Cr(III), Fe(III), Co(III), Ti(III), In(III), Ga(III), Mn(III).

4. The metal complex of claim 2, wherein the metal complex comprises a salen or porphyrin complex of aluminum.

5. The metal complex of claim 2, wherein the metal complex comprises a salen or porphyrin complex of chromium.

6. The metal complex of claim 1, wherein a metal-coordinating moiety comprises one or more functional groups containing an atom selected from the group consisting of: phosphorous, nitrogen atom, and boron.

7. A method for the carbonylation of heterocycles comprising contacting a heterocycle and carbon monoxide in the presence of a metal complex of claim 1.

8. The method of claim 7, wherein the heterocycle is an epoxide, aziridine, thiirane, oxetane, lactone, or lactam.

9. The method of claim 8, wherein the heterocycle is ethylene oxide.
